(19) United States
(12) Patent Application Publication
(10) Pub. No.: US 2019/0124959 A1
(43) Pub. Date: May 2, 2019

(54) SYSTEMS, METHODS, AND COMPOSITIONS RELATED TO USING NON-LIVE-BACTERIA PREPARATIONS TO PROMOTE FOOD SAFETY AND PRESERVATION

(71) Applicant: Micro-Nature, LLC, San Francisco, CA (US)

(72) Inventors: Richard Baird Smittle, Morgantown, WV (US); John Boyd Phelps, Berkeley, CA (US); Gregory Dean Sunvold, Lewisburg, OH (US); John A. Hommeyer, JR., San Francisco, CA (US)

(73) Assignee: Micro-Nature, LLC, San Francisco, CA (US)

(21) Appl. No.: 15/532,100

(22) PCT Filed: Feb. 12, 2016
(86) PCT No.: PCT/US2015/063842

§ 371 Date: Jun. 1, 2017

(51) Int. Cl. A23L 3/3571; A23L 33/135; A23K 50/48; A23K 10/16; A23B 4/22; A23K 50/42

(52) U.S. Cl. CPC A23L 3/3571; A23L 33/135; A23K 50/48; A23K 10/16; A23V 2002/00; A23K 50/42; A23Y 2280/15; A23Y 2280/55; A23B 4/22

(57) ABSTRACT

The present teachings disclose a process for producing a safe and preserved food. The process includes: (i) introducing a non-live-bacteria preparation on or in a food to produce an activated food, and the non-live-bacteria preparation results from fermentation of fermented bacteria, but the non-live-bacteria preparation is substantially depleted of the fermented bacteria, and the fermented bacteria are bacteria that are living; and (ii) incubating the activated food in presence of the non-live-bacteria preparation to kill and/or inhibit growth of pathogens and/or spoilage microorganisms on and/or in the activated food and thereby producing the safe and preserved food; and wherein the fermented bacteria is anti-pathogen bacteria and/or anti-spoilage bacteria.

### RELATED CASE

This application claims priority to U.S. provisional application No. 62/087,723, filed Dec. 4, 2014, and is incorporated herein by reference for all purposes.

### FIELD

The present teachings relate generally to systems, methods, and compositions that promote safety and preservation of food (human or animal), including beverages, and decontamination of non-edible surfaces. More particularly, the present teachings relate to systems, methods, and compositions that use non-live-bacteria preparations, which are substantially depleted of living bacteria but which include fermentation byproducts produced from anti-pathogen and anti-spoilage bacteria, to promote safety and preservation of food.

### BACKGROUND

High nutritional content, good quality ingredients, and taste are the essential elements of a high-quality diet. At the same time, any responsible food product manufacturer must take great care to control pathogens (e.g., vegetative pathogen forms like E. coli, Listeria and Salmonella; spore-forming types like Clostridium botulinum) and spoilage microorganisms (e.g., Pseudomonas, Bacillus, etc.) in the manufacture of human and pet food and to promote safety and preservation of food and to promote long-term storage of the food.

Numerous problems exist with conventional methods (e.g., retort, high-pressure processing (“HPP”), irradiation, freezing, chemical agents, organic/mineral acid direct addition) of controlling pathogens and preserving food. Retort or HPP, however, requires the purchase of expensive equipment, is costly to operate, and negatively impacts diet nutritional content, color, aroma, texture, and taste of food. Further, irradiation has several drawbacks, such as: (1) consumer concerns about the safety of consuming or feeding irradiated foods, (2) capital investment costs, and (3) impacts on nutritional or palatability changes to the diet. Further still, chemical agents used to control pathogens and spoilage also have significant drawbacks such as: (1) consumer-unfriendly label ingredients, (2) alteration of the nutrient profile of the diet that may have negative health consequences, and (3) reduced diet palatability. Further still, freezing is: (1) costly to perform and maintain, (2) requires a restrictive distribution model, and (3) is not preferred by consumers (e.g., convenience, taste, etc.).

Other conventional techniques for promoting food safety and preservation that avoid some of the disadvantages of the conventional techniques described above include combining live bacteria such as lactic acid bacteria, or more specifically, Pediococci bacterial strains, with a carbohydrate source (e.g., dextrose), into a nutrient-rich growth medium (e.g., chicken broth), to create a live-bacteria preparation. Such live-bacteria preparations may be used to kill pathogens and food-spoilage microorganisms. However, the process of creating a live-bacteria preparation typically causes fermentation of the live bacteria, which is associated with acid production. This is often an undesirable side effect, because the taste of the food is altered by the acid load so as to make the food taste tart or sour. In certain situations, this tart or sour taste, induced by the bacterial fermentation, is too great to overcome.

Other drawbacks of live-bacteria preparations include product-handling challenges. First, fermentation typically requires low temperatures and lengthy incubation times (e.g., treating live bacterial cells at 37° C. for 24 hours) for stabilization benefits through fermentation to be realized. This drawback is evidenced by constraints on manufacturing and handling of products, i.e., such manufacturing requires large amounts of work in process held for long periods of time. Second, such conventional techniques may require that live dormant bacteria do not begin growing again and thereby altering the food.

Thus, there exists a longstanding need for more effective means of processing food to: (1) kill indigenous food-borne pathogens, (2) kill spoilage microorganisms to provide long-term (e.g., greater than three months) shelf-life of food products, (3) avoid costly manufacturing processes and equipment, (4) utilize widely accessible distribution models, (5) preserve the nutrient quality of ingredients closer to their raw state, and (6) provide alternative regulatory options.

Moreover, given the daunting effort to keep food free from contamination by pathogens and/or spoilage microorganisms, there remains a need for food processing techniques that effectively produce pathogen-free and shelf-stable food in a safe, effective, and inexpensive manner that does not compromise the quality or taste of the food. What is therefore needed are systems, methods, and compositions that can be used to treat food products to produce food products that are safe and shelf-stable and inedible surfaces that are decontaminated.

### SUMMARY OF THE INVENTION

To achieve the foregoing, in one aspect, the present teachings disclose processes for producing a safe and preserved food. One exemplar such process includes: (i) introducing a non-live-bacteria preparation on and/or in a food to produce an activated food, wherein the non-live-bacteria preparation results from fermentation of fermented bacteria, but the non-live-bacteria preparation is substantially depleted of fermented bacteria, and the fermented bacteria is bacteria that are living; and (ii) incubating the activated food in the presence of the non-live-bacteria preparation to kill and/or inhibit growth of pathogens and/or spoilage microorganisms on and/or in the food and thereby producing a safe and preserved food, and wherein the fermented bacteria is anti-pathogen bacteria and/or anti-spoilage bacteria. Preferably, the non-live-bacteria preparation includes one or more solid byproducts resulting from fermentation of the fermented bacteria; and presence of one or more of the solid byproducts during incubating kills and/or inhibits growth of pathogens and/or spoilage microorganisms on and/or in the activated food.

According to one preferred embodiment of the present teachings, the solid byproducts include fermented bacteria, but the fermented bacteria are bacteria that are dead. According to an alternate embodiment of the present teachings, the fermented bacteria are substantially depleted from the non-live-bacteria preparation.

In another aspect, the present teachings disclose processes for producing a non-live-bacteria preparation. One such exemplar process includes: (i) obtaining a fermentate that includes a growth medium and one or more solid byproducts, wherein one or more of the solid byproducts include bacteria in a fermented and/or fermenting state and fermentation byproducts produced by the bacteria; and (ii) deactivating the bacteria to produce the non-live-bacteria preparation; and wherein the bacteria is anti-pathogen bacteria and/or anti-spoilage bacteria. According to one embodiment of the present teachings, deactivating includes killing the bacteria, and wherein the non-live-bacteria preparation includes bacteria that are dead and one or more of the solid byproducts. According to an alternate embodiment of the present teachings, deactivating includes separating the bacteria from the growth medium and the solid byproducts to produce separated bacteria and the non-live-bacteria preparation, which includes one or more of the solid byproducts that are substantially depleted of the bacteria.

In yet another aspect, the present teachings disclose activated food compositions. One such exemplar activated food composition includes: (i) a food; and (ii) an effective amount of non-live-bacteria preparation present on and/or in the food, and wherein the non-live-bacteria preparation includes one or more solid byproducts resulting from fermentation of fermented bacteria, but the non-live-bacteria preparation is substantially depleted of the fermented bacteria, and the fermented bacteria are anti-pathogen and/or spoilage bacteria that are living; and wherein an effective amount of the non-live-bacteria preparation is sufficient to kill and/or inhibit the growth of pathogens and/or spoilage-microorganisms upon incubation of the activated food composition. According to one embodiment of the present teachings, the non-live-bacteria preparation in the activated food composition is substantially depleted of fermented bacteria. According to an alternate embodiment of the present teachings, the solid byproducts in the activated food composition include the fermented bacteria, but the fermented bacteria are bacteria that are dead.

In yet another aspect, the present teachings disclose preserved food compositions. One such exemplar preserved food composition includes: (i) an incubated food that has undergone incubation in presence of an effective amount of a non-live-bacteria preparation; and (ii) an effective amount of incubated non-live-bacteria preparation present on and/or in the incubated food that killed and/or will promote killing of pathogens and/or spoilage microorganisms on and/or in the incubated food; and wherein the non-live-bacteria preparation includes one or more byproducts resulting from fermentation of fermented bacteria, but the non-live-bacteria preparation is substantially depleted of the fermented bacteria, and the fermented bacteria are anti-pathogen and/or anti-spoilage bacteria that are living.

In yet another aspect, the present teachings disclose systems for producing a non-live-bacteria preparation. One such exemplar system includes: (i) a mixing chamber for mixing growth media components to produce a growth medium; (ii) an inoculating chamber for inoculating the growth medium with an inoculant to produce an inoculated growth medium, wherein the inoculant includes at least one anti-pathogen and/or at least one anti-spoilage bacteria; (iii) an incubating chamber for incubating the inoculated growth medium to produce a fermented growth medium; (iv) a first conduit for delivering the growth medium to the inoculating chamber to produce an inoculated growth medium; (v) a second conduit for delivering the inoculated growth medium to the incubating chamber to produce a fermentate; and (vi) one or more other conduits for delivering the fermentate or for delivering non-live-bacteria preparation intermediates for further processing to produce the non-live-bacteria preparation. According to one preferred embodiment of the present teachings, the system includes a concentrating chamber for concentrating the non-live-bacteria preparation to produce a non-live-bacteria concentrate. The system may also include a separating chamber for separating the anti-pathogen and/or anti-spoilage bacteria from the fermented growth medium to produce a non-live-bacteria preparation and/or a non-live-bacteria preparation intermediate. The system may also include a killing chamber capable of substantially killing the anti-pathogen and/or anti-spoilage bacteria in the fermented growth medium to produce a non-live-bacteria preparation.

In yet another aspect, the present teachings disclose processes for producing a non-retorted food product packaged for long-term storage. One such exemplar process includes: (i) obtaining a food, one or more anti-pathogen and/or anti-spoilage bacteria, a storage container, and a respective lid for the storage container, (ii) fermenting the anti-pathogen and/or the anti-spoilage bacteria in the food to form a fermented food, wherein the fermented food has a pH value that is less than about 5.5; (iii) heating the fermented food to produce a heated, fermented food; (iv) filling the storage container with the heated, fermented to produce a filled storage container, wherein the heated, fermented food has a temperature value that is at least about 71° C. during the filling; and (v) sealing the filled storage container with the respective lid to produce a non-retorted food product packaged for long-term storage, thereby preventing the non-retorted food product packaged for long-term storage from producing a puffy lid during long-term storage.

In yet another aspect, the present teachings disclose other processes for producing a safe and preserved food product for long-term storage. One such exemplar process includes: (i) obtaining a food, a carbohydrate source, a culture energy source, a source of vitamins, a source of minerals, oil, an anti-pathogen and/or anti-spoilage bacteria, a storage container, and a respective lid for the storage container; (ii) grinding the food to produce a ground food; (iii) mixing the carbohydrate source into the ground food to create a first food mixture; (iv) mixing the source of vitamins, the source of minerals, and the oil into the first food mixture to produce a second food mixture; (v) mixing the culture energy source in the second food mixture to produce a third food mixture; (vi) inoculating the anti-pathogen and/or anti-spoilage bacteria in the third food mixture to produce an inoculated food mixture; (vii) heating the inoculated food mixture to produce a heated, inoculated food mixture; (viii) fermenting the heated, inoculated food mixture until a pH value of the heated, inoculated food mixture is less than about 4.6 to produce a fermented food composition; (ix) pumping the fermented food composition to produce a vacuumized product; (x) filling the storage container with the vacuumized product while the vacuumized product is at least about 49° C. to produce a filled storage container; and (xi) sealing the filled container with the respective lid to produce a non-retorted food product packaged for long-term storage, thereby preventing the non-retorted food product packaged for long-term storage from producing a puffy lid during long-term storage.

In yet another aspect, the present teachings disclose processes for decontaminating a non-edible surface. One such exemplar process includes: introducing a non-live-bacteria preparation on the non-edible surface to produce a decontaminated non-edible surface, and the non-live-bacteria preparation results from fermentation of fermented bacteria, but the non-live-bacteria preparation is substantially depleted of the fermented bacteria, and the fermented bacteria are bacteria that are living; and wherein the fermented bacteria is anti-pathogen bacteria and/or anti-spoilage bacteria. Preferably, the non-live-bacteria preparation includes one or more solid byproducts resulting from fermentation of the fermented bacteria; and the presence of one or more of the solid byproducts kills and/or inhibit growth of pathogens and/or spoilage microorganisms on the non-edible surface.

### BRIEF DESCRIPTION OF THE DRAWINGS

FIG. 1 is a flowchart showing certain salient steps of a process, according to one embodiment of the present teachings, for promoting safety and preservation of food.

FIG. 2 is a flowchart showing certain salient steps of a process, according to one embodiment of the present teachings, for producing a non-live-bacteria preparation.

FIG. 3 is a block diagram showing certain components of a system, according to one embodiment of the present teachings, for producing non-live-bacteria preparations and concentrates.

FIG. 4 is a flowchart showing certain salient steps of a process, according to one embodiment of the present teachings, for producing a non-retorted food product for long-term storage.

FIG. 5 is a flowchart showing certain salient steps of a process, according to another embodiment of the present teachings, for producing a non-retorted food product for long-term storage.

FIG. 6 is a graph showing the death of E. coli on a logarithmic scale versus time on shelf-stable wet foods after treatment with non-live-bacteria preparations.

FIG. 7 is a graph showing the death of E. coli on a logarithmic scale versus time and the E. coli was present on dog biscuits that were untreated, treated with a live-bacteria preparation, or treated with a non-live-bacteria preparation substantially depleted of bacteria.

FIG. 8 is a graph showing the death of E. coli on a logarithmic scale versus time and the E. coli was treated with non-live-bacteria preparations comprised of cell-free washings that were stored at different temperatures.

FIG. 9 is a 1000× photomicrograph of a Pediococci cell culture that is stained for acid mucins.

FIG. 10 is a graph showing death of E. coli on a logarithmic scale versus time and the E. coli was present on kibbles treated with a non-live-bacteria preparation.

FIG. 11 is a graph showing death of E. coli on a logarithmic scale versus time and the E. coli was present on kibbles treated with palatant only or treated with a 16× non-live-bacteria concentrate combined with a palatant.

FIG. 12 is a graph showing concentrations of a non-live-bacteria preparation that kill E. coli, presented on a linear scale versus temperature.

### DETAILED DESCRIPTION OF THE PREFERRED EMBODIMENTS

In the following description, numerous specific details are set forth in order to provide a thorough understanding of the present teachings. It will be apparent, however, to one skilled in the art that the present teachings may be practiced without limitation to some or all of these specific details. In other instances, well-known process steps have not been described in detail in order to not unnecessarily obscure the present teachings.

To avoid the undesirable costs and resources (e.g., high amounts of heat, sealed packages, or costly capital equipment) associated with conventional techniques for promoting food safety and preservation, as well as the undesirable side effects of bacterial fermentation and/or product-handling challenges associated with using less expensive conventional techniques, such as live-bacteria preparations, it has been surprisingly and unexpectedly been found that the benefits of live-bacteria preparations may be achieved by using non-live-bacteria preparations and their concentrates to promote safety and preservation of food, as well as to decontaminate non-edible surfaces.

To this end, the present teachings offer systems, methods, and compositions related to non-live-bacteria preparations (described in further detail below), which may surprisingly and unexpectedly be used to promote human and animal food safety and preservation. As used herein, food safety refers to reducing or eliminating pathogenic organisms on and/or in food, and food preservation refers to reducing or eliminating spoilage microorganisms on and/or in food.

In one aspect, the present teachings disclose an activated food composition. According to one embodiment of the present teachings, an activated food composition includes a food and an effective amount of a non-live-bacteria preparation present on and/or in the food. An activated food composition may be thought of as a food in and/or on which a non-live-bacteria preparation has been introduced or applied, but prior to any period of treatment and/or incubation sufficient for the non-live-bacteria preparation to produce its anti-pathogen and/or anti-spoilage effects.

The present teachings contemplate use of any food or beverage in an activated food composition to promote food safety and food preservation. To this end, food in an activated food composition may be any human food, pet food, animal feed, a food ingredient, or a beverage. Further, a food may be raw or a prepared and/or cooked.

According to one embodiment of the present teachings, food in an activated food has a moisture content that is less than about 20%. According to another embodiment of the present teachings, food in an activated food has a moisture content that is less than about 60% and may be thought of as semi-moist. According to another embodiment of the present teachings, food in an activated food composition has a moisture content that is less than about 70% and may be thought of as wet. According to still yet another embodiment, food in an activated food composition may not be physically similar throughout (e.g., food that contains solid pieces, such as meat, within a fluid portion, such as gravy; food that contain a hard outer shell with a soft inner core; or foods that contain crusts with fillings on the inside). In those embodiments where food in an activated food composition is a beverage, such food may have a moisture content of up to about 99.9%.

A non-live-bacteria preparation, as used herein, refers to a preparation obtained from a fermentate (i.e., a bacterial growth culture in which bacterial fermentation has occurred, or, a fermented growth culture) that is produced from fermentation of bacteria selected for their anti-pathogen and/or anti-spoilage activity. As explained in further detail below, a non-live-bacteria preparation is characterized by the absence of living bacteria therein. In other words, a non-live-bacteria preparation includes components produced during fermentation of live bacteria, but is substantially depleted of live bacteria, including when in use in an activated food composition.

According to one embodiment of the present teachings, a non-live-bacteria preparation includes solid byproducts that result from fermentation of anti-pathogen and/or anti-spoilage bacteria (explained in further detail below). These solid byproducts, which also may also be thought of as “bacterial solids,” may include fermentation byproducts produced from fermented bacteria, components associated with bacteria but not produced during fermentation, dead whole bacteria, and cellular debris. The solid byproducts, including fermentation byproducts, may be thought of as including at least some portion of the “active ingredients” of a non-live-bacteria preparation, insofar as they include solid components that kill and/or inhibit the growth of pathogens and spoilage microorganisms on and/or in food. The non-live-bacteria preparations disclosed herein include known fermentation byproducts and other uncharacterized entities that promote safety and preservation of foods. Further, the entities may be individual components and/or a mixture of components.

The present teachings recognize that one or more fermentation byproducts in a non-live-bacteria preparations promote food safety and preservation by facilitating growth inhibition and/or death of one or more pathogens and/or food-spoilage microorganisms on and/or in food. According to one embodiment of the present teachings, a fermentation byproduct in a non-live-bacteria preparation includes at least one member selected from a group comprising pediocin, bacteriocin, acid mucin, propionic acid, glycoprotein, nisin A, nisin Z, nisin Q, nisin F, nisin U, nisin U2, salivarcin X, lacticin J46, lacticin 481, lacticin 3147, salivarcin A, salivarcin A2, salivarcin A3, salivarcin A4, salivarcin A5, salivarcin B, streptin, salivaricin A 1, streptin, streptococcin A-FF22, BHT-Aa, BHT Ab, mutacin BNY266, mutacin 1140, mutacin K8, mutacin II, smbAB, bovicin HJ50, bovicin HC5, macedocin, plantaricin W, lactocin 5, cyctolysin, enterocin A, divercin V41, divercin M35, bavaricin, coagulin, pediocin PA-1, mundticin, piscicocin CS526, piscicocin 126/Vla, sakacin P, leucocin C, sakacin 5X, enterocin CRL35/mundticin, avicin A, mundticin I, enterocin HF, bavaricin A, ubericin A, leucocin A, mesentericin Y105, sakacin G, plantaricin 423, plantaricin C19, curvacin A/sakacin A, camobacteriocin BM 1, enterocin P, piscicoin V lb, penocin A, bacteriocin 31, bacteriocin RC714, hiracin JM79, bacteriocin T8, enterocin SE-K4, camobacteriocin B2, SRCAM 1580, CONCENSUS, phenyllactic acid, 3-hydroxyphenyllactic acid, 4-hydroxyphenylactic acid, 3-hydroxy propanaldehyde, 1,2 propandiol, 1,3 propandiol, hydrogen peroxide, ethanol, acetic acid, carbon dioxide, carbonic acid, propanoic acid, butyric acid, cyclic dipeptides, cyclo(L-Phe-L-Pro), cyclo(L P-Traps-4-0H-L-Pro), 3-(R)-hydroxydecanoic acid, 3-hydroxy-5-cic dodecanoic acid, 3-(R)-hydroxy dodecanoic acid, and 3-(R)-hyroxytetradecanoic acid). According to another embodiment of the present teachings, a fermentation byproduct includes any entity and/or component produced during fermentation of anti-pathogen and/or anti-spoilage bacteria that promotes food safety and/or food preservation.

In certain embodiments of the present teachings, solid byproducts in a non-live-bacteria preparation includes bacteria that are dead. Preferably, dead bacteria in a non-live-bacteria preparation have been killed after undergoing fermentation that produces byproducts present in a non-live-bacteria preparation. A non-live-bacteria preparation (or a concentrate thereof, as explained in further detail below) that includes bacteria that are dead may also be referred to as “a non-live-bacteria preparation having dead bacteria.” The present teachings recognize that a non-live-bacteria preparation that includes dead bacteria provides the advantage of including, in a non-live-bacteria preparation, fermentation byproducts that are strongly associated with bacterial cells. Strongly associated may include fermentation byproducts being stuck to, contained in, or in very close proximity to a bacterial cells. Strongly associated may also include the fermentation byproduct having an affinity for components of the bacterial cell wall. This affinity may be based on polar and non-polar chemical bonds between the fermentation byproduct and bacterial cell wall. Fermentation byproduct that are strongly associated with bacterial cells may be released into a solution when the bacterial cells are washed or rinsed in a buffering solution (e.g., as shown below in Examples 16 and 17), or when the bacterial cells are treated with alcohol (e.g., as shown below in Examples 6 and 7.), which may disrupt the cellular structure of the bacterial cells, releasing the fermentation byproducts.

In other embodiments of the present teachings, a non-live-bacteria preparation does not include bacteria (either living or dead). Preferably, during a process of producing a non-live-bacteria preparation, bacteria is separated from a fermentate to produce a non-live-bacteria preparation and separated bacteria. A non-live bacteria preparation or concentrate that does not include bacteria may be referred to as “a non-live-bacteria preparation substantially depleted of bacteria.”

In either a non-live-bacteria preparation or concentrate having dead bacteria, or a non-live-bacteria preparation substantially depleted of bacteria, the preparation or concentrate is characterized by being substantially depleted of live bacteria. According to one embodiment of the present teachings, substantially depleted of live bacteria means a non-live-bacteria preparation includes less than about 10 cfu of live bacteria per gram of bacterial solids.

A non-live-bacteria preparation may also include a fluid portion. The fluid portion may include growth medium in which anti-pathogen and/or anti-spoilage bacteria are grown, and/or a fluid in which the solid byproducts have been suspended (e.g., water, buffering solution, or a rehydrating fluid). The present teachings recognize that a fluid portion of a non-live-bacteria preparation may also include solid byproducts that are “active ingredients” providing anti-pathogen and/or anti-spoilage activity. Such solid byproducts may be solubilized in the fluid portion. Thus, as the moisture content of the non-live-bacteria preparation decreases (e.g., during concentrating of a non-live-bacteria preparation), these solid byproducts will precipitate out of the fluid portion. To this end, the present teachings recognize that the fluid portion of a non-live-bacteria preparation may also be another non-live-bacteria preparation or intermediate.

According to one embodiment of the present teachings, a non-live-bacteria preparation has a moisture content of greater than about 12%. According to another embodiment of the present teachings, a non-live-bacteria preparation has a moisture content of less than about 12% and may be thought of as dry. A dry non-live-bacteria preparation may be thought of as having a texture that is akin to a pudding, gummy, snotty, glue-like, or ropey substance. According to yet another embodiment of the present teachings, a non-live-bacteria preparation has a moisture content of less than about 3% and may be thought as being substantially dried. A substantially dried non-live-bacteria preparation may have a texture that is increasingly brittle, rougher, and less elastic than a dry non-live-bacteria preparation.

Anti-pathogen and/or anti-spoilage bacteria that undergo fermentation that results in a non-live-bacteria preparation used in an activated food composition are selected for their ability to kill and/or inhibit the growth of one or more pathogens and/or one or more spoilage microorganisms on food. The present teachings contemplate use of any bacteria that promotes food safety and/or food preservation in such manner, including combinations of multiple bacterial strains. According to one embodiment of the present teachings, an anti-pathogen and/or anti-spoilage bacteria includes at least one member selected from a group comprising Bifidobacterium, Pediococcus, Lactobacillus, Lactococcus, Streptococcus, Leuconostoc, Weisella, Carnobacterium, Tetragenococcus, Oenococcus, Fructobacillus, Pediococcus acidilactici, Pediococcus pentosaceus, Lactococcus lactis, Lactococcus cremoris, Lactobacillus delbruckii var bulgaricus, Lactobacillus plantarum, Lactobacillus pentosum, Streptococcus thermophilus, Lactobacillus sakei and Lactobacillus curvatus, Lactobacillus acidophilus, Lactobacillus reuteri, Lactobacillus plantarum, Lactobacillus casei, Lactobacillus johnsonii, Lactobacillus rhamnosus, Lactobacillus gasseri, Bifidobacterium lactis, Bifidobacterium infantis, Bifidobacterium longum, Saccharomyces boulardii, Lactobacillus salivarus, Bacteroides spp, Enterococcus faecium, Lactobacillus delbrucekii spp bulgaricus, Lactobacillus cellibiosus, Lactobacillus curvatus, Lactobacillus brevis, Bifidobacterium bifidum, Bifidobacterium adolescents, Bifidobacterium animalis, Bifidobacterium thermophilium, Enterococcus faecalis, Streptococcus cremoris, Streptococcus salivarius, Streptococcus diacetylactis, Streptococcus intermedius, Lactobacillus paracasei, Streptococcus thermophiles, Streptococcus salivarius subsp. thermophiles, Bacillus cereus, Propionibacterium freundenreichii, and Oxalobacter formigenes. In other embodiments of the present teachings, any lactic acid bacteria or Lactobacillus species of bacteria is an anti-pathogen and/or anti-spoilage bacteria.

An activated food composition may also include one or more pathogens and/or spoilage microorganisms that are present on food and that have not been killed. According to one embodiment of the present teachings, a pathogen is at least one member selected from a group comprising Salmonella, pathogenic Escherichia coli, Shigella, Listeria monocytogenes, Staphylococcus aureus, Campylobacter jejuni, Campylobacter coli, Clostridium botulinum, Clostridium perfringens, Trichinella spiralis, Vibrio parahaemolyticus, Vibrio cholera. According to other embodiments of the present teachings, however, a pathogen is any pathogen known to negatively impact food safety.

According to another embodiment of the present teachings, a food-spoilage microorganism is at least one member selected from a group comprising Rhizopus nigricans, Penicillium, Aspergillus niger, Bacillus subtilis, Enterobacter aerogenes, Saccharomyces, Zygosaccharomyces, Micrococcus roseus, Aspergillus, Rhizopus, Erwinia, Botrytis, Rhodotorula, Alcaligenes, Clostridium, Proteus vulgaris, Pseudomonas fluorescens, Micrococcus, Lactobacillus, Leuconostoc, Alcaligenes, Flavobacterium, Proteus, and Acetobacter. According to other embodiments of the present teachings, however, a spoilage microorganism is any microorganism known to promote food spoilage.

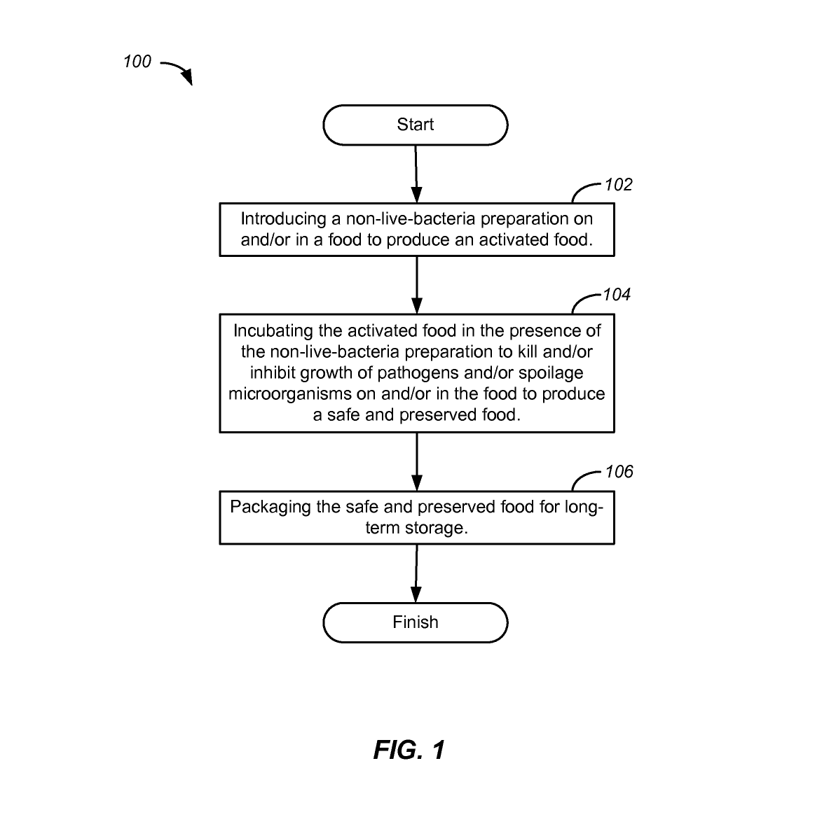

An effective amount of a non-live-bacteria preparation in an activated food composition means an amount of non-live-bacteria preparation sufficient to kill and/or inhibit the growth of pathogens and/or spoilage microorganisms on and/or in food after a sufficient incubation period (as explained in further detail below with reference to step 104 of FIG. 1). According to certain embodiments of the present teachings, an effective amount of a non-live-bacteria preparation also prevents further inoculation of a food by pathogens and/or spoilage microorganisms after a sufficient incubation period of the activated food composition.

The present teachings recognize that a non-live-bacteria preparation may be coated topically onto a surface of a food and/or mixed and/or blended into a food to produce an activated food composition. According to one embodiment of the present teachings, an effective amount of a non-live-bacteria preparation blended and/or mixed into an activated food composition requires bacterial solids in an amount that is at least about 0.0022%, by weight, of the activated food composition, preferably at least about 0.022%, by weight, of the activated food composition, more preferably between about 0.11%, by weight, of the activated food composition, and even more preferably about 0.22%, by weight, of the activated food composition. According to another embodiment of the present teachings, an effective amount of a non-live-bacteria preparation coated topically onto a surface of an activated food composition requires solid byproducts in an amount that is at least about 0.0000022%, by weight, of the activated food composition, preferably at least about 0.000022%, by weight, of the activated food composition, more preferably, between about 0.0011%, by weight, of the activated food composition, and even more preferably about 0.0095%, by weight, of the activated food composition. In certain other embodiments of the present teachings, a food may be blended and/or mixed with an effective amount of a non-live-bacteria preparation and also coated topically with an effective amount of a non-live-bacteria preparation.

An activated food composition may also include a carrier that is capable of being associated with a non-live-bacteria preparation such that the carrier facilitates the combining of a non-live-bacteria preparation with food. According to one embodiment of the present teachings, a carrier includes at least one member selected from a group comprising water, palatant, flavor, fat, coating, yeast, glaze, sauce, sauté sauce, dusting, pan coating, seasoning, covering, layering, film coating, chickpea, chickpea flour, soy flour, dextrose, potato flour, corn flour, wheat flour, grain flour, wheat middling, sucrose, fructose, galactose, lactose, fructooligosaccharides, inulin, and chicory. A carrier that is associated with a non-live-bacteria preparation may be thought of as an “activated carrier.”

In another aspect, the present teachings disclose a safe and preserved food composition. According to one embodiment of the present teachings, a safe and preserved food composition includes an incubated food and an effective amount of incubated non-live-bacteria preparation present on and in the safe and preserved food composition (i.e., where the food has been incubated in the presence of the non-live-bacteria preparation). A safe and preserved food composition may be thought of as an activated food composition (described above) after it has undergone sufficient treatment (e.g., time and temperature treatment) for the non-live-bacteria preparation to kill and/or inhibit growth of one or more pathogens and/or spoilage microorganisms on food. The components of a safe and preserved food are substantially similar to their counterparts described above with reference to an activated food composition. In certain embodiments of the present teachings, however, a safe and preserved food includes one or more pathogens and/or spoilage microorganisms that have been killed by the anti-pathogen and/or anti-spoilage activity associated with byproducts of anti-pathogen and/or anti-spoilage bacteria.

A safe and preserved food is characterized by being substantially free of live pathogens and/or spoilage microorganisms. According to one embodiment of the present teachings, substantially free of live pathogens and/or spoilage microorganisms means a safe and preserved food has less than about 10 cfu of pathogens and/or spoilage microorganisms per gram of food. According to another embodiment of the present teachings, substantially free of pathogens and/or spoilage microorganisms means a surface of food has less than about 10 cfu of pathogens and/or spoilage microorganisms per cm² of food surface.

In another aspect, the present teachings disclose a method of producing a safe and preserved food. To this end, FIG. 1 shows a flowchart that includes certain salient steps of a process 100, according to one embodiment of the present teachings and for producing a safe and preserved food. A safe and preserved food is substantially similar to its counterpart described above with reference to a safe and preserved food composition.

Process 100 begins with a step 102, which includes introducing a non-live-bacteria preparation on and/or in a food to produce an activated food. By way of example, step 102 may be carried out by mixing and/or blending a non-live-bacteria preparation into food, topically applying a non-live-bacteria preparation to the surface of food, injecting a non-live-bacteria preparation into food, soaking a food in a non-live-bacteria preparation, and/or mixing a non-live-bacteria preparation into a beverage. As explained above, an effective amount of a non-live-bacteria preparation is introduced to food in step 102.

The present teachings recognize that certain difficulties may be encountered applying a non-live-bacteria preparation to a solid food component, such that the non-live-bacteria preparation may not become sufficiently associated with inner portions of the solid food component and thus remain susceptible to growth of one or more pathogens and/or spoilage microorganisms. As used herein, a “solid food component” means a combination of food ingredients that have large pieces (i.e., about 3 mm or larger in diameter) or smaller pieces that are agglomerated and/or affixed to one another to give the appearance of a large piece.

To address this problem, multiple techniques for introducing a non-live-bacteria preparation to a solid food component sufficient to promote safety and preservation of the food's inner areas may be used. According to one embodiment of the present teachings, a non-live-bacteria preparation may, prior to introducing to a food, be mixed in a gravy or a marinade. The solid food components are also added to the gravy or marinade, and preferably mixed with, the gravy or marinade. After a sufficient period of time, the solid food component will absorb the liquid containing the non-live-bacteria preparation, thus killing pathogens and spoilage microorganisms contained on the inside of the solid food component.

According to another embodiment of the present teachings, an intermediate step of bathing a solid food component in a liquefied non-live-bacteria preparation for a period of time may be performed. In particular, this technique may be used as an intermediate step, prior to introducing a solid food component to other food, to provide the advantage of being able to more closely monitor the pathogen and spoilage microorganism load in the solid food component before adding it to the finished product.

According to yet another embodiment of the present teachings, a non-live-bacteria preparation and a solid food component are added to a liquid, creating a liquid mixture containing solid components. This liquid mixture containing solid components is then treated to a vacuum (e.g., by placing in a vacuum tumbler, a vacuum chamber, or a vacuum blender). The liquid mixture is pulled into the solid components, producing the effect of killing pathogens and/or spoilage microorganism in the inner areas of the solid food component. This technique provides the advantage of rapidly producing the anti-pathogen and anti-spoilage effects of the non-live-bacteria preparation of the present teachings, particularly with respect to the inner areas of a solid food component.

According to yet another embodiment of the present teachings, a non-live-bacteria preparation is introduced to a solid food component that is partially liquefied while retaining some characteristics of a solid food product, e.g., a meat or vegetable slurry.

According to yet another embodiment of the present teachings, a non-live-bacteria preparation that is dry or substantially dry is combined with a dry palatant, which is used to coat kibbled pet food. A dry or substantially dry non-live-bacteria preparation may be combined with a dry palatant using standard blending and/or mixing techniques. Further, a liquid non-live-bacteria preparation may be combined with a dry palatant using plating, spray drying, or encapsulation techniques well-known to those of skill in the art. It is surprising and unexpected that a dry and/or substantially dry non-live-bacteria preparation is effective at killing pathogens and/or spoilage microorganisms on and in coated kibbled pet food (which are also relatively dry), as conventional techniques require a source of moisture to kill pathogens and spoilage microorganisms. The non-live-bacteria preparations of the present teachings, however, realize a significant benefit of pathogen kill in the presence of dry or substantially dry non-live-bacteria preparations. In other words, the non-live-bacteria preparations of the present teachings unexpectedly and surprisingly do not require significant moisture to promote safety and preservation of food.

Next, a step 104 includes incubating the activated food in the presence of the non-live-bacteria preparation to kill and/or inhibit growth of pathogens and/or spoilage microorganisms on and/or in the food to produce a safe and preserved food. Incubating in step 104 may be carried out under any condition sufficient to promote the anti-pathogen and/or anti-spoilage effects of the non-live-bacteria preparation of the present teachings. According to one embodiment of the present teachings, incubating in step 104 is carried out at a temperature that is at least about 2° C. for a duration of about at least 24 hours. According to another embodiment of the present teachings, incubating is carried out at a temperature that is at least about 10° C. for a duration of at least about 12 hours. According to yet another embodiment of the present teachings, incubating is carried out at a temperature that is at least about 18° C. for a time that is at least about 5 minutes.

When step 104 is complete, a safe and preserved food is produced. According to certain preferred embodiment of the present teachings, however, the safe and preserved food is packaged for long-term storage and further use. To this end, process 100 includes an optional step 106, which includes packaging the safe and preserved food. According to one embodiment of the present teachings, a safe and preserved food has a shelf-life that is between about 1 month and about 60 months when stored at room temperature. According to another embodiment of the present teachings, a safe and preserved food has a shelf-life that is between about 1 month and about 144 months when refrigerated at about 4° C.

The present teachings further recognize that a non-live-bacteria preparation or an activated carrier (i.e., a carrier associated with a non-live-bacteria preparation) may also be packaged for further use. In other words, a non-live-bacteria preparation or an activated carrier may be prepared, packaged, and stored, and then applied to a food to promote safety and preservation of that food at a later date. The present teachings recognize substantially similar time frames for long-term storage of non-live-bacteria preparations and activated carriers as those described above with reference to a safe and preserved food.

In another aspect, the present teachings disclose a process for decontaminating a non-edible surface using a non-live-bacteria preparation. The present teachings recognize that in a similar manner to which a non-live-bacteria preparation is used to promote food safety and preservation, a non-live-bacteria preparation may be used to promote decontamination of a non-edible surface. To this end, according to certain embodiments of the present teachings, a non-live-bacteria preparation is applied to a non-edible surface to promote decontamination of the non-edible surface by killing and/or inhibiting growth of pathogens and/or spoilage microorganisms thereon.

According to one embodiment of the present teachings, a non-edible surface that is decontaminated by a non-live-bacteria preparation includes at least one member selected from a group comprising pipe, tool, chopper, grinder, hammer mill, roller mill, flaker, emulsifier, blender, block pre-breaker, block breaker, extruder, coating equipment, APEC coater, spray bar, dryer, conveyor, pellet mill, steam flaker, vortex mill, storage bin, band saw, knife, cutting surface, countertop, wood chopping block used in food preparation, stainless steel counter top, counter top, bathroom, table, wet bar, alcohol serving establishment, drainage system, disposal system, sink drain, kitchen sink, toilet, toilet bowl rim, bath drain, bath tub, garbage can, barn environment, barn stall, horse stall, livestock exhibition hall, livestock bedding area, retention pond, sewage holding tank, areas around sewage holding tanks, dog kennel, dog cage, cat cage, cat carrier, dog carrier, cattery, automotive garage, air recirculation system on jet airliner, shrimp shell after meat has been removed, fish parts after fillets have been removed, animal parts after meat has been removed, human hair, dog hair coat, diaper, cream, skin, dermatitis, psoriasis, eczema, bed sore, dentifrice, oral rinse, vaginal rinse, douche, tampon, feminine pad, waste pail, garbage can, dumpster, waste handling container, commercial waste management vehicle, garbage truck, waste hauling equipment, waste capture equipment, bin, can, vehicle, tote, conveyer, waste processing equipment, waste, under-arm, vagina, foot, outer ear, and diaper.

Applying a non-live-bacteria preparation or a non-live-bacteria concentrate to a non-edible surface may be carried out by any technique well known to those of skill in the art. By way of example, applying a non-live-bacteria preparation to a non-edible surface includes using at least one member selected from a group comprising spray, wash, blotting, mist, a moisturizer, and application.

Applying a non-live-bacteria preparation to a non-edible surface substantially decontaminates the non-edible surface. According to one embodiment of the present teachings, a substantially decontaminated non-edible surface has less than about 100 cfu of pathogens and/or spoilage microorganisms per 1 cm² of the non-edible surface.

According to one embodiment of the present teachings, an amount of non-live-bacteria preparation that is used to substantially decontaminate a non-edible surface includes between about 0.0001 grams and about 10 grams of bacterial solids per 100 cm² of non-edible surface.

A non-live-bacteria preparation may be applied directly to a non-edible surface, or may be added in conjunction with a carrier that is associated with the non-live-bacteria preparation or non-live-bacteria concentrate. Preferably, a carrier for a non-live-bacteria preparation for use on non-edible surfaces is at least one member selected from a group comprising water, sugar (e.g., dextrose), powdered cellulose, paint, varnish, lacquer, and laminate. The present teachings recognize that these carriers are safe for surface contact with food and/or beverages, which is useful if the non-live-bacteria preparations of the present teachings are used to decontaminate non-edible surfaces involved in food processing.

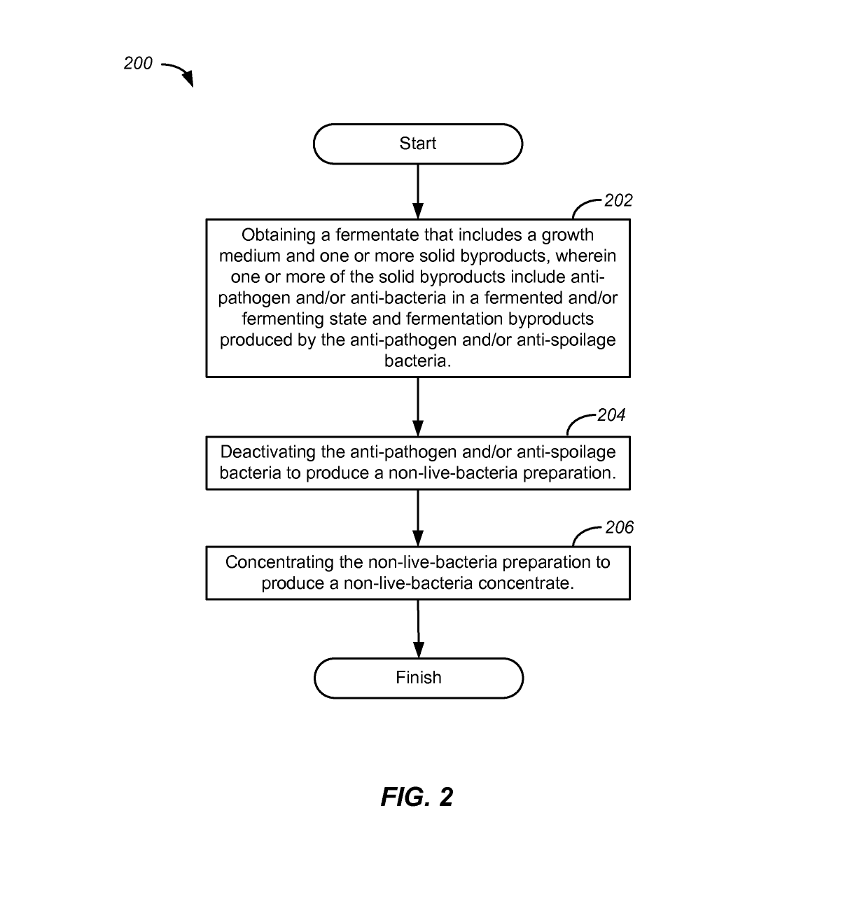

In another aspect, the present teachings disclose a process for producing a non-live-bacteria preparation. To this end, FIG. 2 shows a flowchart that includes certain salient steps of a process 200, according to one embodiment of the present teachings and for producing a non-live-bacteria preparation. Process 200 begins with a step 202, which includes obtaining a fermentate that includes a growth medium and one or more solid byproducts, as well as fermented and/or fermenting anti-pathogen and/or anti-spoilage bacteria, which produced and/or generated components of the solid byproducts. The fermentate of step 202 may be thought of as any conventional fermentate or fermentation growth culture produced from fermentation of anti-pathogen and/or anti-spoilage bacteria. Accordingly, the fermentate may include cellular debris, live and/or dead fermented bacteria, and fermentation byproducts, as well as growth medium and/or any component added to growth medium to facilitate growth of anti-pathogen and/or anti-spoilage bacteria. According to an alternate embodiment of the present teachings, however, a fermentate includes bacteria and other solid byproducts that have been reconstituted in water, a hydrating solution, a buffer solution, or a saline solution.

Obtaining in step 202 may also include carrying out one or more steps for producing a fermentate, including but not limited to obtaining a growth medium, obtaining one or more anti-pathogen and/or anti-spoilage bacteria, inoculating a growth medium with anti-pathogen and/or anti-spoilage bacteria to produce an inoculate, and/or incubating an inoculate to produce a fermentate.

A growth medium in a fermentate may be any growth media that is well known to those of skill in the art for fermenting bacteria. According to one embodiment of the present teachings, a growth media includes at least one member selected from a group comprising a chicken broth, beef broth, a vegetable broth, turkey broth, pork broth, lamb broth, mutton broth, fish broth, broth made from meat and/or bone, DeMan, Rogosa, Sharpe (MRS) Lactobacilli broth, All Purpose Tween (APT) broth, and Lactobacillus Selection (LBS) broth. Further, a growth media may include other additional components that facilitate fermentation of bacteria, such as a carbohydrate source (e.g., apple juice, apple juice concentrate, dextrose, dextrose monohydrate, dextrose hydride, grape sugar, D-glucose, corn sugar, sucrose, lactose, maltose, corn syrup solids, high fructose corn syrup, levulose, glucose, galactose, xylose, ribose, mannose, sorbose, amino acids, high fructose corn syrup, apple pulp, honey, sugar, maple syrup, pear juice, grape juice, orange juice, or fruit juice), vitamins, minerals, and amino acids.

According to another embodiment of the present teachings, a growth medium includes a non-toxic source of oleic acid. The present teachings recognize that a non-toxic source of oleic acid facilitates fermentation of bacteria. A non-toxic source of oleic acid may include at least one member selected from a group comprising Tween 80, polysorbate 80, polyoxyethylene (20) sorbitan monoleate, Tween 20, Brij 35, Mega 8, and detergent in the presence of oleic acid. A non-exhaustive list of detergents is found in the Detergent Handbook accessed on Nov. 30, 2015 in http://www.genotech.com/bulletins/detergent-handbook.pdf and is herein incorporated by reference.

Anti-pathogen and/or anti-spoilage bacteria in a fermentate may be grown using conditions well known to those of skill in the art to facilitate fermentation of growing bacteria. Thus, the present teachings contemplate using a variety of parameters (e.g., time, temperature, pH, concentration, growth-nutrient source and levels), so long as such parameters promote fermentation of anti-pathogen and/or anti-spoilage bacteria sufficient to prepare the non-live-bacteria preparations of the present teachings.

The present teachings recognize that using conventional fermentates to produce a non-live-bacteria preparation provides certain key advantages. For example, fermentates are easy to grow, requiring easily obtained resources, simple laboratory equipment, and straightforward techniques. Further, fermentates are often found as waste products from entities and individuals that grow bacteria and thus represent an additional use for materials that would otherwise be discarded. According to one embodiment of the present teachings, obtaining in step 202 includes obtaining a fermentate in which the anti-pathogen and/or anti-spoilage bacteria have already been killed and/or separated from the fermentate.

According to one embodiment of the present teachings, step 202 includes inoculating, into a growth medium, about 1×10⁴ cfu of an anti-pathogen and/or anti-spoilage bacteria per gram of growth media (expressed herein as units of “cfu/gram”). According to another embodiment of the present teachings, growing and/or fermenting anti-pathogen and/or anti-spoilage bacteria is carried out at a temperature range that is between about 28° C. and about 37° C., and preferably, between about 32° C. and about 35° C. While wishing not to be bound to theory, it is thought that bacterial growth conditions that use such temperature ranges facilitate anti-pathogen and/or anti-spoilage activity associated with producing the non-live-bacteria preparations of the present teachings. In other embodiments of the present teachings, however, any growth condition that facilitates fermentation of bacteria necessary to produce a fermentate is used.

Next, a step 204 includes deactivating anti-pathogen and/or anti-spoilage bacteria to produce a non-live-bacteria preparation. As used herein, deactivating anti-pathogen and/or anti-spoilage bacteria means eliminating live bacteria from the fermentate obtained in step 202 to produce a non-live-bacteria preparation. In certain embodiments of the present teachings, steps 202 and 204 may be combined by obtaining a fermentate from which live bacteria has already been deactivated.

According to one preferred embodiment of the present teachings, deactivating in step 204 is carried out by killing anti-pathogen and/or anti-spoilage bacteria to produce a non-live-bacteria preparation. Killing bacteria according to step 204 may be carried out by any technique well known to those of skill in the art that is sufficient to kill anti-pathogen and/or anti-spoilage bacteria in a fermentate while retaining the anti-pathogen and/or anti-spoilage activity associated with the non-live-bacteria preparations of the present teachings. According to one embodiment of the present teachings, killing includes at least one member selected from a group comprising adding alcohol, heating, sonicating, using ionizing radiation, gassing (e.g., with ethylene and propylene oxides and methyl bromide), electrical shocking, cavitating, freezing, applying inorganic acids (e.g., phosphoric, bromic, chloric, perchloric, sulfuric, nitric), applying organic acids (e.g., acetic, propionic, lactic, butyric, citric, tartaric, malic), exposing to ultra-violet light, using a French pressure cell, HPP, enzyme treating (e.g., lysozyme, proteases and papain), grinding (e.g., with glass beads, using diatomaceous earth, sand, metal and diamond dust), sonicating, adding free fatty acids, adding antibiotics, adding bacteriocins, colicins or vancomycin, HPP, irradiation, and microwaving.

By way of example, killing bacteria according to the present teachings may be carried out by adding alcohol to the fermentate, and preferably, at least one member selected from a group comprising methanol, ethanol, and isopropyl alcohol. Alcohol is preferably added by using a solution that is between about 70% alcohol, by volume of total solution, and about 100% alcohol. Further, alcohol may be added to a fermentate at a ratio, by mass, of alcohol to fermenting growth culture, that is about 1:1, about 1:2, about 1:3, about 1:4, about 1:5, or about 1:10.

According to another preferred embodiment of the present teachings, deactivating in step 204 is carried out by separating anti-pathogen and/or anti-spoilage bacteria from fermentate obtained in step 202 to produce a non-live-bacteria preparation from the remainder portion of the fermentate. The present teachings recognize that fermentation byproducts that have anti-pathogen and anti-spoilage microorganism activity are included in the remainder portion of the fermentate (i.e., the portion of fermentate that remains after bacteria is separated in step 204). The present teachings also recognize, however, that bacteria separated in step 204 may also include fermentation byproducts that are strongly associated with the separated bacteria. Accordingly, as explained in further detail below, the separated bacteria may be used to prepare one or more other non-live-bacteria preparations.

Separating anti-pathogen and/or anti-spoilage bacteria from a fermentate according to step 202 may be carried out by any technique well known to those of skill in the art for separating bacteria from a fermentate. According to one embodiment of the present teachings, separating includes at least one technique selected from a group comprising centrifuging, sedimenting, filtering, and using a flocculant (e.g., alum, chitosan, diatomaceous earth, charcoal, or activated carbon).

After separating in step 204, a non-live-bacteria preparation is substantially depleted of bacteria, preferably whole-cell and/or intact bacteria, both alive and dead. According to one embodiment of the present teachings, substantially depleted of bacteria means a non-live-bacteria preparation or concentrate has less than about 1000 bacterial cells per milliliter of preparation or concentrate.

In order to produce more potent non-live-bacteria preparations, the present teachings recognize that the non-live-bacteria preparations of the present teachings may be concentrated to increase an amount of solid byproducts relative to an amount of moisture in the non-live-bacteria preparation. To this end, an optional step 206, which includes concentrating the non-live-bacteria preparation, may be carried out to produce a non-live-bacteria concentrate, which may also be considered a non-live-bacteria preparation. As a non-live-bacteria preparation becomes more concentrated and is transformed to a non-live-bacteria concentrate, it may develop a consistency that is akin to a pudding, gummy, snotty, glue-like, or ropey substance.

According to one embodiment of the present teachings, concentrating may be carried out by decreasing the amount of moisture in a non-live-bacteria preparation. Concentrating in this manner may be carried out by any technique well known to those of skill in the art for reducing moisture in a mixture or solution. According to one embodiment of the present teachings, concentrating includes using at least one member selected from a group comprising centrifuging, sedimenting, distilling, spray drying, vacuum drying, evaporating (e.g., using a rotary vacuum evaporator or evaporating trays), and heating.

According to one embodiment of the present teachings, concentrating includes removing up to about 60% moisture from a non-live-bacteria preparation to produce a non-live-bacteria concentrate. According to another embodiment of the present teachings, concentrating includes removing up to about 99% moisture from a non-live-bacteria preparation to produce a non-live-bacteria concentrate.

Removing moisture serves, in part, to remove lactic acid produced during fermentation of bacteria in fermenting growth cultures, which when the non-live-bacteria concentrates are added to food (i.e., as explained above with reference to step 102 of FIG. 1), avoids the sour taste and acidity associated with fermented foods produced using conventional techniques. Likewise, removing moisture also serves to produce non-live-bacteria concentrates that have enhanced anti-pathogen and/or anti-spoilage activity per unit mass or volume. Further still, concentrating a non-live-bacteria preparation produces an end-product that is lighter and easier to transport, thus reducing shipping or transportation costs.

According to an alternate embodiment of the present teachings, however, concentrating is carried out by adding bacterial solids produced from one fermentate to another fermentation/or another non-live-bacteria preparation. By way of example, a non-live-bacteria preparation may be prepared according to steps 202 and 204, and the resulting bacterial solids may be separated and added to another non-live-bacteria preparation to produce a non-live-bacteria concentrate. Similarly, as explained in further detail below, bacterial solids may be washed or rinsed in a buffering or rehydrating solution, which facilitates release and/or solubilization at least some of the bacterial solids in the buffering or rehydrating solution, and then the same buffering or rehydrating solution may be used to wash or rinse other bacterial solids to increase the concentration of solid byproducts therein, thus producing a non-live-bacteria concentrate.

According to certain embodiments of the present teachings, concentrating may also be carried out by concentrating a fermentate prior to deactivating in step 204.

As mentioned above, bacteria separated from a fermentate may be further treated to produce another non-live-bacteria preparation. In particular, the present teachings recognize that further treatment of the separated bacteria with one or more rinsing or washing steps in a buffered and/or rehydrating solution, to produce a rehydrated solution that includes rehydrated bacteria, may release fermentation byproducts that are strongly associated with the bacterial cell structure and that are collected and/or solubilized in the buffered and/or rehydrating solution.

According to one embodiment of the present teachings, a buffering and/or rehydrating solution in which separated bacteria are rinsed and/or washed to produce rehydrated bacteria in a rehydrated solution includes at least one member selected from a group comprising Butterfield's Phosphate Buffered Diluent (“BPBD”), saline solution, normal saline, physiological saline, 0.9% saline, 0.9% potassium chloride solution, Ringer's solution, acetone and water. Preferably, rehydrating produces rehydrated bacteria at a concentration of less than about 30% by weight of rehydrated bacteria in the rehydrated mixture.

Because certain fermentation byproducts may be strongly associated with the bacterial cell structure, such rinsing and/or washing to collect the fermentation byproducts in a buffered and/or rehydrated solution may be facilitated in various ways. According to one embodiment of the present teachings, washing and/or rinsing separated bacteria (and/or other bacterial solids that have precipitated out of solution) includes shaking, swirling, creating turbulence, blending, or high-speed blending. According to another embodiment of the present teachings, washing and/or rinsing separated bacteria includes adding one or more proteolytic enzymes (e.g., trypsin) or detergents (e.g., Tergitol 7, Tween 80, lecithin, sodium dodecyl sulfate, or other detergents listed in the Detergent Handbook accessed on Nov. 30, 2015 in http://www.genotech.com/bulletins/detergent-handbook.pdf). According to yet another embodiment of the present teachings, rinsing or washing separated cells includes using organic acids such as acetate, propionate, butyrate, citrate, or lactate.

After rinsing and/or washing, rehydrated bacteria in a rehydrated mixture may be treated to the same and/or similar steps disclosed above with respect to a fermentate to produce a non-live-bacteria preparation. By way of example, the rehydrated bacteria may be subjected to steps of killing, concentrating, separating, and/or drying.

Further, one or more rinses and/or washes may be carried out on separated bacteria (or on solid byproducts that include separated bacteria and/or dead bacteria) to produce one or more “cell-free washings” that collect fermentation byproducts that are strongly associated with bacteria. By way of example, a separated bacteria and/or solid byproducts may be washed with buffering solution, the cells may collected (e.g., by centrifugation, sedimentation, filtration), and then washed again with the same buffering solution, or with a different buffering solution that is added to buffering solution used in earlier washing steps. In such manner, anti-pathogen and/or anti-spoilage byproducts are disassociated from bacteria and suspended in the buffering solution washings, producing another non-live-bacteria preparation.

Bacteria collected in cell-free washings may be separated from the buffering solution washings to produce a non-live-bacteria preparation that is substantially depleted of bacteria. According to one embodiment of the present teachings, such a non-live-bacteria preparation may be further treated with a concentrating step (in a manner analogous to the concentrating steps described above). Further, a cell-free washing may be used to treat additional samples of bacteria and/or solid byproducts to increase the concentration of fermentation byproducts in the cell-free washing.

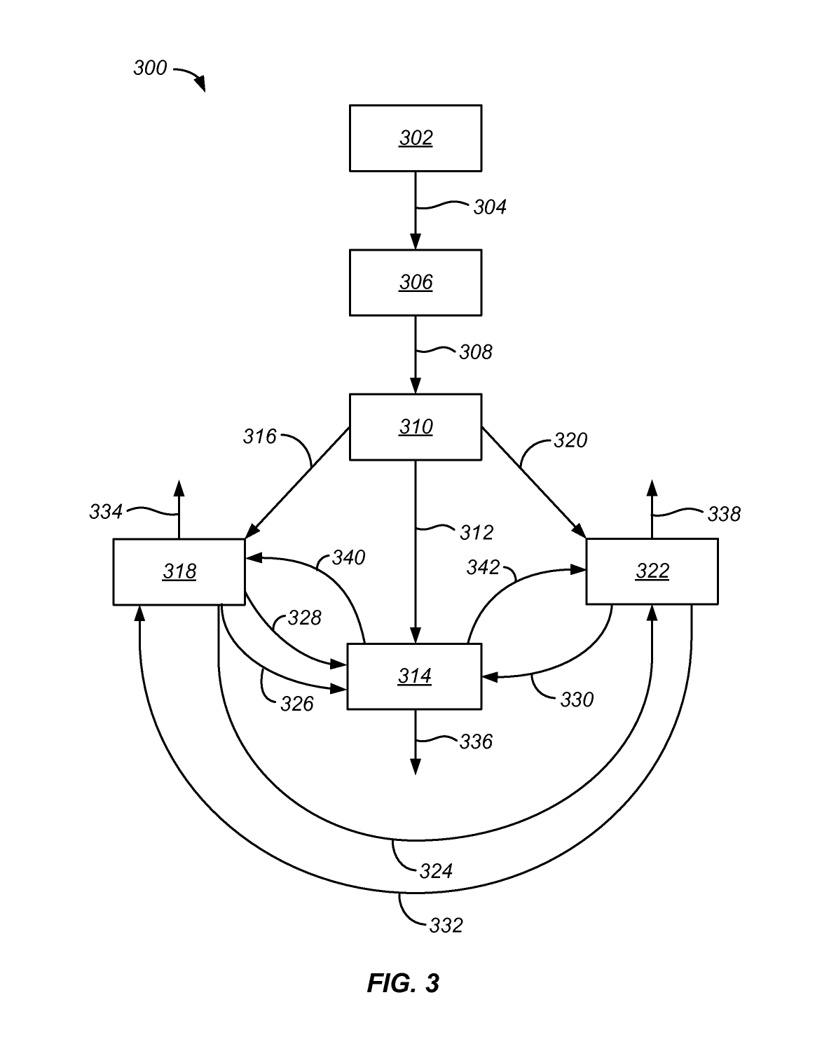

In another aspect, the present teachings disclose a system for producing a non-live-bacteria preparation and/or non-live-bacteria concentrate. To this end, FIG. 3 shows a block diagram of a system 300, according to one embodiment of the present arrangements and for producing a non-live-bacteria preparation or non-live-bacteria concentrate. System 300 includes a mixing chamber 302, an inoculating chamber 306, a growing chamber 310, a concentrating chamber 314, a separating chamber 318, and a killing chamber 322. As explained in further detail below, system 500 also includes conduits 304, 308, 312, 316, 320, 324, 326, 328, 330, and 332 that connect chambers 302, 306, 310, 314, 318, and 322, for delivering various intermediate products between the chambers. System 300 also includes an outlet 334 for delivering a non-live-bacteria preparation that is substantially depleted of bacteria for use, an outlet 336 for delivering non-live-bacteria concentrates (both including and not including dead whole-cell bacteria) for use, and an outlet 338 for delivering non-live-bacteria preparations having dead bacteria for use.

Mixing chamber 302 is any chamber and/or sub-system configured to receive and mix various components used to prepare a growth medium. To this end, mixing chamber 302 may include one or more components to facilitate mixing required to produce a growth medium, such as a high-shear mixer, a scraped surface paddle, or a centrifugal pump that recirculates a mixture.

According to one embodiment of the present arrangements, mixing chamber 302 is configured to receive and/or maintain water and/or any other fluid component of a growth medium at a temperature of about 85° C. and about 90° C. To this end, mixing chamber 302 may include components such as a heater (e.g., a heat exchanger and/or a fluid heat transfer system, such as a kettle-jacketed system) and/or thermometer to heat the growth medium and to ensure accuracy of temperature treatment.

A line 304 may be used to deliver growth medium prepared in mixing chamber 302 to inoculating chamber 306. Transfer of intermediate products through line 304 (as well as through lines 308, 312, 316, 320, 324, and 326) may be carried out using any technique well known to those of skill in the art. By way of example, gravity may be used to facilitate transfer of intermediate products produced in system 300, including but not limited to use of a centrifugal pump, a positive displacement pump, a Lobe pump, and/or a Waukesha-type pump.

Inoculating chamber 306 is configured to inoculate the growth medium produced in mixing chamber 302 with one or more anti-pathogen and/or anti-spoilage bacteria. According to one embodiment of the present arrangements, inoculating chamber 306 is also configured to add primary growth medium enhancements (e.g., dextrose, Tween 80, detergent, glycerine) and/or secondary growth medium enhancements (e.g., amino acids, proline, serine, threonine, cysteine) to the growth medium prior to inoculation to facilitate fermentation of anti-pathogen and/or anti-spoilage bacteria.

Inoculating chamber 306 is any chamber and/or sub-system configured to raise and/or lower temperatures of the components processed therein to facilitate production of an inoculate that includes anti-pathogen and/or anti-spoilage bacteria. According to one embodiment of the present arrangements, inoculating chamber 306 is configured to heat and/or maintain a temperature in chamber 306 that is about between about 85° C. and about 90° C. prior to adding primary growth medium enhancements. According to another embodiment of the present arrangements, inoculating chamber 306 is configured to cool its components to between about 70° C. and about 75° C. prior to adding secondary growth medium enhancements. According to yet another embodiment of the present arrangements, inoculating chamber 306 is configured to cool its components to between about 45° C. and about 50° C. prior to inoculating with one or more anti-pathogen and/or anti-spoilage bacteria. According to yet another embodiment of the present teachings, inoculating chamber 306 is configured to cool its components to between about 25° C. and about 50° C. after inoculation with one or more anti-pathogen and/or anti-spoilage bacteria. Accordingly, chamber 306 may be fitted with a thermometer, a thermocoupler, a heat exchanger, a fluid heat transfer system, and/or other components that facilitate accurate temperature treatment.

A conduit 308 may be used to deliver inoculated growth medium from inoculating chamber 306 to growing chamber 310. Growing chamber 310 is configured to grow the inoculated growth medium produced in inoculating chamber 306 at conditions sufficient to produce the components (i.e., fermented bacteria and/or fermentation byproducts) necessary to produce a fermentate for further processing into the non-live-bacteria preparations or concentrates of the present teachings. According to one embodiment of the present arrangements, growing chamber 310 is configured to treat an inoculated growth medium for duration that is between about 42 and about 54 hours at a temperature range of between about 25° C. and about 50° C.

The present teachings recognize that incubation of anti-pathogen and/or anti-spoilage bacteria in growing chamber 310 may also be facilitated by additional air exposure. To this end, growing chamber 310 may include any means of introducing additional air to a fermenting culture, including but not limited to a shaker, an agitator, and/or an air pump.

The fermentate produced in growing chamber 310 may be delivered for additional processing to produce a non-live-bacteria preparation. According to one embodiment of the present arrangements, a fermentate is delivered via conduit 316 to separating chamber 318.

Separating chamber 318 is configured to separate bacteria from the fermentate delivered from growing chamber 310. Separating in separating chamber 318 may be carried out using techniques and components well known to those of skill in the art for separating bacteria from fluid components.

According to one embodiment of the present arrangements, once live bacteria has been separated from the fermentate, the remainder portion, which preferably includes fermentation byproducts produced in growing chamber 318, may be delivered via outlet 334 for use as a non-live-bacteria preparation. According to another embodiment of the present arrangements, the same non-live-bacteria preparation may be delivered for concentrating via conduit 326 to concentrating chamber 314 (described in further detail below).

Live bacteria separated from the fermentate may also be delivered for further processing. According to one embodiment of the present arrangements, the bacteria are delivered via conduit 324 to killing chamber 322 (described in further detail below) for killing the live bacteria. According to another embodiment of the present arrangements, the bacteria are delivered via conduit 328 to concentrating chamber 314 for concentrating. To this end, killing chamber 322 is configured to facilitate killing of live bacteria, preferably using heat treatment and/or chemical treatment (e.g., treatment with alcohol). Other components that may facilitate killing of bacteria in killing chamber 322 include, but are not limited to, an acid source, an irradiation source, a pressure source, and electricity source, and a UV source.

The fermentate produced in growing chamber 310 may also be delivered to killing chamber 322 for killing the live bacteria therein.

According to one embodiment of the present arrangements, once live bacteria in the fermentate has been killed in killing chamber 322, the resulting product may be delivered via outlet 336 for use as a non-live-bacteria preparation.

According to another embodiment of the present arrangements, however, fermentate that includes killed bacteria may be delivered for further processing. According to one embodiment of the present arrangements, fermentate with killed bacteria is delivered from killing chamber 322 via conduit 330 to concentrating chamber 314 for concentrating. According to another embodiment of the present arrangements, fermentate with killed bacteria is delivered from killing chamber 322 via conduit 332 to separating chamber 318 for separating the killed bacteria from the remainder portion.

Concentrating chamber 314 may include one or more components that facilitate increasing the ratio of solid byproducts to fluid in a non-live-bacteria preparation or a non-live-bacteria preparation precursor. To this end, concentrating chamber 314 may be configured with any one of a centrifuge, various filters, a freeze dryer, an air dryer, a condenser, an evaporator, or a vacuum. Further, concentrating chamber 314 may be configured with one or more components that are capable of detecting the moisture level in a non-live-bacteria concentrate, to ensure that a concentrate with the desired moisture content is generated by the system of the present teachings. In certain embodiments of the present arrangements, concentrating chamber 314 includes components that substantially dry the non-live-bacteria preparations or intermediates it receives.

Once concentrating has been carried out in concentrating chamber 314, the non-live-bacteria concentrate may be delivered for use via outlet 336.

In those embodiments where concentrating chamber receives a fermentate from growing chamber 310 via conduit 312, the concentrated fermentate, which may include live bacteria, may be delivered to separating chamber 318 via conduit 340 for separating the live bacteria from the fermentate, or may be delivered to killing chamber 322 via conduit 345 for killing the live bacteria.

The present teachings recognize that a single chamber may be configured to carry out steps associated with other chambers. By way of example, a single chamber may be a mixing chamber, an inoculating chamber, and/or an incubating chamber. Likewise, a single conduit may be used to deliver more than one non-live-bacteria preparation or non-live-bacteria preparation intermediate. By way of example, a single conduit may deliver either separated bacteria and/or a fermentate substantially depleted of separated bacteria (e.g., in separating chamber 318) to concentrating chamber 314. Further, the present teachings also recognize that instead of a conduit, a non-live-bacteria preparation and/or a non-live-bacteria preparation intermediate may be transferred between chambers and/or for use without the use of a conduit (e.g., by carrying the non-live-bacteria preparation and/or the non-live-bacteria preparation intermediate).

One primary advantage provided by the systems, methods, and compositions disclosed herein is that non-live-bacteria preparations provide a means of promoting food safety and preservation while avoiding certain undesirable byproducts of fermentation, such as lactic acid, which is produced during fermentation of live bacteria on food (e.g., on fermented foods). Byproducts such as lactic acid produce a sour taste and lower the pH of food, which may be unappealing to those who consume such foods. Indeed, the systems, methods, and compositions of the present teachings provide the advantage of protecting foods and beverages from pathogens and spoilage microorganisms without the need for fermentation on and/or in the foods and beverages.

A further advantage is that non-live-bacteria preparations may be produced from relatively simple and abundant components, as they are largely comprised of dead bacteria, extracts from bacteria, and/or fermentation byproducts produced by bacteria. Accordingly, the systems, methods, and compositions of the present teachings provide a relatively straightforward and economical means of promoting safety and preservations foods.

Yet another advantage is that the non-live-bacteria preparations of the present teachings are simple to make and require simple equipment and low-cost ingredients available in abundance. Thus, unlike conventional techniques, which may require steps to isolate, purify, and/or concentrate specific components, entities, and/or factors thought to have anti-pathogen or anti-spoilage activity (e.g., by filtering, adjusting pH, and/or using other techniques), non-live-bacteria preparations avoid the need for these steps and are thus relatively easy and inexpensive to prepare. Further still, because such systems, methods, and compositions use non-live cells and/or their cultures, there are fewer requirements for efficacy (i.e., because conditions that would keep cells alive would not be required).

The anti-pathogen and anti-spoilage effects of the non-live-bacteria preparations of the present teachings, in part, may be attributed to certain substances and/or components and/or combinations thereof that are produced by bacterial cells prior to their deactivation. To the extent that such substances and/or components and/or combinations thereof have been previously identified, the present teachings recognize that using non-live-bacteria preparations, which include such components and/or combinations thereof, provides the advantage of easier and more economical preparation, because steps associated with isolating and/or purifying any such component and/or combination thereof are avoided.

Numerous applications for non-live-bacteria preparations and concentrates exist, including those that deliver meaningful pathogen kill and/or spoilage microorganism kill and preservation benefits. Applications for pet and human food may include, but are not limited to coatings for dry/dried foods to control pathogens and food spoilage organisms; blending non-live-bacteria preparations into liquid formulations of fresh foods or beverages for food safety benefits; and/or pathogen control and spoilage control for raw food material in the supply chain. Specific human edible applications of a non-live-bacteria preparation or concentrate may include, but are not limited to, packaged human food, fresh/raw beverages, packaged beverages, canned vegetables, canned fruits, sauces, soups, condiments, baby foods, liquid enteral diets, milk and dairy products, and yogurt.

Specific animal edible applications of a non-live-bacteria preparation or concentrate may include, but are not limited to a liquid palatant for pet food, a dry palatant for pet food, dried yeast cells, glazes, coatings, dustings, topical product coatings and dustings, kibbles, treats, biscuits, jerky, wet pet food, canned pet food, semi-moist pet food, pet food containing greater than about 20% moisture, pet food in sealed plastic containers, pet food in unsealed containers, pet food in metal containers, and pet food in stand-up resalable pouches.

By way of example, a dried non-live-bacteria preparation may be used to kill pathogens and/or spoilage microorganisms when applied as a component of a dry palatant to kibbled pet food. Likewise, non-live-bacteria preparations may be used to maintain shelf-storage of wet (i.e., greater than about 70% moisture) pet food.

A non-live-bacteria preparation or concentrate may be blended into a food, pet food, or beverage product and/or may be applied to the surface of a food or pet food. In one preferred embodiment of the present teachings, a non-live-bacteria preparation is added to the ingredients of a pet food that is at least one member selected from a group comprising extruded, co-extruded, expanded, retorted, baked, injection molded, chubbs, chub, refrigerated, frozen, and pet food treat. In another preferred embodiment of the present teachings, a non-live-bacteria preparation is topically applied to the pet food after the pet food has been formed, where the pet food that is at least one member selected from a group comprising extruded, co-extruded, expanded, retorted, baked, injection-molded, chubbs, chub, refrigerated, frozen, and a pet food treat. In yet another preferred embodiment of the present teachings, the non-live-bacteria preparation is added to a protein source or meat that is dried to produce a rendered meal.

According to one embodiment of the present teachings, a non-live-bacteria preparation is used in dental health application to inhibit activity of Streptococcus mutans, which is known to cause dental carries. The present teachings recognize that a non-live-bacteria preparation or non-live-bacteria concentrate can limit the ability of S. mutans to grow on dental or oral surfaces. Further applications include, but are not limited to, treating receding gum disease, decreasing plaque formation, decreasing gum infections due to insults on the gums, and improved healing during tooth removal or surgery.

In another embodiment of the present teachings, a non-live-bacteria preparation is used in beverages, including raw beverages (e.g., fruit and vegetable drinks). The systems, compositions, and processes disclosed herein provide a means of leveraging the killing power of beneficial bacteria without the need to stabilize the bacteria in a liquid environment to keep the bacteria alive.

In another embodiment of the present teachings, use of a non-live-bacteria preparation provides a relatively low-cost and efficient means of preserving beverages, particularly raw beverages, without producing the sour taste often associated with fermented beverages.

Further still, the use of natural ingredients produced by bacteria is healthier and more appealing to the consumer, particularly when observing ingredient lists for such beverages (or other foods). Further, when applied to certain carbonated beverages, the non-live-bacteria preparations of the present teachings may be used to avoid the use of phosphoric acid (as well as other chemical preservatives), which is a chemical preservative known to produce certain deleterious effect on human health.

In yet another embodiment of the present teachings, a non-live-bacteria preparation is included in topical applications (both food and non-food) to limit the growth of pathogens and/or spoilage microorganisms. Specific applications include, but are not limited to, bandages impregnated with a non-live-bacteria concentrate; non-live-bacteria concentrates that control odor in deodorants, sunscreen, acne treatments, and wrinkle treatments; or preventing and/or treating various skin diseases and conditions (e.g., psoriasis). Yet another application includes a nose spray to treat the sequelle (i.e., a secondary infection like Shingles or Scarlett Fever), Staphylococcus aureus sinus infection from a viral rhinitis, the common cold, and other illnesses. In particular, topical applications with low water activity/moisture level may be useful. Examples of topical application include, but are not limited to, emollient, sheaf butter, lanolin, cocoa butter, butter crèmes, paw, and cosmetics. In another embodiment of the present teachings, a concentrate is used to treat throat infections (e.g., Streptococco pyogenes). In another embodiment of the present teachings, a concentrate is used to treat psoriasis.

According to yet another embodiment of the present teachings, a non-live-bacteria preparation is delivered, via a liquid (e.g., as a spray) to the surface of at least one member selected from a group comprising fruit, vegetable, meat, seafood, and pet food.

Applying a non-live-bacteria preparation to the surface of a food does not require that the food be cooked or cooked to completion. Accordingly, a non-live-bacteria preparation may be applied to a food while it is in its native state (e.g., a fruit or vegetable prior to harvesting), after a food is harvested, during manufacturing of a food product, or during or after packaging. In such embodiments, a non-live-bacteria concentrate provides several advantages, including extended shelf-life in the supply chain (therefore reducing waste), improved taste/palatability, and simpler and more natural ingredient list for consumer appeal, which is consistent with current consumer trends.

In yet another embodiment of the present teachings, a non-live-bacteria preparation is used to treat raw meats and fish in slaughterhouses and abattoirs. According to such embodiments, raw meat or fish is coated with and/or blended into a mixture that includes a non-live-bacteria preparation, facilitating death and/or growth inhibition of pathogens and/or spoilage microorganisms on raw meat or fish. This provides the further advantage of creating a more sterile environment for further processing and for employees who handle the raw meat or fish. Further, this results in an extended shelf life and less color loss than may otherwise occur due to meat or fish being in a raw state.

In yet another embodiment of the present teachings, a non-live-bacteria preparation is sprayed onto the surface of agricultural products, including eggs, to reduce the risk of Salmonella and pathogen transfer to humans. This embodiment provides the benefit of an extended shelf life, safe products, a reduction of waste, and higher agricultural yields.

In yet another embodiment of the present teachings, a non-live-bacteria preparation is sprayed and/or mixed into animal feed. According to this embodiment, this provides the advantage of reducing the pathogenic bacterial load on poultry, pork, fish farms, or cattle yards, which in turn reduces the pathogenic load of bacteria in the final meats.

In yet another embodiment of the present teachings, a non-live-bacteria preparation is sprayed onto and/or mixed in food in a food-service area, a food-display area, or a salad bar, to prevent pathogen and/or spoilage-microorganism activity and to ensure food safety.

In yet another embodiment of the present teachings, a non-live-bacteria preparation is mixed into and/or used as a surface coating for at least one member selected from a group comprising bread, snack, cereal, semi-moist pet food, soft moist pet food, wet pet food, dry pet food, and pet treats. This embodiment provides several advantages, including prevention of pathogen ingestion, food preservation, food safety assurance, enhanced palatability of food, and a simpler and more natural ingredient list.

In yet another embodiment of the present teachings, a non-live-bacteria preparation is added to at least one member selected from a group comprising confection, candy, raw jam or jelly, cooked jam or jelly, preserve, spread, dip, and peanut butter.

In yet another embodiment of the present teachings, a non-live-bacteria preparation is placed in a sweet-and-sour supplement that is in a shelf-stable form for refrigeration. Such a supplement may be spooned into meals and desserts in a variety of forms. This embodiment provides the advantages of enhanced taste/palatability, a simpler and more natural and healthy ingredient list for consumer appeal, and extended shelf life of products.

In yet another embodiment of the present teachings, a non-live-bacteria preparation is added daily to foods, meals, supplements, and pharmaceuticals. The present teachings recognize that a non-live-bacteria preparation may be added using a sweet or savory application that may be a liquid, a gel, a powder, any of which is applied directly into a food, a gellified product that can be spread onto a food, or a food that is consumed directly (e.g., a chocolate-flavored non-live-bacteria preparation that is added to water or another beverage).

In yet another embodiment of the present teachings, a non-live-bacteria preparation is applied to a pet product to reduce pathogenic activity in a home environment. By way of example, a pet product may include, without limitation, a pet pad, a pet deodorizer, or a pet litter.

Specific methods of using a non-live-bacteria preparation or non-live-bacteria concentrate to promote safety and preservation of a variety of food products are disclosed herein. To this end, set forth below are non-limiting examples of such methods of using non-live-bacteria preparations and concentrates that are prepared according to the present teachings (e.g., as described below in Examples 3 and 4).

According to one embodiment of the present teachings, a non-live-bacteria concentrate is injected into whole meats and seafoods for human consumption. By way of example, the injection process involves using a needle to sufficiently place the injected solution at least about 5 mm below the surface of the meat. The choices of meats to be injected include, but are not limited to, roasts, whole chickens, hams, turkeys, and meatloafs. Injection of a non-live-bacteria concentrate produces whole meat products that are protected against pathogen and/or spoilage microorganism growth and/or survival, have an extended shelf-life, reduce the need for preservatives, and have improved taste and palatability.

According to another embodiment of the present teachings, chicken meat mixed with squash is inoculated with a non-live-bacteria concentrate for product-stabilization purposes. By way of example, chicken meat, vegetables, and other minor ingredients are mixed, cooked, and then inoculated with a non-live-bacteria concentrate. A stainless-steel kettle fitted with a thermal heating jacket is capable of holding up to about 100 kg of ingredients may be used as the basin in which the mixing and incubation of the mixture of meat, vegetables, and minor ingredients, is carried out. The thermal heating jacket is capable of heating up to about 121° C. and maintaining this temperature in ambient environments as low as about −29° C. Within the kettle is a vertically mixing shaft fitted with an auger for mixing. The vertical shaft is capable of rotating on the vertical axis at the rate of up to about 30 rpm. The kettle is further designed to be closed to prevent outside air from continuously contaminating the kettle's contents. The kettle maintains a one-way gas release valve to prevent internal contents from becoming pressurized, and further, has a thermo-coupled probe to monitor temperature, as well as a probe designed to monitor the pH of the solution contained within the kettle. Contents of the kettle may be added through a port opening on top of the kettle, while contents of the kettle may be removed through a port at the bottom of the kettle. About 47.8 kg of chicken meat, about 45 kg of squash, about 3 kg of beet pulp, about 1 kg of trace minerals and vitamins, about 1 kg of fish meal, about 1 kg of dicalcium phosphate, about 0.6 kg of potassium chloride, and about 0.6 kg of salt, are added into the kettle and heated to about 93° C. Upon reaching about 93° C., the mixture is cooled to about 52° C. and a non-live-bacteria concentrate is added into the mixture. The mixture containing the non-live-bacteria concentrate is then added to individual containers that are then sealed. The individual containers containing the mixture are shelf-stable for up to about 24 months.

According to another embodiment of the present teachings, a non-live-bacteria concentrate is sprayed onto an animal carcass. By way of example, one or more chicken carcasses are sprayed with a non-live-bacteria concentrate, and subsequently, meat pieces obtained through trimming the carcasses are stabilized with the concentrate. The non-live-bacteria concentrate is sprayed onto chicken carcasses after the skin has been removed and during the slaughtering process. The non-live-bacteria concentrate is sprayed periodically through the slaughtering process. The surfaces of sprayed carcass components, such as necks, backs, and racks, contain non-live-bacteria concentrate such that when parts of the chicken are placed in containers for further emulsification and grinding of the meat into piece sizes smaller than about 8 mm, the meat becomes inoculated throughout. The meat is capable of having a shelf-life up to about 3 months at storage conditions of less than about 29° C.

According to yet another embodiment of the present teachings, a non-live-bacteria concentrate is added into and/or onto bacon bits, ground meat, sushi, or other meat or seafood products. The non-live-bacteria concentrate improves stability of the food and lessens the chance of food-borne pathogen and/or spoilage microorganism growth and survival.

According to yet another embodiment of the present teachings, a non-live-bacteria concentrate is mixed into a raw meat marinade to enable stability and lessen the chance of food-burned pathogens and spoilage microorganisms. The marinade sauce may be used to flavor raw and slightly cooked meats. Because of the use of meat mallets on the meat and the continuous bathing of the meat in the marinade, the concentrate penetrates the meat and is active internally within the meat. The marinade has the unusual property of enabling the meat to be shelf-stable in ambient storage environments and is resistant to food-borne pathogens and/or spoilage microorganisms, because it contains the non-live-bacteria concentrate.

According to yet another embodiment of the present teachings, a non-live-bacteria concentrate is added into tuna fish salad or crab cakes to enable stability and lessen the growth of food-borne pathogens and spoilage microorganisms. Mechanical mixing of the meat and other ingredients may be used, and during the continuous bathing of the meat and other ingredients, the non-live-bacteria concentrate permeates the tuna fish and other ingredients and is active internally within the tuna fish salad or crab cakes. The tuna fish salad or crab cakes have the unusual property of being shelf-stable in ambient storage environments and is resistant to food-borne pathogens and/or spoilage microorganisms, because it contains the concentrate.

According to yet another embodiment of the present teachings, a non-live-bacteria concentrate is marinated with uncooked meat sticks, uncooked meat strips, or uncooked roast beef to enable stability and lessen the growth of food-borne pathogens and spoilage microorganisms. By way of example, the marinated meat sticks, meat strips, or roast beef are incubated at about 41° C. for about 8 hours. Because of the continuous marinating of the meat sticks, meat strips, or roast beef, the non-live-bacteria concentrate permeates the meat and is active internally within the meat sticks. The meat sticks, meat strips, or roast beef have the unusual property of being shelf-stable in ambient storage environments and are resistant to food-borne pathogens, as the meat sticks, meat strips, or roast beef contain the non-live-bacteria concentrate.

In another aspect, the systems, compositions, and processes of the present teachings may be used to promote safety and preservation of a packaged wet food (i.e., food containing greater than about 70% moisture). Given the previously expressed needs for improved methods of combatting spoilage and pathogenic microorganisms and achieving long-term food storage stability, the present teachings disclose a food processing method that requires incubating a food with live anti-pathogen and/or anti-spoilage bacteria prior to packaging in a manner that provides food safety and food preservation benefits without certain undesirable effects of fermentation, including accumulation of gas in the headspace of sealed food containers produced by the live bacteria, which results in puffy packaging that is unacceptable from a cosmetic or consumer point of view because it gives the appearance of food in the packaging being spoiled.

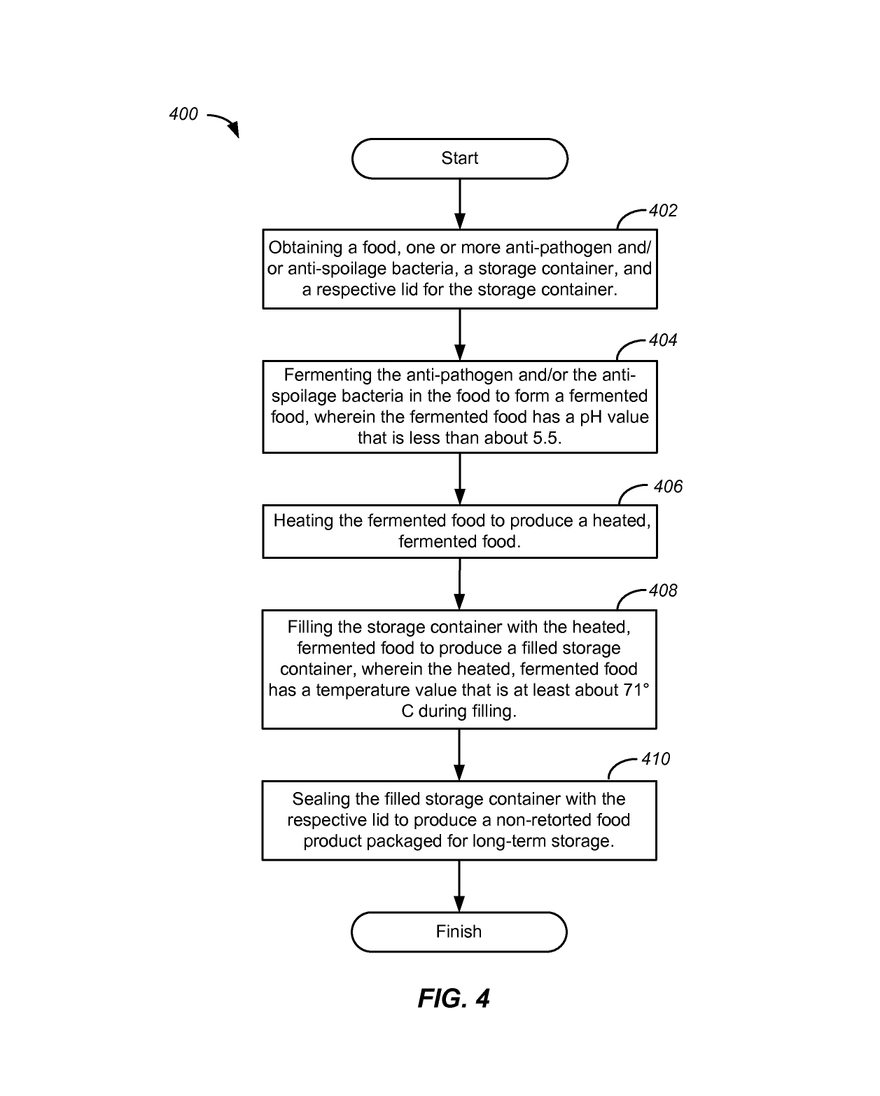

To avoid this problem, certain embodiments of the present teachings employ the use of moderate heating to food prior to storage (i.e., treating at about 82° C. for a relatively brief period of time) to assure the product will be packaged with a flexible film that looks sealed, not bloated (as explained in further detail below with reference to FIG. 4). Absent such moderate heating, which is thought to kill fermenting bacteria prior to packaging, a product contained within a flexible film package will become puffy and undesirable to the consumer due to the activity of live bacteria while the food is in storage. Further, moderate heating may provide the additional advantage of killing residual yeast and/or mold that is associated with raw food ingredients. This method also enables the food product to resist growth by bacteria found either in the product or package and thus encourages product stability over long periods of time (i.e., up to months or years).

To this end, FIG. 4 is a flow chart for a process 400, according to one embodiment of the present teaching and for producing a non-retorted food product for long-term storage. Process 400 begins with a step 402, which includes obtaining a food, one or more anti-pathogen and/or anti-spoilage bacteria, a storage container, and a respective lid for the storage container. Preferably, the food contains at least about 2% carbohydrate, which facilitates fermentation of bacteria used in subsequent steps. Anti-pathogen and/or anti-spoilage bacteria is substantially similar to its counterparts described above with reference to FIGS. 1 and 2 and with reference to activated and preserved food composition.

Next, a step 404 includes fermenting the anti-pathogen and/or the anti-spoilage bacteria in the food to form a fermented food, wherein the fermented food has a pH value that is less than about 5.5. According to one embodiment of the present teachings, the fermented food has a pH value that is less than about 5.5. In another embodiment of the present teachings, the fermented food has a pH value that is less than about 4.7. Fermenting may be carried out at a temperature value that is between about 38° C. and about 60° C., and preferably, between about 49° C. and about 54° C. Further, fermenting may be carried out for a duration that is between about 8 hours and about 20 hours. The present teachings recognize that fermentation of the anti-pathogen and/or anti-spoilage bacteria produces fermentation byproducts and other residual products that promote safety and preservation of food by killing and/or inhibiting growth of pathogenic and/or spoilage bacteria.

In certain embodiments of the present teaching, prior to step 404, the food is mixed with the anti-pathogen and/or anti-spoilage bacteria. Mixing may be carried out at a temperature value that is between about 0° C. and about 49° C. In one embodiment of the present teachings, a further step of adding, to the food mixture, at least one member selected from a group comprising vitamin, mineral, and oil, is carried out.

Next, a step 406 includes heating the fermented food to produce a heated, fermented food.

Next, a step 408 includes filling the storage container with the heated, fermented food to produce a filled storage container, wherein the heated, fermented food has a temperature value that is at least about 93° C., and preferably, at least about 71° C., during filling. According to an alternate embodiment of the present teachings, however, the temperature range for this “hot-filling” step is determined by the difference between manufacturing plant temperature and filling temperature, with the preferable filling temperature range being between about 15° C. and about 50° C. higher than room temperature.

Next, a step 410 includes sealing the filled storage container with the respective lid to produce a non-retorted food product packaged for long-term storage. Step 410 may be carried out by any technique well known to those of skill in the art, including sealing or tightly placing a lid on a storage container. Once step 410 is complete, the non-retorted food product packaged for long-term storage is prevented from producing a puffy lid during long-term storage. The present teachings recognize that the sealed enclosure will not become puffy, even when stored for relatively long periods of time. This produces packaged food products that are more appealing to consumers, thus facilitating sale and usage of such a food products.

The present teachings recognize that such a process enables de-gassing (i.e., during “hot-filling” in step 408) the packaged food product without the need to process the product at extreme temperatures (thus overcoming the soufflé effect that causes puffy lids). Such results are surprising, because it is counter-intuitive to fill the packages above a temperature of about 54° C., because conventional techniques avoid killing live bacteria, as those conventional techniques operate under the theory that bacteria must continue to ferment (i.e., bacteria must not be killed) to promote food safety and preservation power from a “living prophylactic” point of view.

In contrast, use of temperatures above about 93° C. in step 408 begins to boil the water in the product and cook the food, changing the organoleptic properties of the food product. Further, using such high temperatures requires more heat and time to achieve, thus resulting in more costly and less efficient food-storage methods. Thus, the present teachings provide the advantage of avoiding such undesirable effects.

The use of bacterial cultures at the relatively lower temperatures disclosed herein (i.e., under 93° C.). has surprisingly been found to be effective in providing long-term food product storage. Specifically, while such temperatures are thought to be ineffective in killing spore-forming bacteria such as Clostridium botulinum, the present teachings recognize that the food product treated according to process 400 is shelf-stable in spite of the anti-pathogen and/or anti-spoilage bacteria being killed due to the heating process. The present teachings recognize that the effects of a live bacterial culture are present post-heating, even though the inoculated bacteria are dead. Thus, the product remains stable, and pathogens such as C. botulinum are not a health risk to the consumer of the product, in part because the pH of the stored food is below about 4.7, and in certain embodiments of the present teachings, below about 5.5.

According to one embodiment of the present teachings, the present “hot-filling” technique produces a stored food product that is substantially pathogen-free, substantially spoilage-bacteria-free, and shelf-stable for greater than six months. Non-limiting examples of such stored food products treated according to the processes of the present teachings include wet pet food, canned pet food, semi-moist pet food, pet food containing greater than 20% moisture, pet food in sealed plastic containers, pet food in unsealed containers, pet food in metal containers, pet food in stand-up resealable pouches, canned human food, canned ready-to-eat foods, canned vegetables, canned fruits, sauces, soups, condiments, baby foods, liquid enteral diets, milk and dairy products, and yogurt.

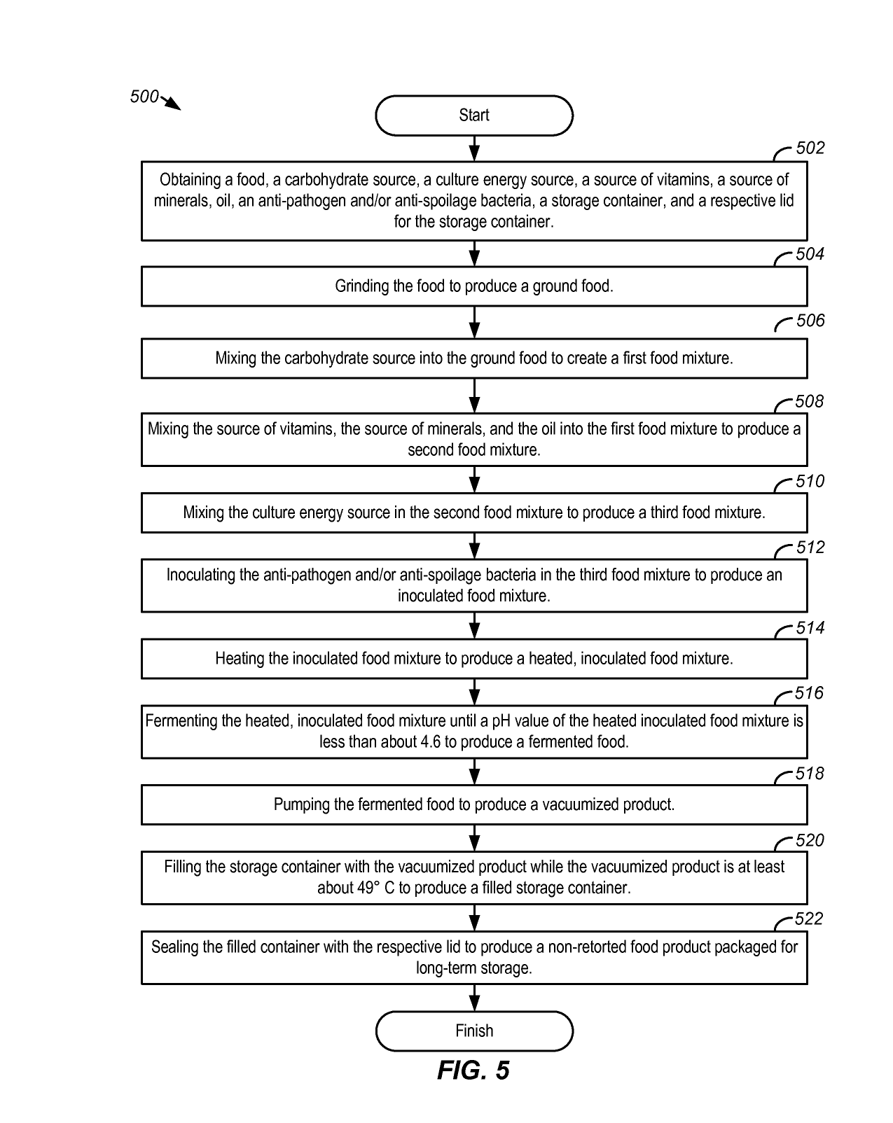

In another aspect, the present teachings provide another filling method that addresses the problem of the soufflé effect and puffy lidding associated with conventional long-term storage of food in containers. Specifically, the present teachings recognize that a vacuum may be applied either during the filling of the finished product or to a food during its fermentation to prevent the development of solubilized gases in the food, thus reducing or eliminating the cause of the soufflé effect and puffy lidding associated with conventional techniques. To this end, FIG. 5 is a flowchart for a process 500, according to another embodiment of the present teachings and for producing a non-retorted food product for long-term storage. Process 500 begins with a step 502, which includes obtaining a food, a carbohydrate source, a culture energy source, a source of vitamins, a source of minerals, oil, an anti-pathogen and/or anti-spoilage bacteria, a storage container, and a respective lid for the storage container. In certain embodiments of the present teachings, step 502 also includes obtaining a water solution or hydrating solution sufficient to rehydrate relatively dried bacteria. A food and an anti-pathogen and/or anti-spoilage bacteria are substantially similar to their counterparts described above.

A carbohydrate source, a culture energy source, a source of vitamins, a source of minerals, and an oil may be any such component and/or ingredient well-known to those of skill in the art for growing and/or fermenting bacteria. A carbohydrate source may be thought of as source of carbohydrate in food that is available to the consumer who eats the food after it has been packaged. Examples of a carbohydrate source may include sweet potato, squash, corn, rice, wheat, oats, barley, amaranth, teff, millet, sorghum, milo, maize, farro, chia, quinoa, semolina, and spelt.

A culture energy source may be thought of as providing a source of energy for fermenting bacteria to grow. Preferably, a culture energy source is at least one member selected from a group comprising apple juice, apple juice concentrate, dextrose, dextrose monohydrate, dextrose hydride, grape sugar, D-glucose, corn sugar, sucrose, lactose, maltose, corn syrup solids, high fructose corn syrup, levulose, glucose, galactose, xylose, ribose, mannose, sorbose, amino acids, high fructose corn syrup, apple pulp, honey, sugar, maple syrup, pear juice, grape juice, orange juice, pear juice concentrate, grape juice concentrate, orange concentrate, and fruit juice.

Next, a step 504 includes grinding the food to produce a ground food product. According to one embodiment of the present teachings, a food is ground prior to obtaining in step 502.

Next, a step 506 includes mixing the carbohydrate source into the ground food to create a first food mixture. Mixing is carried out by any technique well known to those of skill in the art and to a degree sufficient to distribute the carbohydrate source relatively evenly in the first food mixture.

Next, a step 508 includes mixing the source of vitamins, the source of minerals, and the oil into the first food mixture to produce a second food mixture. As with step 506, mixing is carried out to a degree sufficient to distribute the source of vitamins, the source of minerals, and the oil source relatively evenly in the second food mixture. In certain embodiments of the present teachings, however, vitamins, the source of minerals, and/or oil are not used.

Next, a step 510 includes mixing the culture energy source in the second food mixture to produce a third food mixture. The present teachings recognize, however, that step 510 is optional, as other components obtained in step 502 (e.g., a carbohydrate source) may provide energy for the growing bacterial culture.

According to one embodiment of the present teachings, an optional step of hydrating the anti-pathogen and/or anti-spoilage bacteria in the water solution to produce a pre-hydrated bacterial solution is carried out. In other embodiments of the present teachings, however, this hydrating is optional, and non-hydrated bacteria may be used in subsequent steps.

Next, a step 512 includes inoculating the anti-pathogen and/or anti-spoilage bacteria into the third food mixture to produce an inoculated food mixture. In those embodiments that utilize a hydrating step, however, a pre-hydrated bacterial solution is inoculated into the third food mixture to produce an inoculated food mixture.

Next, a step 514 includes heating the inoculated food mixture to produce a heated, inoculated food mixture. Heating is carried out at conditions (e.g., time and temperature) well known to those of skill in the art.

Next, a step 516 includes fermenting the heated, inoculated food mixture until a pH value of the heated, inoculated food mixture is less than about 4.6 to produce a fermented food composition. Step 516 is carried out at conditions well known to those of skill in the art for the anti-pathogen and/or anti-spoilage bacteria to produce lactic acid in an amount sufficient to produce a pH of less than about 4.6.

Next, a step 518 includes pumping the fermented food composition to produce a vacuumized product. Pumping may be carried out by any technique well known to those of skill in the art (e.g., vacuum pumping).

Next, a step 520 includes filling the storage container with the vacuumized product while the vacuumized product is at least about 49° C. to produce a filled storage container.

Next, a step 522 includes sealing the filled container with the respective lid to produce the non-retorted food product packaged for long-term storage. Once step 522 is complete, the non-retorted food product packaged for long-term storage is prevented from producing a puffy lid during long-term storage.

This method of producing a non-retorted food product for long-term storage in a container that does not produce a puffy lid or package provides the benefit of not having to hot fill (i.e., as explained with reference to step 408 of process 400). A further benefit of this method is that by avoiding hot filling, the integrity of the anti-pathogen and/or anti-spoilage bacteria may be maintained, thus enabling possible probiotic benefits to the consumer of the food product. In one embodiment of the present teachings, the food is filled at a temperature of about 49° C. (but preferably no greater than 54° C.) through a variety of means, into a sealable package, including at least one member selected from a group comprising vacuum pumping, a vacuum hopper, a vacuum filler, or a vacuum stuffer.

### EXAMPLES

Unless otherwise indicated in the following examples, all expressions of percentages and ratios are by weight of total solution or product. Further, unless otherwise indicated in the following examples, all expressions of percentage solutions of an alcohol are by volume of total solution. Further, unless otherwise indicated in the following examples, inoculation and/or presence of bacteria in a fluid (e.g., a growth medium) or on a substance (e.g., a food) are expressed in units of colony forming units (“cfu”) of the bacteria per gram of the solution or the substance.

### Example 1

### Development of Fermentate

Example 1 shows development of a fermentate containing Pediococci.

A chicken broth mixture containing about 2% dextrose and about 0.1% Tween 80 was pasteurized to about 88° C. to create a pasteurized broth mixture. When the pasteurized broth mixture had cooled to about 71° C., amino acids were added to create an amino-acid-enriched broth mixture containing about 0.1% threonine, about 0.05% serine, about 0.05% proline, and about 0.1% cysteine. The amino-acid-enriched broth mixture was further cooled to about 52° C. and then swirled to create a homogenous broth suspension. To enable the inoculum source (Pediococci bacterial cells) to rejuvenate before inoculation into the homogenous broth suspension, about 0.5 grams of freeze-dried Pediococcus acidilactici and Pediococcus pentosaceus were added to about 10 mL of distilled water and allowed to stand for about 30 minutes. The homogenous broth suspension was then inoculated with the rejuvenated Pediococcus acidilactici and Pediococcus pentosaceus at the level of about 1×10⁷ cfu/gram. The inoculated chicken broth was placed in a sealed container and then placed in an environment of about 35° C. for about 48 hours to allow it to ferment. After about 48 hours, the fermentate was removed from the 35° C. environment and stored at ambient temperature until further use.

### Example 2

### Development of a Live-Bacteria Concentrate

Example 2 shows development of a live-bacteria concentrate containing live Pediococci.

The bacterial cells were removed from the fermentate described in Example 1 by centrifuging about 400 mL of fermentate at about 2,600 g for about 15 minutes. The supernatant was discarded and the recovered bacterial cells were resuspended in about 50 mL of Butterfield's Phosphate Buffered Diluent (“BPBD”) at about 1×10¹⁰ cfu/gram to create a live-bacteria concentrate. The resuspended bacterial cells were stored at about 4° C.

### Example 3

### Development of a Non-Live-Bacteria Concentrate Having Dead Bacteria

Example 3 shows development of a non-live-bacteria concentrate having dead Pediococci.

About 200 mL of ethanol (75.5%) were added into about 400 mL of the fermentate (as described in Example 1) to create an ethanol-enriched fermentate. The ethanol-enriched fermentate was then incubated at about 49° C. to evaporate ethanol and water off until an approximately 10× non-live-bacteria concentrate (i.e., about 400 mL fermentate concentrated to about 40 mL) was formed. This created a non-live-bacteria concentrate having bacteria that are substantially killed.

### Example 4

### Development of a Non-Live-Bacteria Concentrate Substantially Depleted of Bacteria

Example 4 shows development of a non-live-bacteria concentrate substantially depleted of bacteria.

A portion of the non-live-bacteria concentrate having dead bacteria of Example 3 was centrifuged at about 2,600 g for about 15 minutes. The supernatant was decanted off and the precipitate (i.e., a solid mass containing the bacterial cells) was discarded. The supernatant was used as the non-live-bacteria concentrate substantially depleted of bacteria.

### Example 5

### Anti-Pathogen Activity of a Live-Bacteria Concentrate, a Non-Live-Bacteria Concentrate Having Dead Bacteria, and a Non-Live-Bacteria Concentrate Substantially Depleted of Bacteria

The comparison of a live-bacteria concentrate, a non-live-bacteria concentrate having dead bacteria, and a non-live-bacteria concentrate substantially depleted of bacteria, is shown by Example 5.

A microtiter well experiment was conducted to evaluate the efficacy of various concentrations of a live-bacteria concentrate, a non-live-bacteria concentrate having dead bacteria, and a non-live-bacteria concentrate substantially depleted of bacteria, each added into chicken broth with pathogens. About 100 μL chicken broth were added into wells 2 through 12. The inoculum sources were added at about 100 μL to wells 1 and 2 and consisted of either a source of live-bacteria concentrate as described in Example 2, a source of non-live-bacteria concentrate having dead bacteria as described in Example 3, or a source of non-live-bacteria concentrate substantially depleted of bacteria as described in Example 4. Finally, into all microtiter wells, about 50 μL of a solution containing E. coli (strains ATCC BAA 1427, 1428, 1429, 1430, and 1431) were added such that an approximately 1×10⁵ cfu/gram concentration of E. coli was obtained. The microtiter wells contained the following dilutions of inoculum, by volume: 1:1, 1:2, 1:4, 1:8, 1:16, 1:32, 1:64, 1:128, 1:256, 1:512, and 1:1024.

As demonstrated in Table 1, results generally indicate that addition of a live-bacteria concentrate resulted in inhibition of E. coli cell growth but does not kill the bacteria. (Note: the “growth” result that occurred with a 1:1 dilution of the live-cell concentrate was likely due to the presence of nutrients carried over from the recovered cells.) In contrast, all dilutions of the non-live-bacteria concentrates having dead bacteria and non-live-bacteria concentrates substantially depleted of bacteria resulted in no E. coli growth. This finding demonstrates the pathogen killing superiority of the cultures that underwent kill or removal of the Pediococci cultures. Further, because the cultures that underwent kill of the Pediococci cultures were comparable with respect to pathogen kill to the cultures from which cells were removed, it is reasonable to infer that substances responsible for the pathogen kill were not components of the cells.

TABLE 1
Microtiter Well Results Comparing Effects on Pathogen Growth by
Treatment with Pediococci Live-Bacteria Concentrates, Non-Live-
Bacteria Concentrates Having Dead Bacteria, and Non-Live-Bacteria
Concentrates Substantially Depleted of Bacteria

| | | Non-Live-Bacteria | Non-Live-Bacteria |
|---|---|---|---|
| | | Concentrate | Concentrate |
| | Live-Bacteria | Having Dead | Substantially |
| Dilution | Concentrate | Bacteria | Depleted of Bacteria |
| 1:1 | + | − | − |
| 1:2 | −1 | − | − |
| 1:4 | −1 | − | − |
| 1:8 | −1 | − | − |
| 1:16 | −1 | − | − |
| 1:32 | −1 | − | − |
| 1:68 | −1 | − | − |
| 1:128 | −1 | − | − |
| 1:256 | −1 | − | − |
| 1:512 | −1 | − | − |
| 1:1024 | −1 | − | − |
| No | + | + | + |
| Concentrate | | | |

+ = Growth
−1 = Inhibition
− = No Growth

Examples 6 and 7 relate to comparing the pathogen killing power of a non-live-bacteria concentrates having dead bacteria obtained from three different alcohol sources.

### Example 6

### Development of a Non-Live-Bacteria Concentrate Using Alcohol

Development of non-live-bacteria concentrates having dead bacteria by treatment with ethanol, isopropyl alcohol, or methanol, that results in dead Pediococci, is shown by Example 6.

The cells from about 1 L of fermentate obtained in Example 1 were obtained by centrifuging the fermentate at about 2,600 g for about 15 minutes and then discarding the supernatant. The collected precipitate (i.e., the solid portion remaining after discarding the supernatant) was rehydrated with about 50 mL of BPBD at about 1×10¹⁰ cfu/gram to create a live-bacteria concentrate.

Three different alcohol sources were used to obtain three different alcohol-killed fermentation cultures: ethanol (100%), isopropyl alcohol (90%), and methanol (100%). About 10 mL of each alcohol source were added into about 10 mL of fermentate (as described in Example 1) to create alcohol-killed fermentates. Each alcohol-killed fermentate was then incubated at about 37° C. for about 48 hours to evaporate ethanol and water until an approximately 12× concentrate was formed. This resulted in an ethanol non-live-bacteria concentrate having dead bacteria, an isopropyl alcohol non-live-bacteria concentrate having dead bacteria, and a methanol non-live-bacteria concentrate having dead bacteria.

### Example 7

### Anti-Pathogen Activity of Non-Live-Bacteria Concentrates Treated with Various Alcohols

Example 7 shows the comparison of non-live-bacteria concentrates obtained by treatment with ethanol, isopropyl alcohol, and methanol.

A microtiter well experiment was conducted to evaluate the efficacy of non-live-bacteria concentrates created using one of three various alcohols: ethanol, isopropyl alcohol, and methanol (i.e., samples obtained from Example 7), when added into M9 broth (which was created using Cold Spring Harbor's Protocols for M9 broth recipe accessed on Nov. 15, 2014, from: http://cshprotocols.cshlp.org/content/2006/1/pdb.rec8146.full?text only=true) and a pathogen source. About 50 μL M9 broth were added into wells 2 through 12. About 50 μL of the inoculum source were added at into wells 1 and 2 and consisted of one of three sources of non-live-bacteria concentrates (as described in Example 6): an ethanol non-live-bacteria concentrate having dead bacteria, an isopropyl non-live-bacteria concentrate having dead bacteria, and a methanol non-live-bacteria concentrate having dead bacteria. Finally, into all microtiter wells, about 50 μL of a solution containing E. coli (strains ATCC BAA 1427, 1428, 1429, 1430 and 1431) were added such that an approximately 1×10⁵ cfu/gram concentration of E. coli was obtained. The microtiter wells contained the following dilutions of inoculum, by volume: 1:1, 1:2, 1:4, 1:8, 1:16, 1:32, 1:64, 1:128, 1:256, 1:512, 1:1024, and 1:2048.

As demonstrated in Table 2, results generally indicate that concentrates from alcohol result in inhibition of E. coli cell growth at the highest concentration. Importantly, the methanol concentrate resulted in the greatest ability to kill E. coli, followed by the ethanol concentrate, with the isopropyl concentrate showing the weakest ability to kill E. coli.

TABLE 2
Microtiter Well Results Comparing the Effects on Pathogen Growth of
Pediococci Ethanol Non-Live-Bacteria Concentrates, Isopropyl Alcohol
Non-Live-Bacteria Concentrates, and Methanol Non-Live-Bacteria
Concentrates, Each Having Dead Bacteria

| | | Isopropyl | Methanol |
|---|---|---|---|
| | | Alcohol Non- | Non-Live- |
| | | Live-Bacteria | Bacteria |
| | Ethanol Non-Live- | Concentrate | Concentrate |
| | Bacteria Concentrate | Having | Having |
| Dilution | Having Dead Bacteria | Dead Bacteria | Dead Bacteria |
| 1:1 | − | − | − |
| 1:2 | − | −1 | − |
| 1:4 | + | + | − |
| 1:8 | + | + | −1 |
| 1:16 | + | + | + |
| 1:32 | + | + | + |
| 1:64 | + | + | + |
| 1:128 | + | + | + |
| 1:256 | + | + | + |
| 1:512 | + | + | + |
| 1:1024 | + | + | + |
| 1:2048 | + | + | + |
| No | + | + | + |
| Concentrate | | | |

+ = Growth
−1 = Inhibition
− = No Growth

Examples 8 and 9 relate to comparing anti-pathogen activity of a non-live-bacteria concentrate having dead bacteria to lactic acid.

### Example 8

### Non-Live-Bacteria Concentrates Having Dead Bacteria

A fermentate was obtained by the procedures described in Example 1. The cells of the fermentate were killed by adding about 240 mL ethanol (75.5%) to about 600 mL of fermentate to create a fermentate/ethanol mixture that is a non-live-bacteria preparation having dead bacteria. The fermentate/ethanol mixture was evaporated at about 45° C. until a final mixture amount of about 50 mL remained, which created a non-live-bacteria concentrate having dead bacteria.

### Example 9

### Anti-Pathogen Activity of Non-Live-Bacteria Concentrate Having Dead Bacteria Compared with Anti-Pathogen Activity of Lactic Acid

The comparison of the impact of a non-live-bacteria concentrate having dead bacteria, a blend of non-live-bacteria concentrate having dead bacteria and lactic acid, and lactic acid alone, on growth of pathogens, is shown by Example 9.

A microtiter experiment was conducted to evaluate the pathogen killing effect of the following pathogen killing agents: (1) about 100 μL of non-live-bacteria concentrate having dead bacteria alone (obtained from Example 8), (2) a blend of about 50 μL of non-live-bacteria concentrate having dead bacteria (obtained from Example 8), and about 50 μL of approximately 0.1 M lactic acid, or (3) about 100 μL of approximately 0.1 M lactic acid alone when added into Swanson® chicken broth and a source of pathogens.

About 100 μL chicken broth was added into microtiter wells 1 through 12. The pathogen killing agents were added at about 100 μL into wells 1 and 2. About 100 μL from the mixture of pathogen killing agent and chicken broth were then added to well 3 and then repeated thereafter to create the following dilutions, by volume, until well 11: 1:1, 1:2, 1:4, 1:8, 1:16, 1:32, 1:64, 1:128, 1:256, 1:512, and 1:1024. Next, into all microtiter wells, about 50 μL of a solution containing E. coli (strains ATCC BAA 1427, 1428, 1429, 1430 and 1431) were added such that an approximately 1×10⁵ cfu/gram concentration of E. coli in each well was obtained. Well 12 served as the positive control by having no pathogen killing agent added. Microtiter plates containing the wells described above were then placed into an incubator at about 35° C. for either about 24 or about 48 hours. After the appropriate incubation time, microtiter plates were removed from the incubator and the color indicator (about 50 μL iodonitrotetrazolium salt reagent) was added into each well and the microtiter plate placed back into the incubator at about 35° C. for about an additional 4 hours to produce the desired color change reaction. Upon removal from the incubator, the color change and pH in each well were recorded.

As demonstrated in Table 3, results generally indicate that the non-live-bacteria concentrate having dead bacteria results in the greatest inhibition of E. coli cell growth as compared either to a blend of non-live-bacteria concentrate having dead bacteria and lactic acid, or to lactic acid alone.

TABLE 3
Microtiter Well Results Comparing the Following Pathogen Killing Agents: Non-Live-Bacteria Concentrate Having Dead
Bacteria, a Blend of Non-Live-Bacteria Concentrate Having Dead Bacteria and Lactic Acid, and Lactic Acid Alone

| | After Incubating at 35° C. for 24 hours | | | After Incubating at 35° C. for 48 hours | | |
|---|---|---|---|---|---|---|
| | Non-Live- | Blend of Non-Live- | | Non-Live- | Blend of Non-Live- | |
| | Bacteria Concentrate | Bacteria Concentrate | | Bacteria Concentrate | Bacteria Concentrate | |
| | Having Dead | Having Dead | Lactic | Having Dead | Having Dead | Lactic |
| Dilution | Bacteria | Bacteria and Lactic Acid | Acid | Bacteria Concentrate | Bacteria and Lactic Acid | Acid |
| 1:1 | − | − | − | − | − | − |
| 1:2 | − | − | − | − | − | − |
| 1:4 | − | − | − | − | − | + |
| 1:8 | − | − | − | −1 | −1 | + |
| 1:16 | − | − | − | −1 | −1 | + |
| 1:32 | −1 | −1 | − | −1 | −1 | + |
| 1:64 | −1 | −1 | − | −1 | −1 | + |
| 1:128 | −1 | + | + | −1 | −1 | −1 |
| 1:256 | −1 | + | + | −1 | + | + |
| 1:512 | −1 | + | + | + | −1 | + |
| 1:1024 | −1 | + | + | −1 | −1 | + |
| No Pathogen | + | + | + | + | + | + |
| Killing | | | | | | |
| Agents Added | | | | | | |

+ = Growth
−1 = Inhibition
− = No Growth

Examples 10 and 11 relate to pathogen reinfection of a wet pet food preserved by a non-live-bacteria concentrate.

### Example 10

### Creation of a Preserved Wet Pet Food

Development of three different wet pet foods preserved according to processes and compositions of the present teachings related to non-live-bacteria preparations and concentrates is shown by Example 10.

The formulas for the three different preserved wet pet foods are shown in Tables 4-6. The protein source (depending on the formula, pork, turkey, or cod) was removed from the freezer and then reduced in size with a grinder. Sweet potato was then added to the protein source, using a dicer to reduce the size for blending. The combined protein source and sweet potato then began to be mixed using a Blendtec Automated paddle mixer, while heat was being added to the blend or the meat and carbohydrate (i.e., from sweet potato) emulsion. After about five minutes of mixing and blending, the vitamin premix and mineral premix were added, mixed, and blended, followed about 5 minutes later by the addition of the oil, which is mixed and blended. Finally, about 5 minutes thereafter, dextrose is added, mixed, and blended. In the meantime, the bacterial blend was pre-hydrated by adding the required amount of bacterial blend into about 240 mL of ambient temperature water. After about 15 minutes of mixing the dextrose and other ingredients, the pre-hydrated bacterial blend was added into the mixture. The bacterial blend and other ingredients continued to be heated and were then heated in about 5 hours to a temperature of between about 49° C. and about 54° C. The bacteria were allowed to ferment until the product reached a pH of about 4.6 or less, which created a fermentate. The fermentate was then heated until reaching about 82° C., which occurred in about 1 hour. The heating process killed the bacterial cells to create a heated, killed culture product (i.e., an activated food product, which includes a non-live-bacteria preparation). The activated food product was then filled into plastic trays while the product was at about at least 71° C. A thin, flexible, plastic laminate film with a sealant layer was then heat sealed onto the plastic tray to create a shelf-stable wet pet food product. In this example, three shelf-stable wet pet food products were created: a pork and sweet potato food product, a cod and sweet potato food product, and a turkey and sweet potato food product.

TABLE 4
Pork and Sweet Potato Formula

| Ingredient | Level (%) |
|---|---|
| Pork | 51.5 |
| Sweet Potato | 40.5 |
| Blend of Salmon and Canola Oil | 2.4 |
| Vitamin Premix | 2.5 |
| Dextrose | 2.9 |
| Bacterial Blend* | .04 |

*Bacterial Blend comprised of Pediococcus pentosacceus and Pediococcus acidilactici and providing about 2 × 10⁷ cfu/gram.

TABLE 5
Cod and Sweet Potato Formula

| Ingredient | Level (%) |
|---|---|
| Cod | 47.2 |
| Sweet Potato | 44.9 |
| Blend of Evening Primrose Oil, Flaxseed | 2.0 |
| Oil, and Sunflower Oil | |
| Vitamin Premix | 2.9 |
| Dextrose | 2.9 |
| Bacterial Blend* | .05 |

*Bacterial Blend comprised of Pediococcus pentosacceus and Pediococcus acidilactici and providing about 2 × 10⁷ cfu/gram.

TABLE 6
Turkey and Sweet Potato Formula

| Ingredient | Level (%) |
|---|---|
| Turkey | 51.5 |
| Sweet Potato | 40.6 |
| Blend of Salmon and Canola Oil | 2.4 |
| Vitamin Premix | 2.5 |
| Dextrose | 2.9 |
| Bacterial Blend* | 0.04 |

*Bacterial Blend comprised of Pediococcus pentosacceus and Pediococcus acidilactici and providing about 2 × 10⁷ cfu/gram.

### Example 11

### Pathogen Reinfection of a Shelf-Stable Wet Pet Food

Evaluation of pathogen reinfection of three shelf-stable wet pet foods is shown by Example 11.

The three shelf-stable wet pet food products as described in Example 10 were evaluated for their ability to resist the growth of pathogens that were deliberately reintroduced into the products. About 11 grams of each shelf-stable wet pet food product were placed into petri dishes. Then, about 0.1 mL (i.e., about 1.86×10⁷ cfu/gram of shelf-stable wet pet food product) of concentrated E. coli (strains ATCC BAA 1427, 1428, 1429, 1430, and 1431) was inoculated onto the surface of the samples of shelf-stable wet pet food product. The samples were incubated at about 22° C. for about 0, 24, 48, and 72 hours. Upon completion of sample incubation, the concentrations of E. coli in the samples were determined by making about 1/10 serial dilutions plated out onto Violet Red Bile Agar plates. Plates were then incubated at about 35° C. for about 24 hours. A Quebec Colony Counter was used to count the plates.

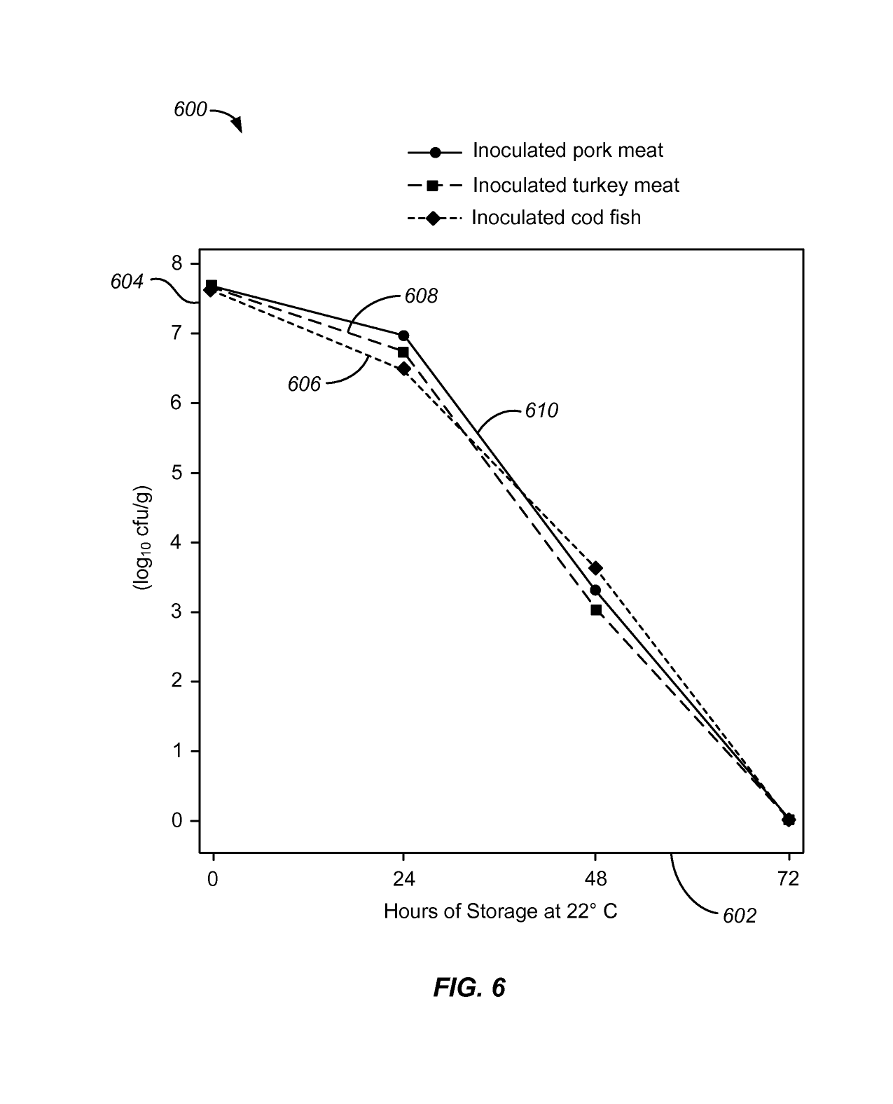

Results are shown in FIG. 6. To this end, FIG. 6 is a line graph 600 showing death of E. coli on shelf-stable wet pet food products that were treated with non-live bacteria preparations (prepared according to the recipes shown in Example 10). An x-axis 602 shows hours of storage at 22° C., and a y-axis 604 shows growth of E. coli, expressed in units of log₁₀ cfu/gram. A line 606 shows E. coli death over time on wet pet food that includes inoculated cod meat, a line 608 shows E. coli death over time on wet pet food that includes inoculated turkey meat, and a line 610 shows E. coli death over time on wet pet food that includes inoculated pork meat. As indicated, E. coli levels were considerably decreased as a result of exposure to the shelf-stable wet pet food products made by the formulas and process described in Example 10. By about 72 hours, the level of E. coli in each shelf-stable wet pet food product was less than about 10 cfu/gram.

Examples 12 through 15 relate to the impact on killing E. coli by applying either a live-bacteria concentrate or a non-live-bacteria concentrate having killed bacteria to a dog food biscuit.

### Example 12

### Development of a Fermentate

Development of a fermentate containing live Pediococci is shown by Example 12.

A chicken broth mixture containing about 2% dextrose and about 0.1% Tween 80 was pasteurized to about 88° C. to create a pasteurized broth mixture. When the pasteurized broth mixture had cooled to about 71° C., amino acids were added to create an amino-acid-enriched broth mixture containing about 0.1% threonine, about 0.05% serine, about 0.05% proline, and about 0.1% cysteine. The amino-acid-enriched broth mixture was further cooled to about 52° C. and then swirled to create a homogenous broth suspension. The homogenous broth suspension was then inoculated with about 0.5 grams of Pediococcus acidilactici and Pediococcus pentosaceus freeze dried culture to provide a concentration of about 1×10⁷ cfu/gram. The inoculated chicken broth was placed in a sealed container and then incubated at about 35° C. for about 48 hours. The fermentate was then kept at ambient temperature until further use.

### Example 13

### Development of a Live-Bacteria Concentrate

Development of a live-bacteria concentrate containing live Pediococci is shown by Example 13.

The bacterial cells were removed from the fermentate described in Example 12 by centrifuging about 400 mL of fermentate at about 2,600 g for about 15 minutes. The supernatant was discarded and the recovered bacterial cells were resuspended in about 50 mL of BPBD at about 1×10¹⁰ cfu/gram to create a live-bacteria concentrate.

### Example 14

### Development of a Non-Live-Bacteria Concentrate Substantially Depleted of Bacteria

About 240 mL of ethanol (75.5%) were added into about 600 mL of the fermentate as described in Example 12 to create an ethanol-enriched fermentate. The ethanol-enriched fermentate was then centrifuged at about 2,500 g for about 15 minutes. After centrifugation, the supernatant was recovered and the cells discarded. The supernatant was placed into an approximately 45° C. incubator to evaporate ethanol and water off until an approximately 3× concentration (i.e., about 450 mL fermentate substantially depleted of bacteria concentrated to about 150 mL) was formed. This created a non-live-bacteria concentrate substantially depleted of bacteria based on a cell equivalent of about 7.94×10⁸ cfu/gram.

### Example 15

### Application of Concentrates to Dog Biscuits

Application of a live-bacteria concentrate and a non-live-bacteria concentrate substantially depleted of bacteria to dog biscuits is shown by Example 15.

Dog biscuits with bacon flavoring weighing about 100 grams and having a total surface area of about 152 cm² were used in this example. The top surface (about 56 cm²) of each biscuit was prepared by inoculating with E. coli (strains ATCC BAA 1427, 1428, 1429, 1430, and 1431) at about 1×10⁷ cfu/side of dog biscuit. After inoculation, the addition of about 1.5 grams of either the live-bacteria concentrate, as described in Example 13, or the non-live-bacteria substantially depleted of bacteria concentrate source, as described in Example 14, were also added to the surface of the dog biscuit. At the appropriate time after addition of the non-live-bacteria concentrate sources, the surface was rinsed and the live E. coli cells remaining were quantified. As such, results reflect the number of E. coli on one side, the top surface, of each biscuit.

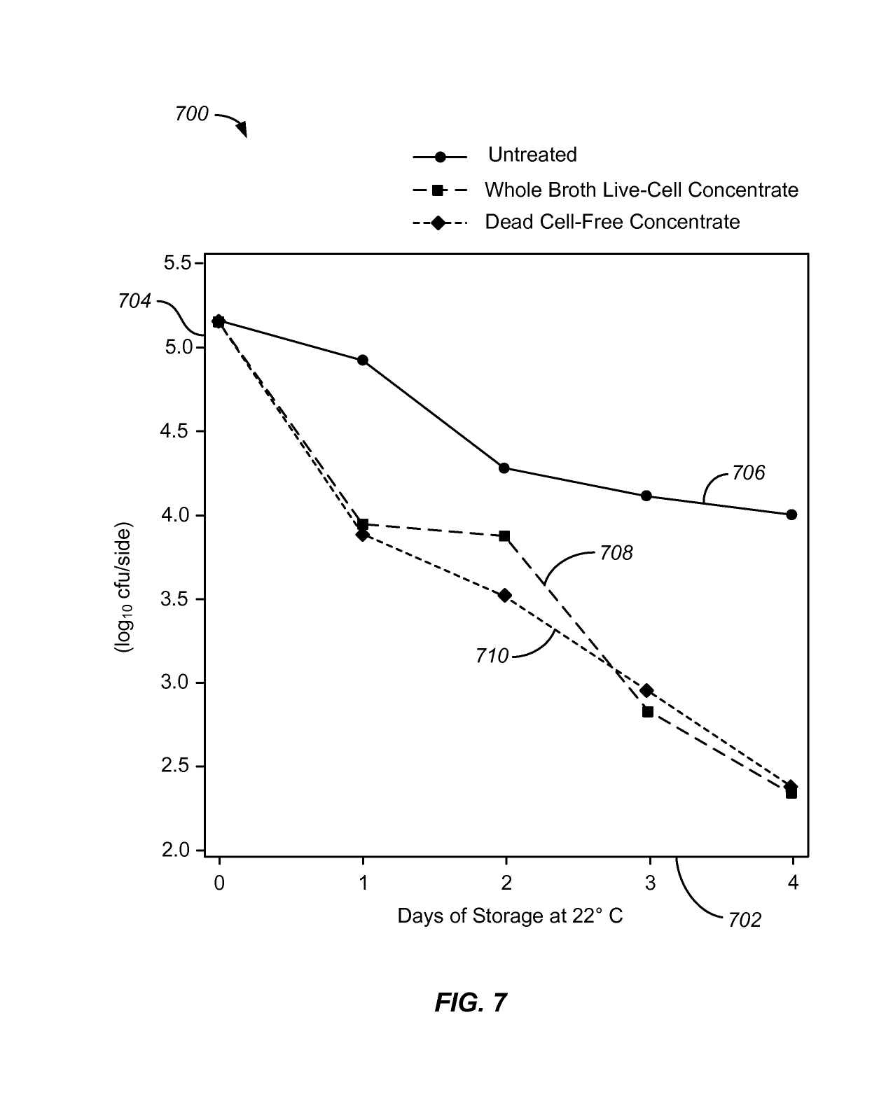

Results are displayed in FIG. 7. To this end, FIG. 7 is a line graph 700 showing death of E. coli over time on dog biscuits that were untreated, treated with a live-bacteria preparation, or treated with a non-live-bacteria concentrate substantially depleted of bacteria. An x-axis 702 shows hours of storage at 22° C., and a y-axis 704 shows growth of E. coli, expressed in units of log₁₀ cfu/gram. A line 706 shows E. coli death over time on untreated dog biscuits, a line 708 shows E. coli death over time on dog biscuits treated with a live-bacteria preparation, and a line 710 shows E. coli death over time on dog biscuits treated with a non-live-bacteria preparation substantially depleted of bacteria. Results indicate that generally the same amount of E. coli kill occurred in the non-live-bacteria concentrate substantially depleted of bacteria source as occurred in the live-bacteria preparation. Because the non-live-bacteria concentrate substantially depleted of bacteria source was based on a lower concentration of cells, the efficacy of the non-live-bacteria concentrate substantially depleted of bacteria was more effective per bacterial cell than the live-bacteria preparation.

Examples 16 and 17 relate to the use of cell-free washings as non-live-bacteria preparations or concentrates, and show that an entity responsible for killing pathogens is closely associated with the bacterial cells.

### Example 16

### Obtaining Cell-Free Washings

Development of cell-free cell washings is shown by Example 16.

About 100 mL of the fermentate described by Example 1 were centrifuged at about 2,600 g for about 15 minutes. The supernatant was decanted off and the precipitate, which contained the bacteria cells, was collected. About 100 mL of BPBD was then added to about 5 grams of cells for about 4 hours to allow cells to equilibrate in BPBD. The BPBD containing the equilibrated cells was centrifuged at about 2,600 g for about 15 minutes. The supernatant was then decanted off and collected to create cell-free washings. The cell-free washings were verified to contain less than about 1,000 cells per mL.

### Example 17

### Evidence of Cell-Free Washings Providing the Source of Pathogen Killing Power

Evidence regarding the ability of cell-free washings to kill pathogens is described in Example 17.

About 9 mL of BPBD was mixed into about 1 mL of a solution containing about 1×10⁷ cfu/mL of E. coli (strains ATCC BAA 1427, 1428, 1429, 1430, and 1431). Into this solution, about 9 mL of cell-free washings, as described in Example 16, were mixed. The E. coli and BPBD mixture from Example 16 served as source for the control samples. The E. coli and cell-free washings mixture served as the source for the test samples. The control and test samples were incubated at about 22° C. and about 37° C. for about 0, 24, 48, 72, and 96 hours. The concentration of E. coli was assessed in each of the samples.

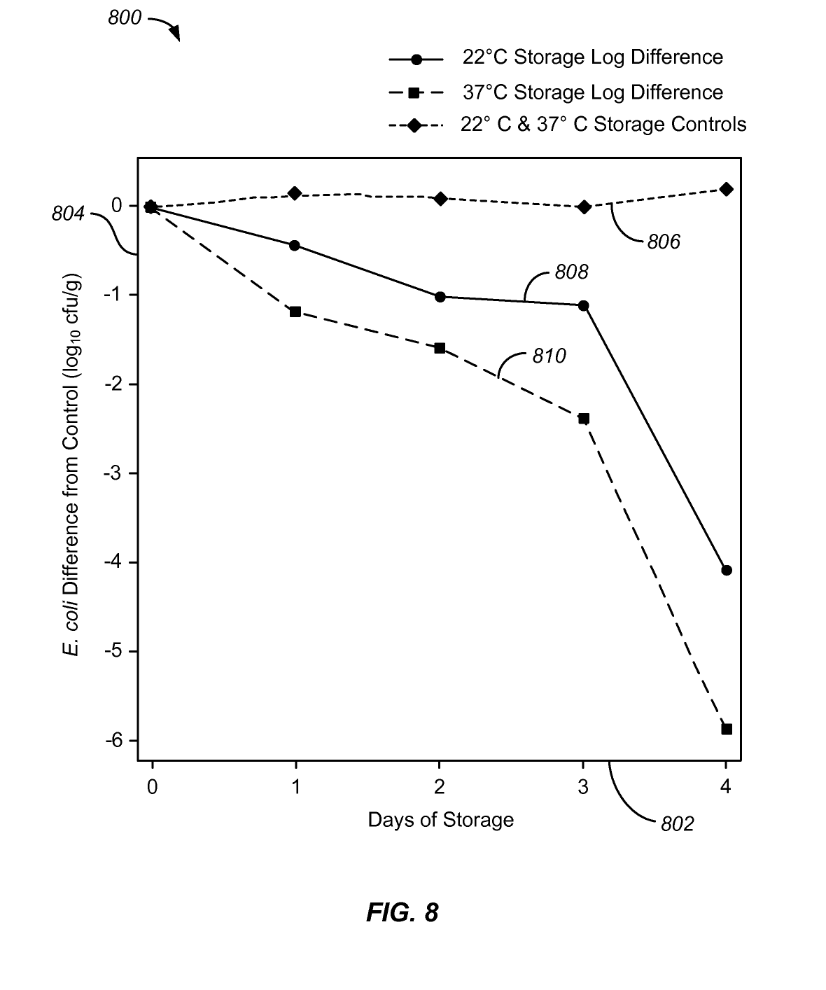

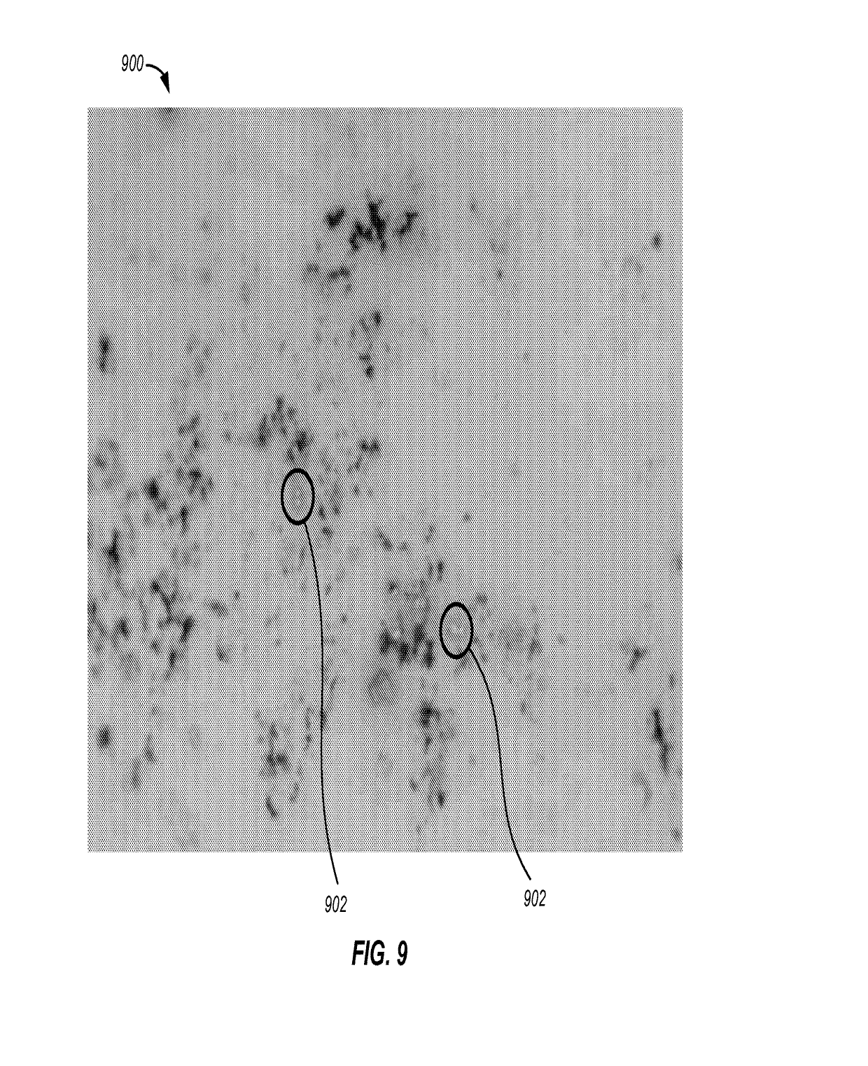

Results are shown in FIG. 8. To this end, FIG. 8 is a line graph 800 showing effect of storage temperature on death of E. coli over time when treated with non-live-bacteria preparations, in the form of cell-free washings, that are substantially depleted of bacteria. An x-axis 802 shows days of storage, and a y-axis 804 shows growth of E. coli relative to an untreated control sample, expressed in units of log₁₀ cfu/gram. A line 806 shows E. coli death over time on untreated control samples stored at about 22° C. and about 37° C. A line 808 shows E. coli death over time on samples stored at about 22° C. A line 810 shows E. coli death over time on samples stored at about 37° C. Results indicate that the test samples killed progressively more E. coli as incubation time increased. Further, the higher incubation temperature produced more killing of E. coli than the lower incubation temperature. Results also indicate that entities closely associated with the cells, but not directly on the cells, were responsible for the killing of E. coli. To this end, FIG. 9 is a 1000× photomicrograph that depicts Pediococci with acid mucins associated on the bacteria, as shown by the circled open holes 902 on FIG. 9. The photomicrograph shown in FIG. 9 used an Alcian Blue pH 2.5 stain, which is a commonly used cationic stain on histological tissues for the detection of anionic acid mucins, especially in cases where endogenously produced acid mucins are above normal levels, such as what occurs in damaged colon enterocytes and in cancerous tissues. Taken together, the results of FIGS. 8 and 9 suggest the role of the acid mucins that are formed from Pediococci, i.e., they are strongly associated with the surface of the Pediococci and then released into the extracellular environment during washing to ultimately kill pathogens and spoilage microorganisms.

### Example 18

### Obtaining a Non-Live-Bacteria Concentrate

Example 18 relates to one preferred embodiment for obtaining a non-live-bacteria concentrate once a fermentate has been prepared.

About 160 mL ethanol were added to about 400 mL of the fermentate described by Example 1 to create an ethanol/fermentate mixture. The ethanol/fermentate mixture was incubated at about 45° C. for about 4 days. Upon completion of the incubation, about 17.5 grams of concentrate remained. The percent concentrate is calculated by dividing the grams of concentrate remaining after incubation by the volume (in mL) of the fermentation culture and multiplying by 100. Thus, the original fermentate contained about a 4.375% concentrate. Alternatively, the fermentate was concentrated by a factor of about 22.9 times (i.e., 400/17.5). The consistency of the concentrate that remained was similar to a gummy, snotty, glue-like, ropey substance. About 25 mL of ethanol was added to about 17.5 grams of concentrate. The addition of ethanol was used to enable the substance to be sprayed out of a spray bottle to create an ethanol-reconstituted concentrate. The spray bottle was a standard hand operated spray bottle purchased from WalMart® and was used to apply the ethanol reconstituted concentrate to yeast in the form of a dry powder at an application rate of about 1.5 grams of ethanol reconstituted concentrate per approximately 100 grams of yeast to create a concentrate-enriched yeast. The percent concentrate within the concentrate-enriched yeast was about 0.618% (i.e., 17.5/(17.5+25)×1.5/100×100).

### Example 19

### Obtaining a Non-Live-Bacteria Concentrate Having Dead Bacteria

Development of a non-live-bacteria concentrate is shown by Example 19.

About 200 mL of ethanol (75.5%) were added to about 400 mL of the fermentate described by Example 1 to create an ethanol/fermentate mixture. The ethanol/fermentate mixture was incubated at about 45° C. for about 5 days. Upon completion of the incubation, about 14.4 grams of concentrate remained. The percent concentrate is calculated as described above in Example 18. Thus, the original fermentate contained about 3.6% concentrate (i.e., 14.4/400×100). Alternatively, the fermentate was concentrated by a factor of about 27.8 times (i.e., 400/14.4). The consistency of the non-live-bacteria concentrate having dead bacteria that remained was similar to a gummy, snotty, glue-like, ropey substance.

### Example 20

### Impact of a Non-Live-Bacteria Concentrate Having Dead Bacteria on Pathogen Kill

The impact of a non-live-bacteria concentrate having dead bacteria on pathogen kill is shown by Example 20.

In Example 20, a microtiter well experiment was conducted to evaluate the efficacy of the non-live-bacteria concentrate described in Example 19 on killing E. coli (ATCC BAA strains 1427, 1428, 1429, 1430, and 1431). The impact of heating on the efficacy of the non-live-bacteria concentrate was further evaluated. The process to evaluate this using a microtiter plate is described as follows. About 25 mL of ethanol was added to about 14.4 grams of non-live-bacteria concentrate obtained in Example 19 to create an ethanol-enriched non-live-bacteria concentrate. About 100 μL of ethanol-enriched concentrate were added into wells 1 and 2. In samples of the ethanol-enriched concentrate where the ethanol and moisture were removed by oven heating, gravimetric means were employed to determine that about 57.6% of the ethanol-enriched concentrate comprised solids. Therefore, the amount of non-live-bacteria concentrate added to wells 1 and 2 was about 57.6 mg of concentrate. Well 1 served as the negative control, as no growth nutrient was added (to demonstrate that no E. coli would grow in the wells without their purposeful addition to the wells). About 100 μL of ethanol (75.5%) were added into wells 2 through 16. About 100 μL were drawn from well 2 and placed into well 3. For well 3 and thereafter, repeated samples of about 100 μL were drawn and placed into the next well to result in the following approximate dilutions, by volume: 1:1, 1:2, 1:4, 1:8, 1:16, 1:32, 1:64, 1:128, 1:256, 1:512, 1:1024, 1:2048, 1:4096, 1:8192, 1:16384, and 1:32768. The previously described procedure for wells 1 through 16 was repeated in a second set of microtiter wells using a different portion of the ethanol-enriched concentrate that was heated in a water bath until it reached about 65° C. and was then removed. The microtiter plate was then incubated as about 45° C. for about 4 hours until all wells were dry.

Upon drying the microtiter plate, about 100 μL of distilled water were added to well 1 and about 100 μL of chicken broth were added to wells 2 through 17. About 50 μL of E. coli (ATCC BAA strains 1427, 1428, 1429, 1430, and 1431) solution that provided about 1×10⁶ cfu were added to wells 1 through 17. Well 17, which contained about 100 μL of chicken broth and about 50 μL of E. coli solution, served as a positive control (to determine whether the E. coli would grow without the addition of the palatant containing a non-live-bacteria concentrate).

The microtiter plate was covered and placed in an incubator at about 35° C. for about 48 hours. After the appropriate incubation time, the microtiter plate was removed from the incubator. About 100 μL of the metabolic indicator iodonitrotetrazolium chloride were added to each well. The microtiter plate was placed into the approximately 35° C. incubator for about 2 hours to develop the color change. Upon removal from the incubator, the results were recorded.

Results are displayed in Table 7. Results indicate that a high degree of killing power occurred in both unheated and heated concentrates, with the unheated concentrate resulting in all but the very weakest dilution killing or inhibiting the growth of the E. coli strains.

TABLE 7
MICROTITER WELL RESULTS COMPARING UNHEATED VS.
HEATED (65° C.) NON-LIVE-BACTERIA CONCENTRATES
HAVING DEAD BACTERIA

| | | | | Heat-Treated |
|---|---|---|---|---|
| | | Concentrate | Unheated | Concentrate |
| Well # | Dilution | (mg/well) | Concentrate | (to 65° C.) |
| 1 | 1:1 | 57.6 | − | − |
| 2 | 1:2 | 28.8 | − | − |
| 3 | 1:4 | 14.4 | − | − |
| 4 | 1:8 | 7.2 | − | − |
| 5 | 1:16 | 3.6 | − | − |
| 6 | 1:32 | 1.8 | − | − |
| 7 | 1:68 | 0.9 | − | − |
| 8 | 1:128 | 0.45 | − | − |
| 9 | 1:256 | 0.225 | − | −1 |
| 10 | 1:512 | 0.1125 | − | − |
| 11 | 1:1024 | 0.0556 | − | −1 |
| 12 | 1:2048 | 0.0281 | −1 | −1 |
| 13 | 1:4096 | 0.0141 | −1 | + |
| 14 | 1:8192 | 0.0070 | −1 | −1 |
| 15 | 1:16384 | 0.0035 | −1 | −1 |
| 16 | 1:32768 | 0.0018 | + | + |
| 17 | No | 0 | + | + |
| | Concentrate | | | |
| | Added | | | |

+ = Growth
−1 = Inhibition
− = No Growth

Examples 21-23 relate to producing dry palatants associated with non-live-bacteria concentrates for kibbled pet food. It was surprising that non-live-bacteria preparations and concentrates were effective at killing food-borne pathogens under these circumstances, because a source of moisture is typically required to kill food-borne pathogens. It is thought that food-borne pathogens require a source of moisture because they are believed to need water to be metabolically active. As shown in the following examples, however, in spite of the use of substantially dry kibbles, significant pathogen kill was realized in the presence of a dried non-live-bacteria concentrate.

### Example 21

### Development of Fermentate

Development of a fermentate containing Pediococci is shown by Example 21.

Chicken broth with about 2% Dextrose, about 0.1% Tween 80, about 0.1% threonine, about 0.05% serine, about 0.05% proline, and about 0.1% cysteine was pasteurized to about 88° C. to produce a pasteurized broth. After cooling to about 52° C., the pasteurized broth was inoculated with Pediococcus acidilactici and Pediococcus pentosaceus at the level of about 1×10⁷ cfu/gram. The inoculated chicken broth was placed in a sealed container and then placed in an environment at about 35° C. for about 48 hours to allow it to ferment. After about 48 hours, the fermentate was removed from the approximately 35° C. environment and kept at ambient temperature until the bacterial cells were removed from the fermentate by centrifugation at about 2,600 g for about 15 minutes. The recovered bacterial cells were resuspended in BPBD at about 1×10¹⁰ cfu/gram to produce a live-bacteria concentrate, which was then stored in refrigeration (i.e., about 4° C.).

### Example 22

### Enrichment of Dry Palatant with Recovered Bacterial Cells

Obtaining dried bacterial cells and adding these to a dry palatant is shown by Example 22.

The live-bacteria concentrate from Example 21 was removed from refrigeration storage. The live-bacteria concentrate consisted of two portions: solids and fluid.

In order to remove the water, the bacterial solids (about 5 grams) were separated from the fluid portion by decanting the fluid portion off. The bacterial solids were then brought to complete dryness by incubating at about 49° C. for about 24 hours. This process resulted in collecting about 0.5 grams of dried bacterial solids from the solid portion. The decanted liquid portion (about 20 grams) was condensed to about 5 grams by incubating at about 49° C. for about 96 hours This process resulted in collecting about 5 grams of condensed bacterial solids (i.e., a non-live-bacteria concentrate substantially depleted of bacteria) from the liquid portion.

Next, in order to kill the bacterial cells, ethanol was added to both portions of dried solids. About 6.25 grams of ethanol was added to the approximately 0.5 grams of dried bacterial solids obtained from the solid portion, and about 6.25 grams of ethanol was added to the condensed bacterial solids obtained from the fluid portion. The two portions of ethanol-enriched condensed bacterial solids were then re-combined. After about 2 hours, the ethanol supernatant containing the killed bacterial cells was decanted and collected.

The ethanol supernatant containing the dead bacterial cells was then sprayed onto soy flour (“SF”; Hodgson Mill All Natural Soy Flour) at an application rate of about 3 grams of spray per about 100 grams whole soybean flour. The SF served as a model for a dry palatant. The sprayed, bacterial-enriched SF was dried at about 22° C. for about 24 hours, or until no ethanol remained. This dried substance (which includes non-live-bacteria concentrates) is further referred to as a dry palatant enriched with a non-live-bacteria concentrate.

### Example 23

### Application of a Dry Palatant Enriched with a Non-Live-Bacteria Preparation to Kibbles Contaminated with Salmonella Surrogates

The effect of applying a dry palatant enriched with a non-live-bacteria concentrate to kibbles contaminated with Salmonella surrogate bacteria is shown by Example 23.

The method of enriching the non-live-bacteria concentrate onto the dry palatant was carried out according to the method described in Example 22.

The kibble source consisted of kibbles suitable for cats. Kibbles were coated with approximately 5.5% fat.

In order to simulate contaminated kibbles, surrogate organisms for Salmonella were applied to the kibbles. The following E. coli strain types of ATCC (BAA 1427, BAA 1428, BAA 1429, BAA 1430, and BAA 1431) were used as surrogate organisms. The liquid solution containing E. coli was applied at about 1×10⁷ cfu/gram to the kibbles. The kibbles were dried for about 24 hours at about 22° C. The result was the creation of kibbles contaminated with Salmonella and E. coli O157:H7 surrogates.

The contaminated kibble source was divided in half. Onto the first half, about 1.5 grams of dry palatant was dusted onto every approximately 98.5 grams of contaminated kibbles. Onto the second half, about 1.5 grams of dry palatant enriched with a non-live-bacteria concentrate as described in Example 22 were dusted onto every approximately 98.5 grams of contaminated kibbles. The dusting method consisted of adding the dry palatant or dry palatant enriched with a non-live-bacteria concentrate to the kibbles, closing the container, and then shaking the contents vigorously. All dustings were carried out at ambient temperature.

Dusted kibbles were then stored at about 22° C. for up to 4 days. Daily samples of kibbles were assessed for the level of Salmonella surrogates by using Violet Red Bile Glucose (VRBG) agar to enumerate the level of E. coli present. Serial dilutions of washed kibble were used to recover surface bacteria. Serial dilutions of kibble washes were made by dilution with BPBD (10⁰, 10⁻¹, 10⁻², 10⁻³). The washes were collected, pipetted into petri plates, and then pour plated with VRBG agar. The plates were incubated for about 24 hours at about 35° C. and then counted for the number of E. coli present within a given sample.

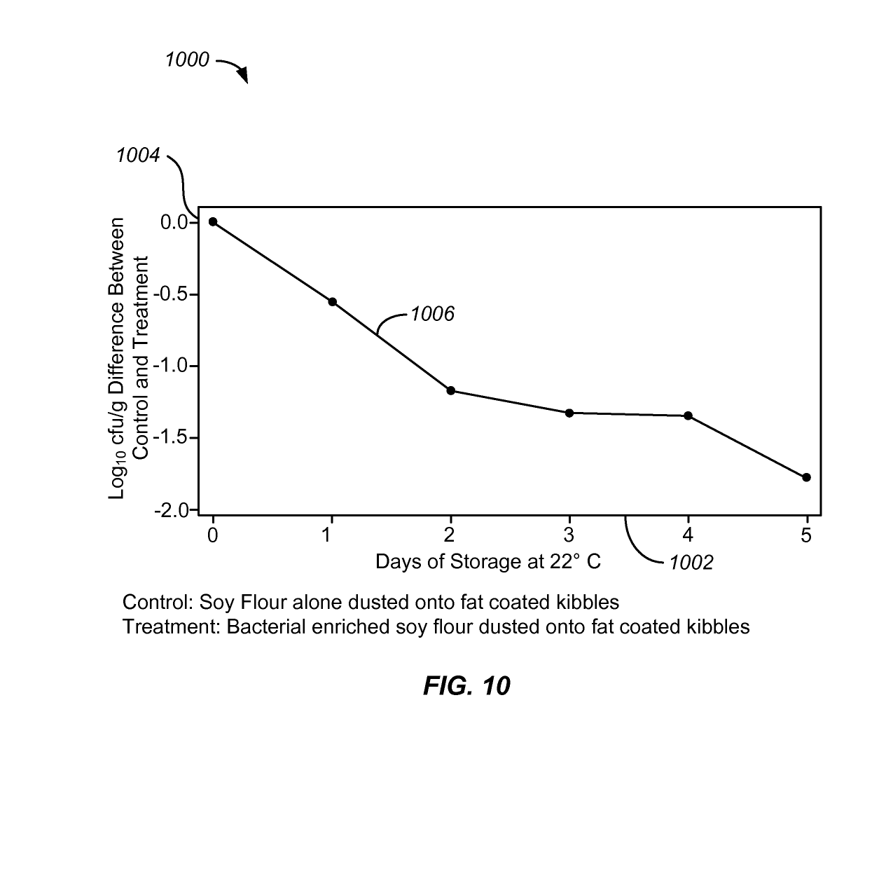

Results demonstrating the difference between kibbles treated with dry palatant alone or with dry palatant enriched with a non-live-bacteria concentrate are shown in FIG. 10. To this end, FIG. 10 is a line graph 1000 showing death of E. coli on kibbles treated with a non-live-bacteria concentrate enriched with a palatant relative to treatment with a palatant alone. An x-axis 1002 shows days of storage at about 22° C. A y-axis 1004 shows growth of E. coli relative to an untreated control, expressed in units of log₁₀ cfu/gram difference between control and treatment. A line 1006 shows the difference in E. coli death between dry palatant enriched with a non-live-bacteria concentrate and the dry palatant alone.

These results indicate that the dry palatant enriched with a non-live-bacteria concentrate does not need live bacterial cells in order to kill the pathogenic bacteria over an approximately 5-day storage period at about 22° C.

### Example 24

### Development of Cysteine-Enriched 10× Non-Live-Bacteria Concentrates.

Development of cysteine-enriched 10× non-live-bacteria concentrates is shown by Example 24.

Two bacterial incubation broths were made according the formulas found in Table 8.

TABLE 8
Bacterial Incubation Broth Formulas

| | 0.1% Cysteine-Enriched | 1% Cysteine-Enriched |
|---|---|---|
| | Broth | Broth |
| Ingredient | Amount (%) | Amount (%) |
| Chicken Broth | 96.8 | 95.9 |
| Dextrose | 1 | 1 |
| Tween ® 80* | 0.1 | 0.1 |
| Threonine | 1 | 1 |
| Proline | 0.5 | 0.5 |
| Serine | 0.5 | 0.5 |
| Cysteine HCl | 0.1 | 1 |
| Total | 100.00 | 100.00 |

*Tween 80 is also referred to as polysorbate 80.

First, chicken broth mixtures with about 1% dextrose and about 0.1% Tween 80 were heated to about 88° C. to create pasteurized broth mixtures. When the pasteurized broth mixtures had cooled to about 74° C., amino acids, at about 1% threonine, 0.5% serine, 0.5% proline, and either 0.1 or 1.0% cysteine, were added to create amino-acid-enriched broth mixtures. The amino-acid-enriched broth mixtures were further cooled to about 38° C. to create cooled broth mixtures. Next, Pediococcus acidilactici and P. pentosaceus at the level of about 1×10⁷ cfu/gram were added to the cooled broth mixtures to create inoculated broths. The inoculated broths were incubated at about 35° C. for about 48 hours. After incubation was complete, the live bacteria in the 0.1% cysteine-enriched incubated broth and in the 1% cysteine-enriched incubated broth were killed by adding approximately 40%, by volume, of ethanol (75.5% solution). The ethanol containing broths were then concentrated about 10× by collecting the precipitate as a source of the bacterial cells from nine volumes of broth and adding the precipitate containing bacterial cells back into one volume of ethanol-containing broth to create a 0.1% cysteine-enriched 10× non-live concentrate and a 1% cysteine-enriched 10× non-live concentrate.

### Example 25

### Impact of Cysteine-Enriched 10× Non-Live Concentrates on Kill of Salmonella Surrogates

In example 25, 0.1% cysteine-enriched 10× concentrate and 1% cysteine-enriched 10× non-live-bacteria concentrates were evaluated for their effects on death of Salmonella surrogates.

E. coli strains ATCC BAA 1427, 1428, 1429, 1430, and 1431 served as the Salmonella surrogate organisms for this experiment. E. coli were added into a solution of BPBD that resulted in approximately 1×10⁷ cfu/gram to create the Salmonella surrogate source.

The sources of 0.1% cysteine-enriched 10× non-live concentrate and 1% cysteine-enriched 10× non-live concentrate were as described in Example 24. A microtiter well experiment was conducted to evaluate the efficacy of concentrates added into chicken broth along with E. coli that served as surrogates for the Salmonella pathogen. Separate microtiter plates were used to evaluate each concentrate separately. About 100 μL of each concentrate were added into wells 1 and 2 on a microtiter plate. Then the microtiter plates were incubated at about 45° C. for about 24 hours to remove the ethanol and water from the well. Next, about 100 μL of BPBD were added to wells 1 and 2. Then, about 100 μL of chicken broth were added into microtiter wells 2 through 12. Starting with well 2, 1:2 serial dilutions were made for every subsequent well. The results were that wells 1 through 12 had the following serial dilutions, by volume, of inoculum: 1:1, 1:2, 1:4, 1:8, 1:16, 1:32, 1:64, 1:128, 1:256, 1:512, 1:1024, and 1:2048. Next, about 100 μL of the Salmonella surrogate source were added to wells 1 through 12. A control well was also made that contained about 100 μL chicken broth and about 100 μL of the Salmonella surrogate source. Microtiter plates were then incubated at about 35° C. for about 48 hours. Upon completion of incubation, about 100 μL of iodonitrotetrazolium color reagent were added to each well. Microtiter plates were then placed into an approximately 35° C. environment for about 2 to 4 hours to enable the color change to occur. In each microtiter well, a yellow or amber color indicated no growth, a pink color indicated inhibition of growth, and a red color indicated definite growth of the E. coli.

Results are shown in Table 9. Results indicated that both non-live-bacteria concentrate sources killed Salmonella surrogates (i.e., E. coli). However, a lower concentration of the 1% cysteine-enriched 10× non-live-bacteria concentrate was needed to effectively kill Salmonella surrogates.

TABLE 9
Impact of Cysteine-Enriched 10X Non-Live-
Bacteria Concentrate on Killing E. coli

10X Non-Live-Bacteria Concentrate

| Dilution | 0.1% Cysteine | 1% Cysteine |
|---|---|---|
| 1:1 | − | − |
| 1:2 | − | − |
| 1:4 | − | − |
| 1:8 | − | − |
| 1:16 | − | − |
| 1:32 | + | − |
| 1:64 | + | − |
| 1:128 | + | − |
| 1:256 | + | − |
| 1:512 | + | − |
| 1:1024 | + | − |
| 1:2048 | ++ | −1 |
| 1:4096 | ++ | ++ |
| Control | ++ | ++ |

− = No growth
−1 = possible growth
+ = definite growth

Impact of Live-Bacteria Preparation or 4× Non-Live-Bacteria Concentrate on Pathogens in Green Juice.

Examples 26, 27, and 28 show the ability of a live-bacteria preparation compared to a non-live-bacteria concentrate on killing pathogens in a green juice matrix.

### Example 26

### Development of a Live-Bacteria Preparation Grown on Trypto Soy Broth with Additional Air Exposure

Development of a live-bacteria preparation grown on Trypto Soy Broth is shown by Example 26.

A bacterial incubation broth was prepared according the formula found in Table 10.

TABLE 10
Bacterial Incubation Broth Formula

| Ingredient | Amount (%) |
|---|---|
| Trypto Soy Broth* | 2.88 |
| Glycerin | 0.96 |
| Water | 96.15 |
| Total | 100.0 |

*Trypto Soy Broth consists of casein digest peptone, about 56.7%; papain digest of soy bean meal, about 10%; sodium chloride, about 16.7%; dextrose, about 8.3%; and dipotassium phosphate, about 8.3%.

First, water with about 2.88% Trypto Soy Broth and about 0.96% glycerin was pasteurized to about 121° C. to create a sterilized broth mixture. When the sterilized broth mixture had cooled to about 43° C., Pediococcus acidilactici and P. pentosaceus at the level of 1×10⁷ cfu/gram were added to create an inoculated broth. The inoculated broth was placed into shallow Teflon® pans to increase air exposure of the broth and was incubated at about 35° C. for about 24 hours. Incubation was then continued at about 22° C. for about 96 hours to create a live-bacteria preparation. The live-bacteria preparation was then placed in a closed container that was stored at about 4° C. until further use.

### Example 27

### Development of a Non-Live-Bacteria Preparation from a Pediococci Culture Grown on Trypto Soy Broth.

Development of a non-live-bacteria preparation having dead Pediococci is shown by Example 27.

A bacterial incubation broth was prepared according the formula in Table 11.

TABLE 11
Bacterial Incubation Broth Formula

| Ingredient | Amount (%) |
|---|---|
| Chicken Broth | 94.9 |
| Dextrose | 2 |
| Tween ® 80* | 0.1 |
| Threonine | 1 |
| Proline | 0.5 |
| Serine | 0.5 |
| Cysteine HCl | 1 |
| Total | 100.0 |

*Tween 80 is also referred to as polysorbate 80.

First, chicken broth containing about 2% dextrose and about 0.1% Tween 80 was pasteurized to about 85° C. for about 1 minute to create a pasteurized broth mixture. When the pasteurized broth mixture had cooled to about 82° C., amino acids were added at the following levels, about 1.0% threonine, about 0.5% serine, about 0.5% proline, and about 1.0% cysteine, to create an amino-acid-enriched broth mixture. The amino-acid-enriched broth mixture was further cooled to about 38° C. to create a cooled broth mixture. Next, Pediococcus acidilactici and P. pentosaceus at the level of 1×10⁷ cfu/gram were added to the cooled broth mixture to create an inoculated broth. The inoculated broth was incubated at about 35° C. for about 48 hours to create a live-bacteria preparation with Pediococci. After incubation, the live-bacteria preparation with Pediococci was heated to about 85° C. for about 10 minutes to kill Pediococci and create a non-live-bacteria preparation having dead bacteria. The non-live-bacteria preparation was then placed into shallow pans and evaporated to a 4× concentration (i.e., 1000 mL non-live-bacteria culture concentrated to 250 mL non-live-bacteria culture) by heating to about 45° C. to create a 4× non-live-bacteria concentrate. The 4× non-live-bacteria concentrate was then stored at about 4° C. until further use.

### Example 28

### Impact of a Live-Bacteria Preparation, a 4× Non-Live-Bacteria Concentrate, and Potassium Sorbate, on Killing Salmonella Surrogates in a Green Juice

In Example 28, a live-bacteria preparation, a 4× non-live-bacteria concentrate, and potassium sorbate, were evaluated for their abilities to kill Salmonella surrogates.

The source of the live-bacteria preparation was prepared as described in Example 26. The 4× non-live-bacteria concentrate was prepared as described in Example 27.

E. coli strains ATCC BAA 1427, 1428, 1429, 1430, and 1431, served as the Salmonella surrogate organisms for this experiment. E. coli was added into a solution of BPBD that resulted in about 1×10⁷ cfu/gram to create the Salmonella surrogate source.

Green juice was made by grinding up and filtering out (Hamilton Beach) the juice from about 450 grams kale, about 450 grams spinach, about 10 grams of ginger, and about 90 grams lemon juice. The pH of the juice was about 4.55.

The following approximate treatments effects on killing Salmonella in green juice were evaluated: 5% live-bacteria preparation, 25% live-bacteria preparation, 25% live-bacteria preparation+0.1% potassium sorbate, 5% non-live-bacteria concentrate, 25% non-live-bacteria concentrate, and 25% non-live-bacteria concentrate+0.1% potassium sorbate. After adding the appropriate amount of treatment, Salmonella surrogates were then added to produce approximately 1×10⁷ cfu/gram of treated green juice to determine the influence of the treatments on Salmonella surrogates. Another set of samples were made with the addition of treatments but without the addition of Salmonella surrogates for the purpose of determining the influence of the treatments on psychotropic bacteria. Corresponding controls were made by not adding any treatment. After incubating samples at about 45° C. for about 9 hours, and then at about 4° C. for about 24 hours, the levels of Salmonella surrogates were assessed by plating in Violet Red Bile Agar then incubating for about 24 hours at about 35° C., while the psychotropic normal flora levels were assessed by pour plating samples onto Aerobic Plate Count Agar incubated for about 72 hours at about 22° C.

Results are presented in Table 14. Results indicated that all treatments killed Salmonella surrogates by at least about 0.68 log₁₀. Results further indicate that the 25% treatment of live-bacteria preparations and the 25% treatment of 4× non-live-bacteria concentrates plus 0.1% potassium sorbate were effective in killing psychotropic normal flora.

TABLE 12
Impact of Live-Bacteria Preparation, 4X Non-Live-Bacteria Concentrate,
and 0.1% Potassium Sorbate on Pathogen Kill in Green Juice

| | Impact on Killing Salmonella | | | Impact on Killing Psychotropic Normal | | |
|---|---|---|---|---|---|---|
| | Surrogates | | | Flora | | |
| | | | 25% Live- | | | 25% Live- |
| | | | Bacteria | | | Bacteria |
| | 5% Live- | 25% Live- | Preparation + | 5% Live- | 25% Live- | Preparation + |
| | Bacteria | Bacteria | 0.1% Potassium | Bacteria | Bacteria | 0.1% Potassium |
| Treatment | Preparation | Preparation | Sorbate | Preparation | Preparation | Sorbate |
| Live- | −1.03* | −0.68 | ND** | 0.09 | −0.30 | ND |
| Bacteria | | | | | | |
| Preparation | | | | | | |
| 4X Non- | −0.75 | −0.93 | −1.21 | 0.09 | 0.19 | −0.33 |
| Live- | | | | | | |
| Bacteria | | | | | | |
| Concentrate | | | | | | |

*Results reported are log₁₀ change from the corresponding control value.
**ND = not determined.

In examples 29, 30, and 31, a live-bacteria concentrate and a non-live-bacteria concentrate are shown to kill pathogens on the inedible surfaces of stainless steel and concrete and edible fines generated in the process of manufacturing kibbled foods.

### Example 29

### Development of 10× Live-Bacteria Concentrate

Development of a 10× live-bacteria concentrate is shown by Example 29.

The bacterial incubation broths were prepared according to the formulas shown in Table 13.

TABLE 13
Bacterial Incubation Broth Formulas

| | 0.1% Cysteine Grown | 1% Cysteine Grown |
|---|---|---|
| Ingredient | Amount (%) | Amount (%) |
| Chicken Broth | 95.8 | 94.9 |
| Dextrose | 2 | 2 |
| Tween ® 80* | 0.1 | 0.1 |
| Threonine | 1 | 1 |
| Proline | 0.5 | 0.5 |
| Serine | 0.5 | 0.5 |
| Cysteine HCl | 0.1 | 1 |
| Total | 100.00 | 100.00 |

*Tween 80 is also referred to as polysorbate 80.

First, chicken broth with about 2% dextrose and about 0.1% Tween 80 was heated to about 88° C. to create pasteurized broth mixtures. When the pasteurized broth mixtures had cooled to about 79° C., amino acids were added to the pasteurized broth mixtures in the following amounts, about 1% threonine, about 0.5% serine, about 0.5% proline, and either abut 0.1% cysteine or about 1.0% cysteine, to create amino-acid-enriched broth mixtures. The amino-acid-enriched broth mixtures were further cooled to about 38° C. to create cooled broth mixtures. Next, Pediococcus acidilactici and P. pentosaceus at the level of about 1×10⁷ cfu/gram were added to the cooled broth mixtures to create inoculated broths. The inoculated broths were incubated at about 35° C. for about 48 hours. After incubation was complete, the live bacterial cells in the incubated broth were recovered by centrifuging at about 2,600 g for about 15 minutes. Live bacterial cells recovered from centrifuging nine volumes of incubated broth were added into one volume of incubated broth to create a 0.1% cysteine-derived 10× live-bacteria concentrate and a 1% cysteine-derived 10× live-bacteria concentrate.

### Example 30

### Development of a 10× Non-Live-Bacteria Concentrate

Development of 10× non-live-bacteria concentrates is shown by Example 30.

The bacterial incubation broths were prepared according to the formulas found in Table 16.

TABLE 14
Bacterial Incubation Broth Formulas

| Ingredient | Amount (%) | Amount (%) |
|---|---|---|
| Chicken Broth | 95.8 | 94.9 |
| Dextrose | 2 | 2 |
| Tween ® 80* | 0.1 | 0.1 |
| Threonine | 1 | 1 |
| Proline | 0.5 | 0.5 |
| Serine | 0.5 | 0.5 |
| Cysteine HCl | 0.1 | 1 |
| Total | 100.00 | 100.00 |

*Tween 80 is also referred to as polysorbate 80.

First, chicken broths containing about 2% dextrose and about 0.1% Tween 80 were heated to about 88° C. to create pasteurized broth mixtures. When the pasteurized broth mixtures had cooled to about 79° C., amino acids were added in the following amounts, about 1% threonine, about 0.5% serine, about 0.5% proline, and either about 0.1% cysteine or about 1.0% cysteine, to create amino-acid-enriched broth mixtures. The amino-acid-enriched broth mixtures were further cooled to about 38° C. to create cooled broth mixtures. Next, Pediococcus acidilactici and P. pentosaceus at the level of 1×10⁷ cfu/gram were added to the cooled broth mixtures to create inoculated broths. The inoculated broths were incubated at about 35° C. for about 48 hours. After incubation was complete, the live bacterial cells in the incubated broths were recovered by centrifuging at about 2,600 g for about 15 minutes. Live bacterial cells recovered from centrifuging approximately 9 volumes of incubated broths were added into one volume of incubated broth to create 10× live-bacteria concentrates. The 10× live-bacteria concentrates were then heated to about 85° C. for about 5 minutes to kill the live bacteria, which then resulted in a 0.1% cysteine-derived 10× non-live-bacteria concentrate and a 1% cysteine-derived 10× non-live-bacteria concentrate.

### Example 31

### Impact of 10× Live-Bacteria Concentrates and 10× Non-Live-Bacteria Concentrates on Kill of Salmonella Surrogates on a Stainless Steel Surface

The effects of 10× live-bacteria concentrates and 10× non-live-bacteria concentrates on killing Salmonella surrogates on the surface of stainless steel are shown by Example 31.

E. coli strains ATCC BAA 1427, 1428, 1429, 1430 and 1431 served as the Salmonella surrogate organisms for this experiment. E. coli was added into a solution of BPBD that resulted in about 1×10⁷ cfu/gram to create the Salmonella surrogate source.

The sources of the 10× live-bacteria concentrates and the 10× non-live-bacteria concentrates were prepared as described in Examples 29 and 30, respectively.

About 300 μL of Salmonella surrogates were added to about 1 cm² of a stainless steel surface to create an inoculated stainless steel surface. Next, about 300 μL of either the 10× live-bacteria concentrates or the 10× non-live-bacteria concentrates were added to the inoculated stainless steel surface to create a treated stainless steel surface. To obtain a sample of the stainless steel surface, a sterile cotton-tipped swab pre-saturated with BPBD was used to sample the treated stainless steel surface. After sampling, the cotton-tipped swab was then placed into a sterile tube containing about 2 mL of BPBD and shaken vigorously to create a sample tube. Samples of the contents of the sample tube were then assessed for E. coli levels by pour plating in violet red bile glucose agar at various dilutions and incubating for about 24 hours at about 35° C.

Results are shown in Table 15. All 10× live-bacteria concentrates and 10× non-live-bacteria concentrates completely killed all Salmonella surrogates, i.e., E. coli.

TABLE 15
Impact of 10X Live-Bacteria Concentrates and 10X Non-Live-Bacteria
Concentrates on Killing E. coli on Stainless Steel

| 0.1% Cysteine- | 1% Cysteine- | 0.1% Cysteine- | 1% Cysteine- |
|---|---|---|---|
| Derived 10X | Derived 10X | Derived 10X | Derived 10X |
| Live-Bacteria | Live-Bacteria | Non-Live-Bacteria | Non-Live-Bacteria |
| Concentrate | Concentrate | Concentrate | Concentrate |
| Complete kill of | Complete kill of | Complete kill of | Complete kill of |
| 1 × 10⁷ cfu/gram | 1 × 10⁷ cfu/gram | 1 × 10⁷ cfu/gram | 1 × 10⁷ cfu/gram |

### Example 32

### Impact of 10× Live-Bacteria Concentrates and 10× Non-Live-Bacteria Concentrates on Kill of Salmonella Surrogates on a Concrete Surface

The effects of 10× live-bacteria concentrates and 10× non-live-bacteria concentrates on killing Salmonella surrogates on the surface of concrete are shown by Example 32.

E. coli strains ATCC BAA 1427, 1428, 1429, 1430, and 1431 served as the Salmonella surrogate organisms for this experiment. E. coli was added into a solution of BPBD that resulted in about 1×10⁷ cfu/gram to create the Salmonella surrogate source.

The sources of 10× live-bacteria concentrates and 10× non-live-bacteria concentrates were prepared as described in Examples 29 and 30, respectively.

About 300 μL of Salmonella surrogates were added to about 1 cm² of a stainless steel surface to create an inoculated concrete surface. Next, about 300 μL of either 10× live-bacteria concentrates or 10× non-live-bacteria concentrates were added to the inoculated concrete surface to create a treated concrete surface. To obtain a sample of the concrete surface, a sterile cotton-tipped swab pre-saturated with BPBD was used to sample the treated concrete surface. After sampling, the cotton-tipped swab was then placed into a sterile tube containing about 2 mL of BPBD and shaken vigorously to create a sample tube. Samples of the contents of the sample tube were then assessed for E. coli levels by pour plating in violet red bile glucose agar at various dilutions and incubating for about 24 hours at about 35° C.

Results are shown in Table 16. All 10× live-bacteria concentrates and 10× non-live-bacteria concentrates completely killed all Salmonella surrogates, i.e., E. coli.

TABLE 16
Impact of 10X Live-Bacteria Concentrates and 10X Non-Live-
Bacteria Concentrates on Killing E. coli on Concrete

| 0.1% Cysteine- | 1% Cysteine- | 0.1% Cysteine- | 1% Cysteine- |
|---|---|---|---|
| Derived 10X | Derived 10X | Derived 10X | Derived 10X |
| Live-Bacteria | Live-Bacteria | Non-Live-Bacteria | Non-Live-Bacteria |
| Concentrate | Concentrate | Concentrate | Concentrate |
| Complete kill of | Complete kill of | Complete kill of | Complete kill of |
| 1 × 10⁷ cfu/gram | 1 × 10⁷ cfu/gram | 1 × 10⁷ cfu/gram | 1 × 10⁷ cfu/gram |

### Example 33

### Impact of 10× Live-Bacteria Concentrate and 10× Non-Live-Bacteria Concentrate on Kill of Salmonella Surrogates on Pet Food Fine Particles

The effects of 10× live-bacteria concentrates and 10× non-live-bacteria concentrates on killing Salmonella surrogates on the surface of pet food fine particles are shown by Example 33.

E. coli strains ATCC BAA 1427, 1428, 1429, 1430, and 1431 served as the Salmonella surrogate organisms for this experiment. E. coli was added into a solution of BPBD that resulted in about 1×10⁷ cfu/gram to create the Salmonella surrogate source.

The sources of 10× live-bacteria concentrates and 10× non-live-bacteria concentrates were prepared as described in Examples 29 and 30, respectively.

The source of pet food fine particles was obtained by grinding about 1 gram of pet food kibbles through a spice grinder for about 2 minutes.

About 300 μL of Salmonella surrogates were added to about 1 gram of pet food fine particles to create inoculated pet food fines. Next, about 300 μL of either 10× live-bacteria concentrates or 10× non-live-bacteria concentrates were added to the inoculated pet food fines to create treated pet food fines. The treated pet food fines were then incubated for about 24 hours at about 35° C. to produce incubated pet food fines. Samples of the incubated pet food fines were then assessed for E. coli levels by pour plating in violet red bile glucose agar plates at various dilutions and incubating for about 24 hours at about 35° C.

Results are shown in Table 17. All 10× live-bacteria concentrates and 10× non-live-bacteria concentrates completely killed all Salmonella surrogates, i.e., E. coli.

TABLE 17
Impact of 10X Live-Bacteria Concentrates and 10X Non-Live-Bacteria
Concentrates on Killing E. coli on Pet Food Fine Particles

| 0.1% Cysteine- | 1% Cysteine- | 0.1% Cysteine- | 1% Cysteine- |
|---|---|---|---|
| Derived 10X | Derived 10X | Derived 10X | Derived 10X |
| Live-Bacteria | Live-Bacteria | Non-Live-Bacteria | Non-Live-Bacteria |
| Concentrate | Concentrate | Concentrate | Concentrate |
| Complete kill of | Complete kill of | Complete kill of | Complete kill of |
| 3 × 10⁷ cfu/gram | 3 × 10⁷ cfu/gram | 3 × 10⁷ cfu/gram | 3 × 10⁷ cfu/gram |

Examples 34 and 35 indicate the ability of both live-bacteria concentrates and non-live-bacteria concentrates to kill pathogens in ground meat.

### Example 34

### Development of a 20× Live-Bacteria Concentrate

Development of a 20× live-bacteria concentrate is shown by Example 34.

A bacterial incubation broth was prepared according the formula found in Table 18.

TABLE 18
Bacterial Incubation Broth Formula

| Ingredient | Amount (%) |
|---|---|
| Chicken Broth | 96.7 |
| Dextrose | 1 |
| Tween ® 80* | 0.1 |
| Glycerine | 1 |
| Threonine | 0.1 |
| Proline | 0.05 |
| Serine | 0.05 |
| Cysteine HCl | 1 |
| Total | 100.00 |

*Tween 80 is also referred to as polysorbate 80.

First, a chicken broth mixture containing about 1% dextrose, about 0.1% Tween 80, and about 1% glycerine, was pasteurized to about 88° C. to create a pasteurized broth mixture. When the pasteurized broth mixture had cooled to about 77° C., amino acids were added at levels of about 0.1% threonine, about 0.05% serine, about 0.05% proline, and about 1.0% cysteine, to create an amino-acid-enriched broth mixture. The amino-acid-enriched broth mixture was further cooled to about 38° C. to create a cooled broth mixture. Next, Pediococcus acidilactici and Pediococcus pentosaceus at the level of about 1×10⁷ cfu/gram were added to the cooled broth mixture to create an inoculated broth. The inoculated broth was incubated at about 35° C. for about 48 hours. After incubation was complete, the live bacterial cells in the incubated broths were recovered by centrifuging at about 2,600 g for about 15 minutes. Live bacterial cells recovered from centrifuging about 19 volumes of incubated broths were added into 1 volume of incubated broth to create a 20× live-bacteria concentrate. The 20× live-bacteria concentrate was then placed in sealed glass containers that were stored at about 4° C. until further use.

### Example 35

### Impact of a 20× Non-Live-Bacteria Concentrate on Kill of Salmonella Surrogates in Ground Turkey Meat

A 20× non-live-bacteria concentrate evaluated for its effect on killing Salmonella surrogates in ground turkey meat is shown by Example 35.

The 20× non-live-bacteria concentrate source was prepared as described in Example 34.

E. coli strains ATCC BAA 1427, 1428, 1429, 1430, and 1431 served as the Salmonella surrogate organisms for this experiment. E. coli were added into a solution of BPBD that resulted in about 1×10⁷ cfu/gram to create the Salmonella surrogate source.

Ground turkey meat served as the growth medium for evaluating the kill of Salmonella surrogates by the 20× live-bacteria concentrate source. Two processes of treating the turkey meat with the 20× live-bacteria concentrate were evaluated.

The first process of treating the ground turkey meat was done in the following manner. First, about 0.1 mL of the 20× live-bacteria concentrate was added to about 100 grams of ground turkey meat to create a pre-treated ground turkey meat mixture. Next, the pre-treated ground turkey meat mixture was cooked at about 100° C. for about 5 minutes to create a cooked pre-treated meat. The cooked pre-treated meat was then cooled to about 35° C. to create a cooled pre-treated meat. The cooled pre-treated meat was then inoculated with about 1×10⁵ cfu of the above Salmonella surrogate source to create an inoculated cooled pre-treated meat. The inoculated cooled pre-treated meat was then stored at about 4° C. for about 96 hours to create an incubated pre-treated meat. After about 96 hours, the incubated pre-treated meat was evaluated for the amount of E. coli remaining by plating onto Violet Red Bile Glucose agar.

The second process of treating the ground turkey meat was done in the following manner. First, ground turkey meat mixture was cooked to about 100° C. for about 5 minutes to create a cooked meat. Next, the cooked meat was cooled to about 35° C. to create a cooled cooked meat. Next, about 0.1 mL of the 20× live-bacteria concentrate was added to about 100 grams of cooled cooked meat to create a post-treated cooked meat. The post-treated cooked meat was then inoculated with about 1×10⁵ cfu of the above Salmonella surrogate source to create an inoculated post-treated cooked meat. The inoculated post-treated cooked meat was then stored at about 4° C. for about 96 hours to create an incubated post-treated meat. After about 96 hours, the incubated post-treated meat was evaluated for the amount of E. coli remaining by plating onto Violet Red Bile Glucose agar.

A corresponding control involved cooking ground turkey meat and inoculating with E. coli as described above, but without the inclusion of the 20× live-bacteria concentrate source.

Results are shown in Table 19. Because the 20× live-bacteria concentrate was applied prior to cooking in the first process, the Pediococci bacteria contained within it were rendered dead, which resulted in treatment using a non-live-bacteria preparation having dead bacteria. Results indicate that over one log of E. coli was killed using the first process compared to the control. In the second process, the 20× live-bacteria treatment was considered to contain live bacteria, as there was no killing process involved. In the case of the second process, again, over one log of E. coli was killed. In both cases, temperature conditions were not favorable for fermentation to occur. In sum, a non-live-bacteria concentrate or a 20× live-bacteria concentrate were both effective under non-fermenting conditions at killing E. coli by over one log within a about a 96-hour storage period at about 4° C.

TABLE 19
Impact of 20X Non-Live-Bacteria Concentrate
on E. coli Levels in Ground Turkey Meat

| | Control: | | |
|---|---|---|---|
| | Turkey Meat | | |
| | Inoculated | First Process: | Second Process: |
| | with E. coli, | Incubated Pre- | Incubated Post- |
| | No Treatment | Treated Meat | Treated Meat |
| E. coli log₁₀ cfu/ | 5.55 | 4.48 | 4.43 |
| gram after storage | | | |
| at 4° C. for 96 h | | | |

In Examples 36, 37, and 38, the impacts of acid and heat treatment on a non-live-bacteria concentrate to effectively kill Salmonella surrogates (i.e., E. coli) were evaluated. Results indicated that the non-live-bacteria concentrate was still effective at killing Salmonella surrogates (i.e., E. coli), even though it was exposed to a large amount of pyrophosphates. Results further indicated that even boiling a non-live-bacteria concentrate for about 5 minutes did not remove its ability to kill Salmonella surrogates (i.e., E. coli).

### Example 36

### Development of a 16× Non-Live-Bacteria Concentrate

Development of a 16× non-live-bacteria concentrate is shown by Example 36.

A bacterial incubation broth was prepared according the formula found in Table 20.

TABLE 20
Bacterial Incubation Broth Formula

| Ingredient | Amount (%) |
|---|---|
| Chicken Broth | To 100 |
| Dextrose | 2 |
| Tween ® 80* | 0.1 |
| Threonine | 0.1 |
| Proline | 0.05 |
| Serine | 0.05 |
| Cysteine HCl | 0.1 |

*Tween 80 is also referred to as polysorbate 80.

First, a chicken broth mixture with about 2% dextrose and about 0.1% Tween 80 was pasteurized to about 88° C. to create a pasteurized broth mixture. When the pasteurized broth mixture had cooled to about 77° C., amino acids were added at a level of about 0.1% threonine, about 0.05% serine, about 0.05% proline, and about 0.1% cysteine, to create an amino-acid-enriched broth mixture. The amino-acid-enriched broth mixture was further cooled to about 38° C. to create a cooled broth mixture. Next, Pediococcus acidilactici and Pediococcus pentosaceus at the level of about 1×10⁷ cfu/gram were added to the cooled broth mixture to create an inoculated broth. The inoculated broth was incubated at about 35° C. for about 48 hours to create a fermentate. After incubation was complete, about 200 mL of ethanol (75.5%) were added to about 400 mL of fermentate to create an ethanol/fermentate mixture. The ethanol/fermentate mixture was dried by heating at about 45° C. for about 120 hours to create a dried mixture. Upon completion of drying, the dried mixture was then solubilized in about 25 mL of ethanol (75.5%) to create a 16× non-live-bacteria concentrate.

### Example 37

### Impact of a 16× Non-Live-Bacteria Concentrate Enriched with Dry Palatant on Killing Topical Salmonella Surrogates on Kibbles

Impact of a dry palatant enriched with a 16× non-live-bacteria concentrate on killing Salmonella surrogates is shown by Example 37.

The formula for creating a dry palatant is shown in Table 21.

TABLE 21
Formula for Dry Palatant

| Ingredient | % of Formula |
|---|---|
| Sodium Acid Pyrophosphate | 33.33 |
| Maltodextrin | 33.33 |
| Brewers Yeast | 33.33 |

Upon adding the ingredients for the dry palatant together, they were mixed by shaking in a sealed container. This formula and process created an untreated palatant.

Next, about 1.5 mL of the 16× non-live-bacteria concentrate created in Example 36 were added to about 100 grams of untreated palatant and then dried for about 24 hours at about 45° C. to create an enriched palatant.

E. coli served as the source of Salmonella surrogates. Cat food kibbles were inoculated with E. coli (ATCC BAA 1427, 1428, 1429, 1430 and 1431) at the level of about 1×10⁷ cfu/gram to create inoculated kibbles. Inoculated kibbles were then coated with about 5 grams of chicken fat to create inoculated fat coated kibbles. About 1.5 grams of either untreated or enriched palatant were coated onto about 100 grams of inoculated fat coated kibbles to create either untreated kibbles or enriched kibbles.

Untreated and enriched kibbles were then incubated at about 22° C. for about 0, 1, 24, 48, 72, 96, 168, and 366 hours. After the appropriate incubation lengths, the levels of remaining E. coli on the kibbles were determined by plating onto Violet Red Bile Glucose agar and counted after about 24 hours of incubation at about 35° C.

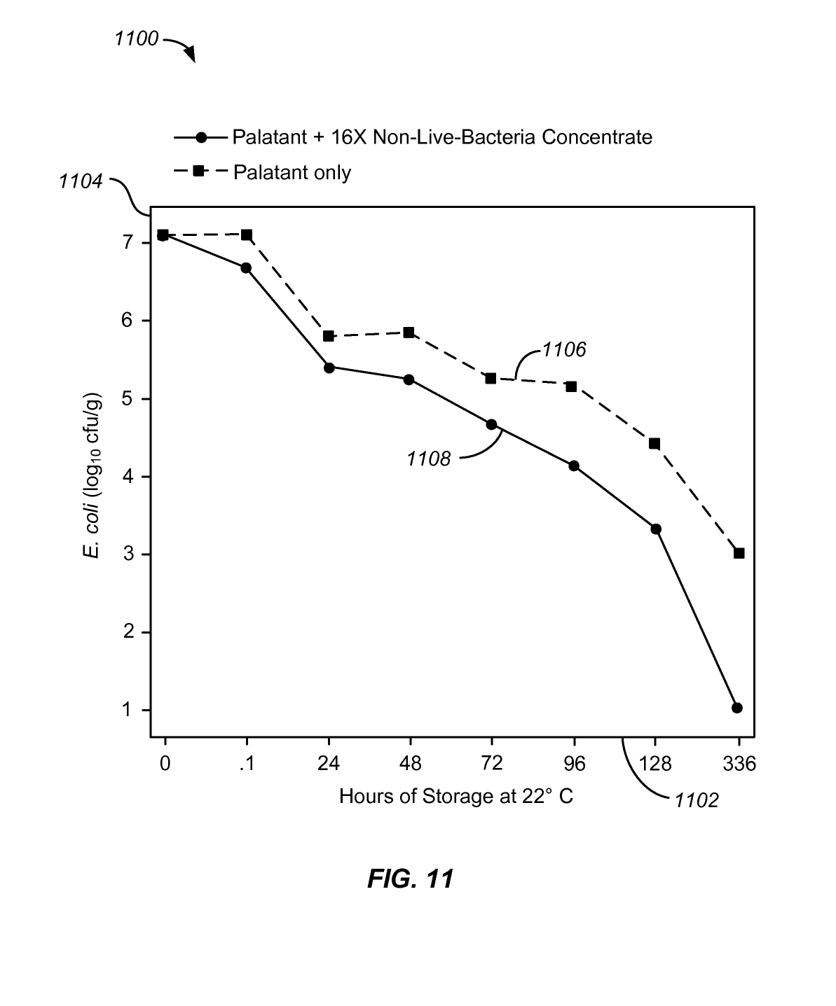

Results are shown in FIG. 11. To this end, FIG. 11 is a line graph 1100 showing E. coli death, over time, on cat food kibbles enriched with 16× non-live-bacteria concentrates. An x-axis 1102 shows days of storage at about 22° C. A y-axis 1104 shows E. coli death expressed in units of log₁₀ cfu/gram. A line 1106 shows E. coli death, over time, of cat food kibbles treated with palatant only. A line 1108 shows E. coli death, over time, of cat food kibbles treated with a combined palatant and 16× non-live-bacteria concentrate.

Results indicate a steady decline in E. coli levels during about 336 hours of incubation in both untreated and treated kibbles. However, a more rapid decline and greater extent of E. coli death occurred in the enriched kibbles is evident within about 1 hour of incubation and by about 336 hours, E. coli death is about two logs more than on untreated kibbles.

### Example 38

### Impact of Heating on the Efficacy of Killing Pathogens by a 16× Non-Live-Bacteria Concentrate

The impact of heating a 16× non-live-bacteria concentrate on its ability to kill Salmonella surrogates (i.e., E. coli) was evaluated in Example 38.

The source of 16× non-live-bacteria concentrate was prepared as described in Example 49.

A portion of the 16× non-live-bacteria concentrate was boiled for about 5 minutes to create a heated 16× non-live-bacteria concentrate. The non-heated non-live-bacteria concentrate was the 16× non-live-bacteria concentrate described in Example 36. The heated and non-heated non-live-bacteria concentrates each contained about 57.6 mg of solids per approximately 100 μL concentrate.

E. coli strains ATCC BAA 1427, 1428, 1429, 1430, and 1431 served as the Salmonella surrogate organisms for this experiment. E. coli were added into a solution of BPBD that resulted in about 1×10⁷ cfu/gram to create the Salmonella surrogate source.

A microtiter well experiment was conducted to evaluate the efficacy of the non-heated non-live-bacteria concentrate and heated non-live-bacteria concentrate added into ethanol along with E. coli that served as surrogates for the Salmonella pathogen. About 100 μL of the concentrate source were added into well 1. About 100 μL ethanol were added into microtiter wells 2 through 12. Next, about 100 μL of the non-live-bacteria concentrate source were added to well 2. Starting with well 2, 1:2 serial dilutions were made for every subsequent well. The result was that wells 1 through 12 had the following approximate serial dilutions, by volume, of inoculum: 1:1, 1:2, 1:4, 1:8, 1:16, 1:32, 1:64, 1:128, 1:256, 1:512, 1:1024, and 1:2048. Microtiter plates were then placed at about 45° C. for about 4 hours to evaporate off ethanol. Next, about 100 μL of the Salmonella surrogate source were added to wells 1 through 12. A control well was also made that contained about 100 μL of the Salmonella surrogate source. Microtiter plates were then incubated at about 35° C. for about 48 hours. Upon completion of incubation, about 100 μL of iodonitrotetrazolium color reagent were added to each well. Microtiter plates were then placed into an approximately 35° C. environment for about 2 to 4 hours to enable the color change to occur. In each microtiter well, a yellow or amber color indicated no E. coli growth (<100,000 cfu per well), a pink color indicated about 100,000 cfu of E. coli per well, a red color indicated about 1,000,000 cfu of E. coli per well, and a deep red color indicated >1,000,000 cfu of E. coli per well.

Results are shown in Table 22. Results indicate that both the heated as well as the non-heated non-live-bacteria concentrates kill Salmonella surrogates at the lowest dilutions. Increasing dilutions result in reduced killing of Salmonella surrogates.

TABLE 22
Impact of Heating of Non-Live-Bacteria Concentrate on Its
Ability to Kill of Salmonella Surrogates (E. coli)

| | | Solids per well | Non-Heated | Heated |
|---|---|---|---|---|
| Well | Dilution | (mg) | Concentrate | Concentrate |
| 1 | 1:1 | 57.6 | − | − |
| 2 | 1:2 | 28.8 | − | − |
| 3 | 1:4 | 14.4 | − | − |
| 4 | 1:8 | 7.2 | −1 | −1 |
| 5 | 1:16 | 3.6 | −1 | −1 |
| 6 | 1:32 | 1.8 | −1 | −1 |
| 7 | 1:64 | 0.9 | −1 | −1 |
| 8 | 1:128 | 0.45 | + | + |
| 9 | 1:256 | 0.225 | + | + |
| 10 | 1:512 | 0.1125 | + | + |
| 11 | 1:1024 | 0.0556 | + | + |
| 12 | 1:2048 | 0.0281 | + | + |
| Control | None | 0 | ++ | ++ |

− = No growth of E. coil (<100,000 cfu/well)
−1 = 100,000 cfu of E. coli per well
+ = 1,000,000 cfu of E. coli per well
++ = >1,000,000 cfu of E. coli per well

### Example 39

### Impact of Incubation Temperature on Killing Salmonella Surrogates

The impact of incubation temperature on killing Salmonella surrogates by a 16× non-live-bacteria concentrate is shown in Example 39.

In Example 39, the impact of temperature on a non-live-bacteria concentrate killing E. coli is demonstrated. Increasing incubation temperature increases killing power of the non-live concentrate. In addition, a non-live concentrate is effective at killing E. coli a low temperatures (about 10° C.) as well.

The source of 16× non-live-bacteria concentrate was prepared as described in Example 36.

The source of Salmonella surrogates, i.e., E. coli, was prepared as described in Example 38.

Four replicate sets of microtiter plates were made according the methods described in Example 38. One replicate microtiter plate was placed for about 48 hours in each of the following approximate temperatures: 10°, 25°, 35°, and 45° C. Upon completion of incubation, plates were removed from the incubator. About 100 μL of iodonitrotetrazolium violet reagent were added to each well. Microtiter plates were then placed into an approximately 35° C. environment for about 2 to 4 hours to enable the color change to occur. In each microtiter well, a yellow or amber color indicated no growth of E. coli (<100,000 cfu/well), a pink color indicated possible survival of <1,000,000 cfu of E. coli per well, a red color indicated definite survival of 1,000,000 cfu of E. coli per well, and a deep red color indicated complete survival of 1×10⁷ cfu of E. coli per well.

The 16× non-live-bacteria concentrate's minimal killing concentration of the Salmonella surrogates was considered evident at the lowest dilution in which a pink color was observed. The 16× non-live-bacteria concentrate's minimal killing concentration of Salmonella surrogates was considered evident at the lowest dilution, in which a red color was observed.

Results are shown in Table 23. Results support several conclusions. First, increasing incubation temperatures results in achieving the same amount of inhibition or kill using lower concentrations of the 16× non-live-bacteria concentrate. Second, the amount of 16× non-live-bacteria concentrate needed to achieve the minimal inhibitory concentration or minimal killing concentration of Salmonella surrogates was only marginally reduced after temperatures were about 25° C. or higher. Third, even the lowest temperature, about 10° C., resulted in growth inhibition and killing of the Salmonella surrogates.

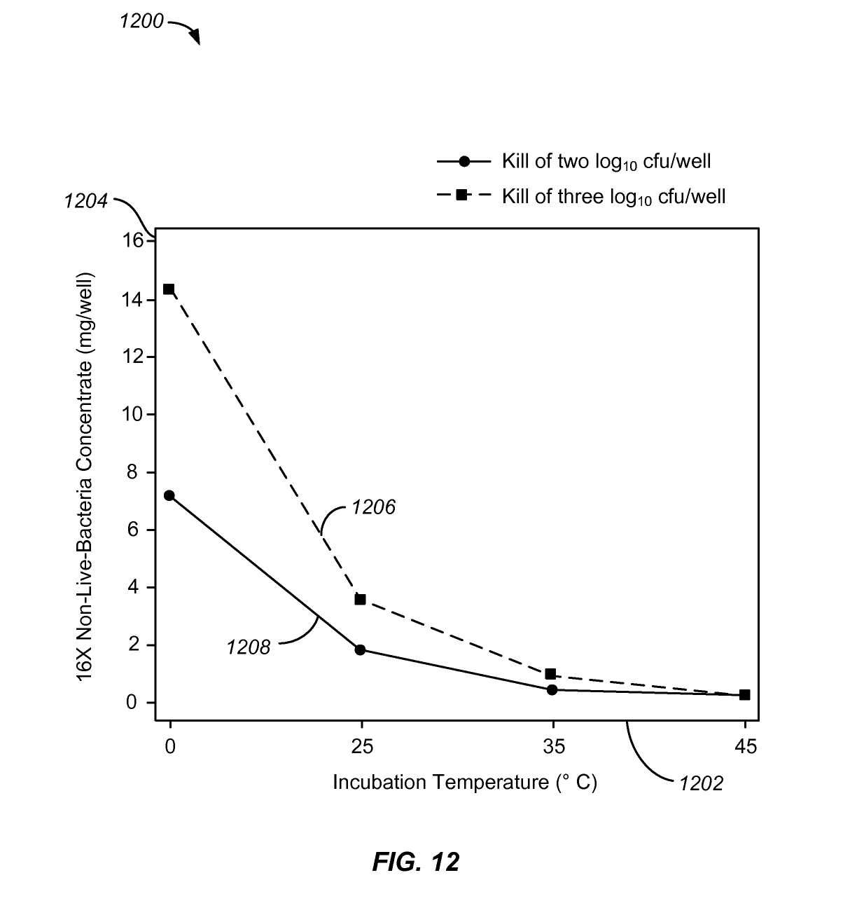

Further results are shown in FIG. 12. To this end, FIG. 12 is a line graph 1200 showing amount of a 16× non-live-bacteria concentrate necessary to achieve pathogen kill during a 48-hour incubation at various temperatures. An x-axis 1202 shows incubation temperature (° C.). A y-axis 1204 shows amount (mg/well) of a 16× non-live-bacteria concentrate. A line 1206 shows an amount of a 16× non-live-bacteria concentrate necessary to achieve two logs of surrogate death at various temperatures. A line 1208 shows an amount of 16× non-live-bacteria concentrate necessary to achieve three logs of surrogate death at various temperatures.

Results in FIG. 12 indicate that greater killing power of a 16× non-live bacteria concentrate occurs at relatively higher temperatures. Further, the amount of 16× non-live bacteria concentrate needed to achieve minimal killing was only marginally reduced once the incubation temperature was about 25° C. or higher. Even the lowest temperature, about 10° C., resulted in inhibition and killing of Salmonella surrogates.

In Examples 40 and 41, the impact of different lactic acid bacteria sources on killing E. coli is demonstrated. Results indicate differing effects on killing power depending on the source of the lactic acid bacteria. Blends of lactic acid bacteria can also be effective at killing E. coli.

### Example 40

### Creation of Non-Live-Bacteria Concentrate Sources

The creation of three sources of non-live-bacteria concentrates is represented in Example 41.

The bacterial sources comprised one of the following three: (1) a mixture of Pediococcus acidilactici and Pediococcus pentosaceus, (2) Lactobacillus acidophilis alone, or (3) equal amounts of a mixture of (1) and (2).

A bacterial incubation broth was prepared according the formula found in Table 23.

TABLE 23
Bacterial Incubation Broth Formula

| Ingredient | Amount (%) |
|---|---|
| Chicken Broth | To 100 |
| Dextrose | 2 |
| Tween ® 80* | 0.1 |
| Threonine | 0.1 |
| Proline | 0.05 |
| Serine | 0.05 |
| Cysteine HCl | 0.1 |

*Tween 80 is also referred to as polysorbate 80.

First, a chicken broth mixture containing about 2% dextrose and about 0.1% Tween 80 was boiled to create a sterilized broth mixture. When the sterilized broth mixture had cooled to about 82° C., amino acids were added at the levels of about 0.1% threonine, about 0.05% serine, about 0.05% proline, and about 0.1% cysteine, to create an amino-acid-enriched broth mixture. The amino-acid-enriched broth mixture was further cooled to about 52° C. to create a cooled broth mixture. Next, one of the three previously mentioned bacterial sources were added at a level of about 1×10⁷ cfu/gram to the cooled broth mixture to create an inoculated broth. The inoculated broth was incubated at about 35° C. for about 48 hours to create a fermentate. After incubation was complete, about 100 mL of ethanol (75.5%) were added to about 200 mL of fermentate to create an ethanol/fermentate mixture. The ethanol/fermentate mixture was dried by placing in an environment at about 45° C. for about 120 hours until about 50 mL of concentrate remained to create three non-live-bacteria concentrate sources: Pediococci non-live-bacteria concentrate, Lactobacillus non-live-bacteria concentrate, and Pediococci/Lactobacillus blend non-live-bacteria concentrate. The solids of the non-live-bacteria concentrates consisted of about 220 μg per 1 mL of concentrate.

### Example 41

### Impact of Bacteria Source on Killing of Salmonella Surrogates

The impacts of Pediococci spp., Lactobacillus spp., or a combination of both, on killing Salmonella surrogates, were evaluated in Example 41.

The sources of Pediococci non-live-bacteria concentrate, Lactobacillus non-live-bacteria concentrate, and Pediococci/Lactobacillus blend non-live-bacteria concentrate, were prepared as described in Example 40.

E. coli strains ATCC BAA 1427, 1428, 1429, 1430, and 1431 served as the Salmonella surrogate organisms for this experiment. E. coli were added into a solution of BPBD that resulted in about 1×10⁷ cfu/gram to create the Salmonella surrogate source.

A microtiter well experiment was conducted to evaluate the ability of the bacterial source of the non-live-bacteria concentrate to kill E. coli, which served as surrogates for the Salmonella pathogen. About 100 μL of the non-live-bacteria concentrate source were added into wells 1 and 2. About 100 μL ethanol were added into microtiter wells 2 through 12. Starting with well 2, 1:2 serial dilutions were made for every subsequent well. The result was that wells 1 through 12 had the following serial dilutions, by volume, of inoculum: 1:1, 1:2, 1:4, 1:8, 1:16, 1:32, 1:64, 1:128, 1:256, 1:512, 1:1024, and 1:2048. Microtiter plates were then placed in about 45° C. for about 4 hours to evaporate off ethanol. Next, about 100 μL of the Salmonella surrogate source were added to wells 1 through 12. A control well was also made that contained about 100 μL of the Salmonella surrogate source. Microtiter plates were then incubated at about 35° C. for about 48 hours. Upon completion of incubation, about 100 μL of iodonitrotetrazolium color reagent was added to each well. Microtiter plates were then placed into an approximately 35° C. environment for about 2 to 4 hours to enable the color change to occur. In each microtiter well, a yellow or amber color indicated no survival of E. coli, a pink color indicated possible survival of <1,000,000 cfu of E. coli per well, a red color indicated definite survival of 1,000,000 cfu of E. coli per well, and a deep red color indicated complete survival of E. coli per well.

Results are shown in Table 24. Results indicate that all non-live-bacteria concentrates, regardless of bacterial source, killed Salmonella surrogates. Pediococci derived non-live-bacteria concentrate killed Salmonella at the lowest concentration, while Lactobacillus derived non-live-bacteria concentrates required the highest concentration to kill Salmonella surrogates. The non-live-bacteria concentrate source derived from a blend of Pediococci and Lactobacillus bacteria required a moderate concentration to kill the Salmonella surrogates.

TABLE 24
Impact of Heating of Non-Live-Bacteria Concentrate
on Their Abilities to Kill Salmonella Surrogates

| | | | | | Pediococci/ |
|---|---|---|---|---|---|
| | | | Pedioccoci | Lactobacillus | Lactobacillus Blend |
| | | Solids per | Non-Live-Bacteria | Non-Live-Bacteria | Non-Live-Bacteria |
| Well | Dilution | well (mg) | Concentrate | Concentrate | Concentrate |
| 1 | 1:1 | 22 | − | − | − |
| 2 | 1:2 | 11 | − | − | − |
| 3 | 1:4 | 5.5 | − | − | − |
| 4 | 1:8 | 2.75 | − | − | − |
| 5 | 1:16 | 1.38 | − | − | − |
| 6 | 1:32 | 0.69 | − | −1 | − |
| 7 | 1:64 | 0.34 | − | −1 | −1 |
| 8 | 1:128 | 0.17 | −1 | + | + |
| 9 | 1:256 | 0.08 | + | + | + |
| 10 | 1:512 | 0.04 | + | + | + |
| 11 | 1:1024 | 0.02 | + | + | + |
| 12 | 1:2048 | 0.01 | + | + | + |
| Control | None | 0 | ++ | ++ | ++ |

− = No growth of E. coil (<100,000 cfu/well)
−1 = possible survival of <1,000,000 cfu of E. coli per well
+ = definite survival of 1,000,000 cfu of E. coli per well
++ = complete survival of 10,000,000 cfu of E. coli per well

Although illustrative embodiments of the present teachings have been shown and described, other modifications, changes, and substitutions are intended. Accordingly, it is appropriate that the appended claims be construed broadly and in a manner consistent with the scope of the disclosure, as set forth in the following claims.

1. A process for producing a safe and preserved food, said process comprising:
introducing a non-live-bacteria preparation on and/or in a food to produce an activated food, and said non-live-bacteria preparation results from fermentation of fermented bacteria, but said non-live-bacteria preparation is substantially depleted of said fermented bacteria, and said fermented bacteria are bacteria that are living;
incubating said activated food in presence of said non-live-bacteria preparation to kill and/or inhibit growth of pathogens and/or spoilage microorganisms on and/or in said activated food and thereby producing said safe and preserved food; and
wherein said fermented bacteria is anti-pathogen bacteria and/or anti-spoilage bacteria.

2. The process of claim 1, wherein
in said introducing, said non-live-bacteria preparation includes one or more solid byproducts resulting from said fermentation of said fermented bacteria; and
in said incubating, presence of one or more of said solid byproducts kills and/or inhibits growth of pathogens and/or spoilage microorganisms on and/or in said food.

3. The process of claim 2, wherein said solid byproducts include said fermented bacteria, but said fermented bacteria are bacteria that are dead.

4. The process of claim 2, wherein said fermented bacteria is substantially depleted from said non-live-bacteria preparation.

5. The process of claim 1, wherein said incubating is carried out at treatment conditions that are at least one member selected from a group comprising a temperature greater than about 2° C. for a time that is at least about 24 hours, a temperature greater than about 10° C. for a time that is at least about 12 hours, and a temperature greater than about 18° C. for time that is at least about 5 minutes.

6. The process of claim 1, further comprising packaging said safe and preserved food.

7. A process for producing a non-live-bacteria preparation, said process comprising:
obtaining a fermentate that includes a growth medium and one or more solid byproducts, wherein one or more of said solid byproducts include bacteria in a fermented and/or a fermenting state and fermentation byproducts produced by said bacteria;
deactivating said bacteria to produce said non-live-bacteria preparation; and
wherein said bacteria is anti-pathogen bacteria and/or anti-spoilage bacteria.

8. The process of claim 7, wherein said deactivating includes killing said bacteria, and wherein said non-live-bacteria preparation composition includes said bacteria that are dead and one or more of said solid byproducts.

9. The process of claim 7, wherein said deactivating includes separating said bacteria from said growth medium and said solid byproducts to produce separated bacteria and said non-live-bacteria preparation, and wherein said non-live-bacteria preparation includes one or more of said solid byproducts that are substantially depleted of said bacteria.

10. The process of claim 7, wherein said obtaining said fermentate includes obtaining a fermentate that has a cysteine concentration in said fermentate of between about 0.8% and about 1.2%.

11. The process of claim 7, wherein said obtaining said fermentate includes fermenting an incubate that has a cysteine concentration in said fermentate of between about 0.8% and about 1.2%.

12. The process of claim 7, further comprising concentrating said fermentate prior to said deactivating.

13. The process of claim 7, further comprising concentrating said non-live-bacteria preparation composition to produce a non-live-bacteria concentrate.

14. The process of claim 12, further comprising adding alcohol to said non-live-bacteria preparation prior to said concentrating.

15. The process of claim 14, wherein said alcohol is selected from at least one member selected from a group comprising ethanol, isopropyl alcohol, and methanol.

16. The process of claim 9, further comprising:
rehydrating said separated bacteria to produce a rehydrated bacteria mixture that includes rehydrated bacteria; and
deactivating said rehydrated bacteria in said rehydrated bacteria mixture to produce another non-live-bacteria preparation.

17. The process of claim 16, wherein said deactivating includes separating said rehydrated bacteria from said rehydrated bacteria mixture to produce separated rehydrated bacteria and another non-live-bacteria preparation.

18. The process of claim 16, wherein said deactivating includes killing said rehydrated bacteria to produce another non-live-bacteria preparation.

19. An activated food composition comprising:
a food;
an effective amount of a non-live-bacteria preparation present on and/or in said food, and wherein said non-live-bacteria preparation includes one or more solid byproducts resulting from fermentation of fermented bacteria, but said non-live-bacteria preparation is substantially depleted of said fermented bacteria, and said fermented bacteria is an anti-pathogen and/or anti-spoilage bacteria that is living; and
wherein said effective amount of said non-live-bacteria preparation is sufficient to kill and/or inhibit the growth of pathogens and/or spoilage-microorganisms upon incubation of said activated food composition.

20. The activated food composition of claim 19, wherein one or more of said solid byproducts are present in a concentration that is between about 0.00002%, by weight, of said activated food composition, and about 2%, by weight, of said activated food composition.

21. The activated food composition of claim 19, wherein said solid byproducts are present in a concentration that is between about 0.0002%, by weight, of said activated food composition, and about 1.8%, by weight, of said activated food composition.

22. The activated food composition of claim 19, wherein said non-live-bacteria preparation is substantially depleted of said fermented bacteria.

23. The activated food composition of claim 19, wherein said solid byproducts include said fermented bacteria, but said fermented bacteria are bacteria that are dead.

24. The activated food composition of claim 19, further comprising a carrier, wherein said non-live-bacteria preparation is associated with said carrier, and said carrier includes at least one member selected from a group comprising water, palatant, flavor, fat, coating, yeast, glaze, sauce, sauté sauce, dusting, pan coating, seasoning, covering, layering, film coating, chickpea, chickpea flour, soy flour, dextrose, potato flour, corn flour, wheat flour, grain flour, wheat middling, sucrose, fructose, galactose, lactose, fructooligosaccharides, inulin, and chicory.

25. A preserved food composition comprising:
an incubated food that has undergone incubation in presence of an effective amount of a non-live-bacteria preparation;
an effective amount of incubated non-live-bacteria preparation present on and/or in said incubated food, wherein said effective amount of said incubated non-live-bacteria preparation killed and/or will promote killing of pathogens and/or spoilage microorganisms on and/or in said incubated food; and
wherein said non-live-bacteria preparation includes one or more byproducts resulting from fermentation of fermented bacteria, but said non-live-bacteria preparation is substantially depleted of said fermented bacteria, and said fermented bacteria is anti-pathogen and/or anti-spoilage bacteria that are living.

26. The preserved food composition of claim 25, further comprising a carrier that is associated with said non-live-bacteria preparation.

27. The preserved food composition of claim 25, further comprising a population of pathogens and/or spoilage microorganisms that have been killed by said non-live-bacteria preparation.

28. A system for producing a non-live-bacteria preparation, said system comprising:
a mixing chamber for mixing growth media components to produce a growth medium;
an inoculating chamber for inoculating said growth medium with an inoculant to produce an inoculated growth medium, wherein said inoculant includes at least one anti-pathogen and/or at least one anti-spoilage bacteria;
an incubating chamber for incubating said inoculated growth medium to produce a fermented growth medium;
a first conduit for delivering said growth medium to said inoculating chamber to produce an inoculated growth medium;
a second conduit for delivering said inoculated growth medium to said incubating chamber to produce a fermentate; and
one or more other conduits for delivering said fermentate and/or non-live-bacteria preparation intermediates for further processing to produce said non-live-bacteria preparation.

29. The system of claim 28, further comprising a killing chamber for killing said anti-pathogen and/or said anti-spoilage bacteria to produce said non-live-bacteria preparation.

30. The system of claim 28, further comprising a separating chamber for separating said anti-pathogen and/or said anti-spoilage bacteria from said fermented growth medium to produce said non-live-bacteria preparation.

31. The system of claim 29, further comprising a concentrating chamber for concentrating said non-live-bacteria preparation to produce a non-live-bacteria concentrate.

32. The system of claim 30, further comprising a concentrating chamber for concentrating said non-live-bacteria preparation to produce a non-live-bacteria concentrate or for concentrating said fermentate to produce a non-live-bacteria preparation intermediate.

33. A process for producing a non-retorted food product packaged for long-term storage, said process comprising:
obtaining a food, one or more anti-pathogen and/or anti-spoilage bacteria, a storage container, and a respective lid for said storage container,
fermenting said anti-pathogen and/or anti-spoilage bacteria in said food to form a fermented food, wherein said fermented food has a pH value that is less than about 5.5;
heating said fermented food to produce a heated, activated food;
filling said storage container with said heated, fermented food to produce a filled storage container, wherein said heated, fermented food has a temperature value that is at least about 71° C. during said filling; and
sealing said filled storage container with said respective lid to produce said non-retorted food product packaged for long-term storage, thereby preventing said non-retorted food product packaged for long-term storage from producing a puffy lid during said long-term storage.

34. The process of claim 33, wherein said food contains at least about 2% carbohydrate.

35. The process of claim 33, wherein said heating is carried out at a temperature that is up to about 82° C.

36. The process of claim 33, further comprising, prior to said fermenting, mixing said anti-pathogen and/or said anti-spoilage bacteria in said food.

37. The process of claim 36, wherein said mixing is carried out at a temperature that is between about 0° C. and about 49° C.

38. The process of claim 33, further comprising adding, to said food mixture, at least one member selected from a group comprising vitamin, mineral, and oil.

39. The process of claim 33, wherein said fermenting is carried out at a temperature that is between about 38° C. and about 60° C.

40. The process of claim 33, wherein said fermenting is carried out at a temperature that is between about 49° C. and about 54° C.

41. A process for producing a non-retorted food product packaged for long-term storage, said process comprising:
obtaining a food, a carbohydrate source, a culture energy source, a source of vitamins, a source of minerals, oil, an anti-pathogen and/or anti-spoilage bacteria, a storage container, and a respective lid for said storage container;
grinding said food to produce a ground food;
mixing said carbohydrate source into said ground food to create a first food mixture;
mixing said source of vitamins, said source of minerals, and said oil into said first food mixture to produce a second food mixture;
mixing said culture energy source in said second food mixture to produce a third food mixture;
inoculating said anti-pathogen and/or anti-spoilage bacteria in said third food mixture to produce an inoculated food mixture;
heating said inoculated food mixture to produce a heated, inoculated food mixture;
fermenting said heated, inoculated food mixture until a pH value of said heated, inoculated food mixture is less than about 4.6 to produce a fermented food composition;
pumping said fermented food composition to produce a vacuumized product;
filling said storage container with said vacuum atmosphere product while said vacuumized product is at least about 49° C. to produce a filled storage container; and
sealing said filled container with said respective lid to produce said non-retorted food product packaged for long-term storage, thereby preventing said non-retorted food product packaged for long-term storage from producing a puffy lid during said long-term storage.

42. The process of claim 41, wherein said grinding is carried out at a temperature that is greater than about 4° C.

43. The process of claim 41, wherein said heating is carried out at a temperature that is greater than about 49° C.

44. The process of claim 41, wherein said obtaining includes obtaining a water solution, and prior to said inoculating, said anti-pathogen and/or anti-spoilage bacteria is hydrated in said water solution.

45. A process for decontaminating a non-edible surface, said process comprising:
introducing a non-live-bacteria preparation on said non-edible surface to produce a decontaminated non-edible surface, and said non-live-bacteria preparation results from fermentation of fermented bacteria, but said non-live-bacteria preparation is substantially depleted of said fermented bacteria, and said fermented bacteria is bacteria that is living; and
wherein said fermented bacteria is anti-pathogen bacteria and/or anti-spoilage bacteria.

46. The process of claim 45, wherein:
in said introducing, said non-live-bacteria preparation includes one or more solid byproducts resulting from said fermentation of said fermented bacteria; and
presence of one or more of said solid byproducts kills and/or inhibits growth of pathogens and/or spoilage microorganisms on said non-edible surface.

47. The process of claim 45, wherein after said introducing, said non-edible surface is substantially free of pathogens and/or spoilage microorganisms.
